(19) United States
(12) Patent Application Publication
(10) Pub. No.: US 2024/0317965 A1
(43) Pub. Date: Sep. 26, 2024

(54) NANOCLAY, STARCH AND GALLIUM ALLOY-BASED MATERIALS, METHODS OF MAKING AND USING THE SAME

(71) Applicant: The University of Chicago, Chicago, IL (US)

(72) Inventors: Bozhi Tian, Chicago, IL (US); Yiliang Lin, Chicago, IL (US); Jiping Yue, Chicago, IL (US)

(21) Appl. No.: 18/612,387

(22) Filed: Mar. 21, 2024

Related U.S. Application Data
(60) Provisional application No. 63/491,869, filed on Mar. 23, 2023.

(51) Int. Cl. C08K 3/34; C08B 31/04; C09C 1/00

(52) U.S. Cl. CPC C08K 3/346; C08B 31/04; C09C 1/00; C01P 2004/20; C01P 2004/52; C01P 2004/62; C01P 2004/64

(57) ABSTRACT

The present disclosure provides for nanoclay, starch and gallium alloy-based materials, methods of making and using the same. In particular, in one aspect, the present disclosure provides for materials comprising: nanoclay in an amount of 20 wt % to 40 wt %; starch granules in an amount of 20 wt % to 40 wt %; and a gallium-based alloy in an amount of 20 wt % to 40 wt %.

### CROSS-REFERENCE TO RELATED APPLICATIONS

This application claims the benefit of priority of U.S. Provisional Application No. 63/491,869, filed Mar. 23, 2023, which is incorporated herein by reference in its entirety.

### STATEMENT REGARDING FEDERALLY SPONSORED RESEARCH OR DEVELOPMENT

This invention was made with government support under grant number N000141612958 awarded by the U.S. Office of Naval Research and grant number NSF CMMI-1848613 awarded by the National Science Foundation. The government has certain rights in the invention.

### FIELD

The present disclosure relates generally to a soil-inspired chemical system and methods of preparation and use thereof.

### BACKGROUND OF THE DISCLOSURE

Interactions between the microbiota and their colonized environments mediate critical pathways in biogeochemical cycles, ecological resilience, and human health^{1,2}. Novel materials that can controllably modulate such microbial activity may contribute to both fundamental and applied research, including drug delivery³, artificial photosynthesis⁴⁻⁸, biohybrid fuel cells^{9,10}, carbon dioxide fixation¹⁻¹³, and living materials¹⁴⁻¹⁸. The microbial colonized environment of soil is a perfect example of microbe-material interaction in nature, and it represents a mechanically and chemically integrated system that can remodel its properties in response to the external environment¹⁹. Spatially complex and dynamic environs within the soil's porous structures support the high diversity and density of soil microbiota^{19,20}, which in turn mediate essential biogeochemical cycling to provide nutrients such as nitrogen, phosphorous, and sulfur to the soil system²¹.

It is hypothesized that a soil-inspired chemical system comprising porosity, chemical heterogeneous, and dynamic properties, like those of natural soil, may serve as a responsive platform for modulation of microbial systems^{22,23} as well as other applications. However, there are currently no examples of soil-inspired materials that can replicate these beneficial properties.

### SUMMARY

The present disclosure relates to a soil-inspired chemical system and methods of preparation and use thereof. The synthesis and characterization of the soil-inspired chemical system is described here. A representative example of the soil-inspired chemical system can be found in Supplementary Table 1. We demonstrate its utility as a dynamically responsive material platform for microbial modulation in vitro and in vivo. The soil-inspired chemical system shows promise as a therapy for gastrointestinal disease, suggesting a therapeutic alternative to existing techniques⁵³⁻⁵⁷. Beyond gut microbiota, this chemical system may be extended to the study of other microbiomes, such as skin and soil microbiota, which would have implications from human health to the stability and productivity of agro-ecosystems⁵⁸.

Accordingly, in one aspect, the present disclosure relates to a material comprising:
nanoclay in an amount of 20 wt % to 40 wt %;
starch granules in an amount of 20 wt % to 40 wt %; and
a gallium-based alloy in an amount of 20 wt % to 40 wt %.

In another aspect, the present disclosure relates to a method of making the material as described herein, the method comprising the steps of:
(i) mixing the nanoclay and the starch granules with water to obtain a mixture, wherein the mixture comprises 60 wt % to 98 wt % water;
(ii) adding the gallium-based alloy to the mixture to form a slurry;
(iii) lowering the temperature of the slurry below the freezing point of the gallium-based alloy;
(iv) freeze-drying the slurry to form a scaffold; and
(v) compressing the scaffold at a temperature of at least 50° C. and at a pressure of at least 5 MPa to form the material.

In another aspect, the present disclosure relates to an artificial growth medium comprising the material as described herein and a plurality of cells, wherein the plurality of cells comprises a biofilm-forming organism, gram-positive bacteria, or gram-negative bacteria.

In another aspect, the present disclosure relates to a method of producing a chemical, the method comprising:
providing the artificial growth medium as described herein, wherein the plurality of cells is capable of producing a chemical; and
inducing the plurality of cells to produce the chemical, wherein the chemical is a chemical feedstock, a fuel, or a pharmaceutical.

In another aspect, the present disclosure relates to a method of modulating the gut microbiome and/or treating a digestive disorder in a subject in need thereof, the method comprising administering an effective amount of the material as described herein to the subject.

In another aspect, the present disclosure relates to a substrate comprising a layer of the material as described herein, wherein the layer includes a predetermined conductive pattern.

In another aspect, the present disclosure relates to a method of creating an electrical circuit, the method comprising providing a substrate comprising a layer of the material as described herein, and converting portions of the layer to create a predetermined conductive pattern.

Other aspects of the disclosure will be apparent to those skilled in the art in view of the description that follows.

### BRIEF DESCRIPTION OF THE DRAWINGS

The accompanying drawings are included to provide a further understanding of the systems and methods of the disclosure, and are incorporated in and constitute a part of this specification. The drawings are not necessarily to scale, and sizes of various elements may be distorted for clarity. The drawings illustrate one or more embodiment(s) of the disclosure and together with the description serve to explain the principles and operation of the disclosure.

FIG. 1A is a schematic of a soil-inspired material as described herein.

FIG. 1B is a schematic of the interaction between a microbial system and the soil-inspired material as described herein.

FIG. 1C is a schematic of a fabrication process.

FIG. 1D is a schematic of a transmission electron microscopy (TEM) image illustrating the morphology of liquid metal particles before freeze-drying and a TEM image illustrating the morphology of nanoclays before freeze-drying.

FIG. 1E is a schematic of a scanning electron microscopy (SEM) image illustrating the formation of a layered structure after freeze-drying due to ice templates.

FIG. 1F is a schematic of a SEM image illustrating a more compact structure after compression.

FIG. 2A is a schematic of the simultaneous X-ray fluorescence and ptychography measurement experiment.

FIG. 2B is a schematic of a three-dimensional (3D) ptychographic tomography illustrating the distribution of liquid metal particles in the soil-inspired material as described herein.

FIG. 2C is a schematic of sections of correlative 3D X-ray fluorescence and ptychographic tomography.

FIG. 2D is a schematic of correlative fluorescence and ptychographic imaging of the microtomed samples.

FIG. 2E is a schematic of a cross-sectional TEM image of the soil-inspired material as described herein and which is prepared by an ultramicrotome.

FIG. 2F is a schematic of an in-situ IR spectra of the starch granules as described herein.

FIG. 3A is a schematic of statistical analysis of the soil-inspired material as described herein.

FIG. 3B is a schematic of mechanical sintering induces conductivity on the initially non-conductive soil-inspired material.

FIG. 3C is a schematic of optical images of the soil-inspired material as described herein.

FIG. 3D is a schematic of the relationship between solvent vapors and the conductivity of the soil-inspired material as described herein.

FIG. 3E is a schematic of the change in conductance of the soil-inspired material as described herein.

FIG. 3F is a schematic of the soil-inspired material as described herein is a responsive matrix.

FIG. 4A is a schematic of laser microscopy images of the soil-inspired material as described herein.

FIG. 4B is a schematic of a high-resolution scanning transmission electron microscope (STEM) image of the soil-inspired material as described herein.

FIG. 4C is a schematic of an energy dispersive X-ray spectroscopy (EDS) of the soil-inspired material as described herein.

FIG. 4D is a schematic of an X-ray absorption near edge structure (XANES) spectra of the soil-inspired material as described herein.

FIG. 4E is a schematic of a positive spectra of time-of-flight secondary ion mass spectrometry (TOF-SIMS) from the soil-inspired material as described herein with laser writing of the soil-inspired material.

FIG. 4F is a schematic of a positive spectra of TOF-SIMS from the soil-inspired material as described herein without laser writing of the soil-inspired material.

FIG. 4G is a schematic of biofilms on soil-inspired material as described herein with and without lasing.

FIG. 5A is a schematic of linear discriminant analysis effect size (LEfSe) taxa analysis of the soil-inspired material as described herein.

FIG. 5B is a schematic of statistical analysis of g_Oscillibacter modulation of the soil-inspired material as described herein.

FIG. 5C is a schematic of statistical analysis of g_Allobaculum modulation of the soil-inspired material as described herein.

FIG. 5D is a schematic of statistical analysis of g_Blautia modulation of the soil-inspired material as described herein.

FIG. 5E is a schematic of statistical analysis of g_Enterorhabdu modulation of the soil-inspired material as described herein.

FIG. 5F is a schematic of the change of mouse body weight percentage over 7 consecutive days.

FIG. 5G is a schematic of data illustrating the oil-inspired material as described herein significantly mitigates the shortened colon length induced by ulcerative colitis.

FIG. 5H is a schematic of mice with ulcerative colitis treated with the soil-inspired material as described herein.

FIG. 5I is a schematic of data illustrating the soil-inspired material as described herein mitigates diarrhea in mice with ulcerative colitis.

FIG. 5J is a schematic of the histology of the colon.

FIG. 5K is a schematic of the histology injury score of the soil-inspired material as described herein.

FIG. 6 is a schematic of the fabrication of the soil-inspired chemical system as described herein.

FIG. 7 is a schematic of the optical and SEM images of starch granules as described herein.

FIG. 8 is a schematic of SEM images of a layered structure after freeze-drying.

FIG. 9A is a schematic of the formation of the porous soil structure as described herein.

FIG. 9B is a schematic of the freeze-drying method as described herein.

FIG. 9C is a schematic of the formation of a nonporous aggregate.

FIG. 10 is a schematic of the photographs of the soil-inspired material as described herein and which is fabricated into origami structures.

FIG. 11 is a schematic of sectioning of correlative 3D X-ray fluorescence and ptychographic tomography at different planes.

FIG. 12 is a schematic of an X-ray ptychography and fluorescence imaging of the soil-inspired material as described herein.

FIG. 13A is a schematic of a reconstructed 3D model.

FIG. 13B is a schematic of representative slices in the reconstructed 3D model.

FIG. 14 is a schematic of an X-ray ptychography and fluorescence imaging in cross-sectioned samples.

FIG. 15 is a schematic of an X-ray ptychography and fluorescence imaging in cross-sectioned samples.

FIG. 16 is a schematic of Fourier-transform infrared (FTIR) spectra of water and heavy water in the frequency range 880 to 4250 cm⁻¹.

FIG. 17 is a schematic of differential scanning calorimetry (DSC) curves.

FIG. 18 is a schematic of a gelatinization process.

FIG. 19 is a schematic of starch gelatinization and the chemical structures of starch.

FIG. 20 is a schematic of different nanoclays used to construct the soil-inspired chemical systems as described herein.

FIG. 21A is a schematic of curves of the soil-inspired material as described herein under nanoindentation.

FIG. 21B is a schematic of curves of soil-inspired material as described herein under three-point bending.

FIG. 22A is a schematic of strain-stress curves from three-point-bending tests of the soil-inspired material as described herein.

FIG. 22B is a schematic of statistical analysis illustrating the soil-inspired material as described herein without liquid metal.

FIG. 23 is a schematic of X-ray microtomography (Micro-CT) experiments.

FIG. 24 is a schematic of a 3D plot of the relative polarity, dipole moment, and dielectric constant of tested solvents.

FIG. 25A is a schematic of an image taken on a 3D laser confocal scanning microscope with patterns showing the gallium (Ga) element.

FIG. 25B is a schematic of an image taken on a 3D laser confocal scanning microscope with patterns showing the electron shell model of Ga.

FIG. 25C is a schematic of an image taken on a 3D laser confocal scanning microscope with patterns showing a star.

FIG. 25D is a schematic of an image taken on a 3D laser confocal scanning microscope with patterns showing a snowflake.

FIG. 25E is a schematic of an image taken on a 3D laser confocal scanning microscope with patterns showing a circle.

FIG. 26 is a schematic of a scanning transmission electron microscopy (STEM) image of the laser-sintered soil-inspired material as described herein.

FIG. 27A is a schematic of a STEM image of a representative area with multiple single atoms on a matrix.

FIG. 27B is a schematic of a typical line histogram with Gaussian fitting.

FIG. 27C is a schematic of statistical analysis of single atom sizes.

FIG. 28 is a schematic of electron microscopy (EM) image analysis illustrating two types of single metal atoms.

FIG. 29 is a schematic of images illustrating that the single atoms remain stable for at least 8 months after laser sintering.

FIG. 30 is a schematic of high-resolution time-of-flight secondary ion mass spectrometry (TOF-SIMS) after laser patterning.

FIG. 31A is a schematic of photographs of two circuit lines made by laser patterning from the soil-inspired material as described herein.

FIG. 31B is a schematic of the mechanical performance of the soil-inspired material as described herein after recycling.

FIG. 31C is a schematic of laser patterning of the soil-inspired material as described herein.

FIG. 32 is a schematic of a suitable laser power that enhances Bacillus Subtilis biofilm growth.

FIG. 33 is a schematic of SEM images illustrating the biofilm cell density on the soil-inspired material as described herein.

FIG. 34 is a schematic of a benchmark experiment illustrating lasing on the soil-inspired material as described herein without liquid metal.

FIG. 35 is a schematic of a benchmark experiment illustrating mechanically sintering the soil-inspired material as described herein.

FIG. 36 is a schematic of liquid flask culture of Bacillus Subtilis.

FIG. 37A is a schematic of data illustrating that the soil-inspired material as described herein modulates E. coli growth in liquid culture.

FIG. 37B is a schematic of data illustrating that the soil-inspired material as described herein modulates bacterial metabolism.

FIG. 38A is a schematic of the change of mouse body weight percentage over 7 consecutive days with oral administration of the soil-inspired material as described herein.

FIG. 38B is a schematic of optical images of colons from a soil-inspired material-treated group and a control group.

FIG. 38C is a schematic of statistical analysis illustrating no difference in colon lengths between the soil-inspired material-treated group and a control group.

FIG. 38D is a schematic of data illustrating hematoxylin and eosin (H&E) staining of the distal colon and proximal colon from the soil-inspired material group.

FIG. 39A is a schematic of statistical analysis of the distal and proximal colon crypt depth illustrating no difference between the soil-inspired material and control groups.

FIG. 39B is a schematic of statistical analysis of the nuclei per crypt in the distal and proximal colon illustrating no difference between the soil-inspired material and control groups.

FIG. 40 is a schematic of data illustrating H&E staining of internal organs.

FIG. 41 is a schematic of data illustrating quantitative analysis of kidney histology.

FIG. 42A is a schematic of statistical analysis on the absolute gene abundance illustrating no difference between the control and soil-inspired material groups.

FIG. 42B is a schematic of statistical analysis on the alpha diversity illustrating no difference between the control and soil-inspired material groups.

FIG. 43 is a schematic of a taxonomy abundance heatmap illustrating no gut microbiota dysbiosis.

FIG. 44A is a schematic of statistical analysis on the absolute gene abundance illustrating a significant decrease after tetracycline treatment.

FIG. 44B is a schematic of statistical analysis on the alpha diversity illustrating no difference after tetracycline treatment.

FIG. 45 is a schematic of a taxonomy abundance heatmap of the 13 richest genera.

FIG. 46 is a schematic of data illustrating tetracycline treatment that induces a significant reduction in the absolute abundance of several genera.

FIG. 47A is a schematic of statistical analysis on the absolute gene abundance illustrating an increase in absolute abundance of the gut bacteria.

FIG. 47B is a schematic of statistical analysis illustrating treatment with soil-inspired material significantly increases the alpha diversity.

FIG. 48 is a schematic of a taxonomy abundance heatmap of 13 richest genera.

FIG. 49 is a schematic of a representative histology images of the colon region.

FIG. 50 is a schematic of data illustrating that the soil-inspired material as described herein helps maintain the mucus layer (epithelial thickness) in both distal colon and proximal colon in DSS-induced rodent colitis.

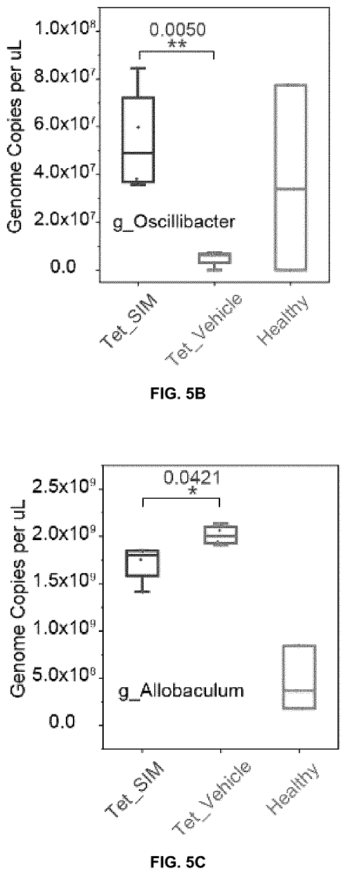

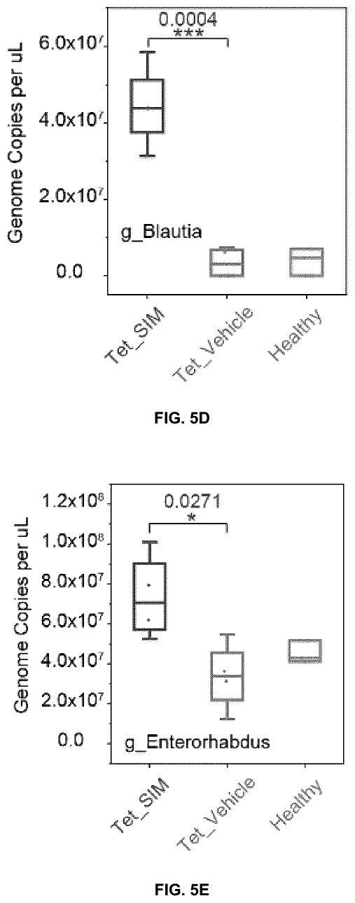

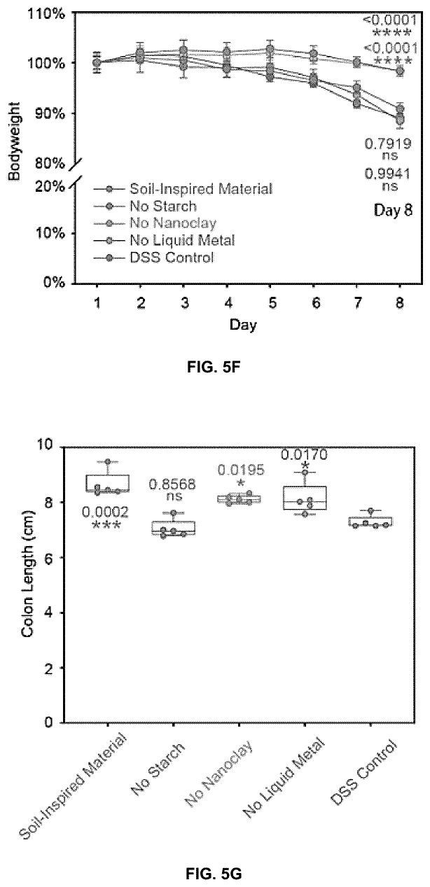

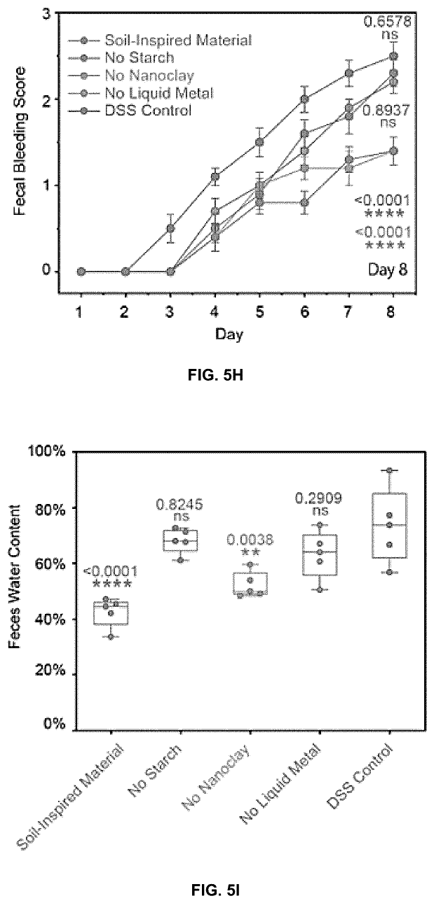

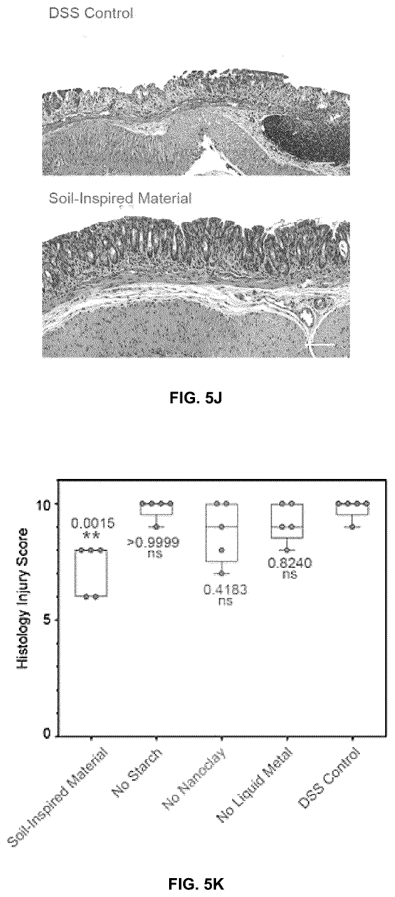

FIG. 5I is a schematic of a linear discriminant analysis effect size (LEfSe) taxa analysis.

FIG. 52 is a schematic of data illustrating that no significant difference was observed in either absolute gene abundance or alpha diversity of the total fecal bacterium population between experimental groups.

FIG. 53 is a schematic of data illustrating that the material combination without liquid metal (indicated as “No Liquid Metal”) significantly worsens the Romboustsia dysbiosis induced by DSS treatment.

FIG. 54 is a schematic of a micro CT imaging sequence illustrating the location of orally administrated soil-inspired material as described herein in gastrointestinal tracts.

FIG. 55 is a schematic of date illustrating ex-vivo comparison of gastrointestinal tract 6 hours following oral administration of the soil-inspired material as described herein and the control gastrointestinal tissue without exposure to the material.

FIG. 56 is a schematic of data illustrating system developed for real-time conductivity measurement with multiple samples under solvent exposure.

### DETAILED DESCRIPTION

Before the disclosed methods and materials are described, it is to be understood that the aspects described herein are not limited to specific embodiments, and as such can, of course, vary. It is also to be understood that the terminology used herein is for the purpose of describing particular aspects only and, unless specifically defined herein, is not intended to be limiting.

Interactions between the microbiota and their colonized environments mediate critical pathways, from biogeochemical cycles to homeostasis in human health. Accordingly, the present disclosure relates to a soil-inspired chemical system comprising nanostructured minerals, starch granules, and liquid metals. Fabricated via a bottom-up synthesis, the soil-inspired chemical system as described herein enables chemical redistribution and modulation of microbial communities. The present inventors have characterized the composite, confirming its structural similarity to the soil, with 3D X-ray fluorescence and ptychographic tomography, and electron microscopy imaging. The present inventors have also demonstrated that post-synthetic modifications formed by laser irradiation led to chemical heterogeneities from the atomic to the macroscopic level. The soil-inspired material as described herein possesses chemical, optical, and mechanical responsiveness to yield write-erase functions in electrical performance. The composite as described herein can also enhance microbial culture/biofilm growth and biofuel production in vitro. Finally, the present inventors have shown that the soil-inspired system enriches gut bacteria diversity, rectifies tetracycline-induced gut microbiome dysbiosis, and ameliorates dextran sulfate sodium-induced rodent colitis symptoms within in-vivo rodent models.

In one aspect, the present disclosure relates to a material. The material comprises nanoclay. In various embodiments as otherwise described herein, the material comprises nanoclay in an amount of 20 wt % to 40 wt %, e.g., in amount of 20 wt % to 35 wt %, or 20 wt % to 30 wt %, or 20 wt % to 25 wt %, or 25 wt % to 40 wt %, or 25 wt % to 35 wt %, or 25 wt % to 30 wt %, or 30 wt % to 40 wt %, or 30 wt % to 35 wt %, or 35 wt % to 40 wt %.

In various embodiments, the nanoclay comprises montmorillonite, bentonite, kaolinite, halloysite, dickite, nacrite, or illite.

In various embodiments, the nanoclay comprises bentonite in an amount of at least 90 wt % of the nanoclay, e.g., in an amount of 90 wt % of the nanoclay, or 92 wt % of the nanoclay, or 94 wt % of the nanoclay, or 96 wt % of the nanoclay, or 98 wt % of the nanoclay, or 100 wt % of the nanoclay.

In various embodiments, the nanoclay comprises at least two clays. In various embodiments as otherwise described herein, the at least two clays are montmorillonite, bentonite, kaolinite, halloysite, dickite, nacrite, or illite.

As described herein, the material also comprises starch granules. In various embodiments as otherwise described herein, the material comprises starch granules in an amount of 20 wt % to 40 wt %, e.g., in amount of 20 wt % to 35 wt %, or 20 wt % to 30 wt %, or 20 wt % to 25 wt %, or 25 wt % to 40 wt %, or 25 wt % to 35 wt %, or 25 wt % to 30 wt %, or 30 wt % to 40 wt %, or 30 wt % to 35 wt %, or 35 wt % to 40 wt %.

In various embodiments, the starch granules comprise tapioca starch in an amount of at least 90 wt % of the starch granules, e.g., in an amount of 90 wt % of the starch granules, or 92 wt % of the starch granules, or 94 wt % of the starch granules, or 96 wt % of the starch granules, or 98 wt % of the starch granules, or 100 wt % of the starch granules.

In various embodiments, the starch granules comprise at least two starches. In various embodiments as otherwise described herein, the at least two starches may be derived from corn, waxy corn, potatoes, rice, or wheat.

In various embodiments, the starch granules have an average size in the range of 0.5 μm to 200 μm, e.g., in the range of 0.5 μm to 150 μm, or 0.5 μm to 120 μm, or 0.5 μm to 100 μm, or 0.5 μm to 50 μm, or 0.5 μm to 20 μm, or 1 μm to 200 μm, or 1 μm to 150 μm, or 1 μm to 120 μm, or 1 μm to 100 μm, or 1 μm to 50 μm, or 1 μm to 20 μm, or 2 μm to 200 μm, or 2 μm to 150 μm, or 2 μm to 120 μm, or 2 μm to 100 μm, or 2 μm to 50 μm, or 2 μm to 20 μm, or 5 μm to 200 μm, or 5 μm to 150 μm, or 5 μm to 120 μm, or 5 μm to 100 μm, or 5 μm to 50 μm, or 5 μm to 20 μm.

As described herein, the material also comprises a gallium-based alloy. In various embodiments as otherwise described herein, the material comprises a gallium-based alloy in an amount of 20 wt % to 40 wt %, e.g., in amount of 20 wt % to 35 wt %, or 20 wt % to 30 wt %, or 20 wt % to 25 wt %, or 25 wt % to 40 wt %, or 25 wt % to 35 wt %, or 25 wt % to 30 wt %, or 30 wt % to 40 wt %, or 30 wt % to 35 wt %, or 35 wt % to 40 wt %.

In various embodiments, the gallium-based alloy comprises at least 25 wt % gallium, e.g., at least 30 wt % gallium, or at least 35 wt % gallium, or at least 40 wt % gallium, or at least 45 wt % gallium, or at least 50 wt % gallium.

In various embodiments, the gallium-based alloy further comprises indium in an amount of at least 10 wt %, e.g., in an amount of at least 15 wt %, or at least 20 wt %, or at least 25 wt %, or at least 30 wt %, or at least 35 wt %, or at least 40 wt %, or at least 45 wt %, or at least 50 wt %.

In various embodiments, the gallium-based alloy further comprises tin. In various embodiments as otherwise described herein, the gallium-based alloy further comprises gallistan or related alloy. As a person of ordinary skill in the art understands, gallistan can be an alloy composed of gallium, indium, and tin.

In various embodiments, the gallium-based alloy comprises indium in the range of 60 to 85% of the alloy, and the balance can be gallium. In various other embodiments, the gallium-based alloy comprises indium in the range of 60 to 80% of the alloy, and the balance can be gallium. In various other embodiments, the gallium-based alloy comprises indium in the range of 60 to 75% of the alloy, and the balance can be gallium. In various other embodiments, the gallium-based alloy comprises indium in the range of 60 to 70% of the alloy, and the balance can be gallium. In various other embodiments, the gallium-based alloy comprises indium in the range of 70 to 85% of the alloy, and the balance can be gallium. In various other embodiments, the gallium-based alloy comprises indium in the range of 70 to 80% of the alloy, and the balance can be gallium. In various other embodiments, the gallium-based alloy comprises indium in the range of 75 to 85% of the alloy, and the balance can be gallium.

In various embodiments, the gallium-based alloy can be present as nanoparticles. In various embodiments as otherwise described herein, the nanoparticles have an average diameter of less than 1 μm, e.g., an average diameter of at least 5 nm, or an average diameter in the range of 10 nm to 500 nm, or an average diameter in the range of 20 nm to 200 nm.

In various embodiments, the gallium-based alloy has a freezing point of no more than 20° C., e.g., no more than 18° C., or 15° C., or 10° C., or 5° C., or 0° C.

As described herein, the material comprises no more than 10 wt % water, e.g., no more than 5 wt % water, or no more than 2 wt % water, or no more than 1 wt % water.

In various embodiments, the material can be porous with a porosity in the range of 20 to 80%, e.g., in the range of 20 to 70%, or 20 to 60%, or 20 to 50%, or 20 to 40%, or 20 to 30%, or 30 to 80%, or 30 to 70%, or 30 to 60%, or 30 to 50%, or 30 to 40%, or 40 to 80%, or 40 to 70%, or 40 to 60%, or 40 to 50%, or 50 to 80%, or 50 to 70%, or 50 to 60%, or 60 to 80%, or 60 to 70%, or 70 to 80%.

In various embodiments, the material can be layered. For example, each layer of the material can be separated by a gap. In various embodiments as otherwise described herein, the gap between adjacent layers can be in the range of 0.5 to 100 μm, e.g., in the range of 0.5 to 80 μm, or 0.5 to 60 μm, or 0.5 to 40 μm, or 0.5 to 20 μm, or 0.5 to 10 μm, or 0.5 to 5 μm, or 0.5 to 2 μm, or 0.5 to 1 μm, or 1 to 100 μm, or 1 to 80 μm, or 1 to 60 μm, or 1 to 40 μm, or 1 to 20 μm, or 1 to 10 μm, or 1 to 5 μm, or 1 to 2 μm. In various embodiments, the layers can exhibit an organized or a disorganized structure. A person of ordinary skill in the art would understand how to create the layered structure of the material as described herein. For example, the layers can be generated through freeze-drying, which may subsequently be subjected to a hot compression treatment at a minimum temperature of 50° C.

In various embodiments, the material has a Young's modulus in the range of 0.1 to 10 GPa, e.g., in the range of 0.1 to 8 GPa, or 0.1 to 6 GPa, or 0.1 to 4 GPa, or 0.1 to 2 GPa, or 0.1 to 1 GPa, or 0.1 to 0.5 GPa, or 0.5 to 8 GPa, or 0.5 to 6 GPa, or 0.5 to 4 GPa, or 0.5 to 2 GPa, or 0.5 to 1 GPa, or 1 to 8 GPa, or 1 to 6 GPa, or 1 to 4 GPa, or 1 to 2 GPa.

In various embodiments, the material further comprises conductive lines. In various embodiments as otherwise described herein, the conductive lines are on a surface of the material as described herein. In various embodiments as otherwise described herein, the conductive lines are carbonized or compressed. Conductive traces can undergo carbonization through CO₂ laser sintering, utilizing equipment such as the Universal Laser Systems VLS 4.60. This process can be achieved in both raster and vector configurations. Across these modes, the sintering intensity may vary from 2 to 20%, with operational speeds ranging from 5 to 30%. Additionally, the engraving process can be repeated between one to four times to achieve the preferred depth and feature clarity. In some embodiments, the material as described herein can be bound in any suitable manner, e.g., adhesives, compression, heat, lasers, etc., to a surface of a suitable substrate, e.g., glass, silicon, or plastics, to generate conductive lines or processed to create conductive lines that have a variety of uses. In one embodiment, the conductive lines can be useful in electronic circuits or devices including such electronic circuits. Electronic circuits can include one or more switches, resistors, transistors, capacitors, inductors, diodes, etc., which are connected by the conductive lines including wires or traces through which electric current can flow. The conductive lines can be generated by applying any suitable method including lasers, compression, or carbonization to the material on the substrate.

In another aspect, the present disclosure relates to a method of making the material as otherwise described herein. The method comprises mixing the nanoclay and the starch granules as described herein with water to obtain a mixture. In various embodiments as otherwise described herein, the mixture comprises 60 to 98 wt % water, e.g., 60 to 95 wt % of water, or 60 to 90 wt % of water, or 70 to 98 wt % of water, or 70 to 95 wt % of water, or 70 to 90 wt % of water, or 80 to 98 wt % of water, or 80 to 95 wt % of water, or 80 to 90 wt % of water, or 90 to 98 wt % of water, or 90 to 95 wt % of water.

In various embodiments, the method also comprises adding the gallium-based alloy as described herein to the mixture to form a slurry. In various embodiments as otherwise described herein, the mixture can be stirred for at least 8 hours (e.g., at least 10 hours or at least 12 hours) in order to hydrate the starch granules. In various embodiments as otherwise described herein, the slurry can be sonicated to form gallium-based alloy nanoparticles.

In various embodiments, the method also comprises lowering the temperature of the slurry as described herein below the freezing point of the gallium-based alloy. In various embodiments as otherwise described herein, the lowering of the temperature can be performed through the application of a temperature gradient. For example, the lowering of the temperature can be performed through the application of a unidirectional temperature gradient and/or performed through directional freezing.

In various embodiments, the method also comprises freeze-drying the slurry as described herein to form a scaffold. In various embodiments as otherwise described herein, the freeze-drying of the slurry can be conducted at a temperature of no more than −10° C., e.g., at a temperature of no more than −20° C., or no more than −30° C., or no more than −40° C. In various embodiments as otherwise described herein, the freeze-drying of the slurry can be conducted at a pressure of no more than 1 mbar, e.g., no more than 0.5 mbar, or no more than 0.2 mbar, or no more than 0.1 mbar.

In various embodiments, the method also comprises compressing the scaffold as described herein at an appropriate temperature and at an appropriate pressure to form the material. In various embodiments as otherwise described herein, the compressing of the scaffold can be conducted at a temperature of at least 50° C., e.g., at a temperature of at least 60° C., or at a temperature of at least 70° C., or at a temperature of at least 80° C. In various embodiments as otherwise described herein, the compressing of the scaffold can be conducted at a pressure of at least 5 MPa, e.g., at a pressure of at least 10 MPa, or at least 15 MPa, or at least 20 MPa.

In various embodiments, the method also comprises exposing the material as described herein to a stimulus to form a conductive pattern. In various embodiments as otherwise described herein, the stimulus can be laser irradiation or pressure. For laser irradiation, conductive patterns can undergo carbonization through CO₂ laser sintering, utilizing equipment such as the Universal Laser Systems VLS 4.60. This process can be achieved in both raster and vector configurations. Across these modes, the sintering intensity may vary from 2 to 20%, with operational speeds ranging from 5 to 30%. Additionally, the engraving process can be repeated between one to four times to achieve the preferred depth and feature clarity. To achieve pressure-induced conductivity, various tools can be employed, including, but not limited to, sharp needles or other specialized instruments. These tools are designed to apply targeted pressure (e.g., >0.1 GPa) to specific areas, which can modify the conductive properties of a material. In various embodiments, the application of pressure is carefully controlled and can be adjusted according to the desired outcome.

In another aspect, the present disclosure relates to an artificial growth medium. The artificial growth medium comprises the material as described herein and a plurality of cells. In various embodiments as otherwise described herein, the plurality of cells comprises a biofilm-forming organism, gram-positive bacteria, or gram-negative bacteria. In some embodiments, the material as described herein can be used to cultivate animal cells and plant cells as well as microorganisms such as bacteria.

In another aspect, the present disclosure relates to a method of producing a chemical. In various embodiments as otherwise described herein, the chemical can be biofuels (e.g., acetate, ethanol, or butanol), antibiotics (e.g., penicillin), fine chemicals (e.g., flavonoids or polyphenols), or plastics (e.g., polyhydroxyalkanoates). The method comprises providing the artificial growth medium as described herein. In various embodiments as otherwise described herein, the plurality of cells can be capable of producing a chemical. The method also comprises inducing the plurality of cells to produce the chemical. In various embodiments as otherwise described herein, the chemical can be a chemical feedstock, a fuel, or a pharmaceutical.

In another aspect, the present disclosure relates to a method of modulating the gut biome and/or treating a digestive disorder in a subject in need thereof. The method comprises administering an effective amount of the material as described herein to the subject. In various embodiments as otherwise described herein, the digestive disorder can be microbiome dysbiosis, ulcerative colitis, colitis, Crohn's disease, or irritable bowel syndrome.

In another aspect, the present disclosure relates to a substrate. The substrate comprises a layer of the material as described herein. In various embodiments as otherwise described herein, the layer comprises a predetermined conductive pattern.

In another aspect, the present disclosure relates to a method of creating a circuit. The method comprises providing a substrate comprising a layer of the material as described herein, and converting portions of the layer to create a predetermined conductive pattern. Conversion to conductive forms is possible through CO₂ laser sintering or pressure application. Laser sintering with devices like the Universal Laser Systems VLS 4.60 allows for carbonization in raster and vector modes, with adjustable sintering power (e.g., in the range of 2 to 20%) and speed (e.g., in the range of 5 to 30%), and may require 1-4 repetitions for desired depth. For pressure-induced conductivity, sharp needles or similar tools exert targeted pressure (e.g., >0.1 GPa) to alter a material's conductive properties, with precise control over the pressure for the required results.

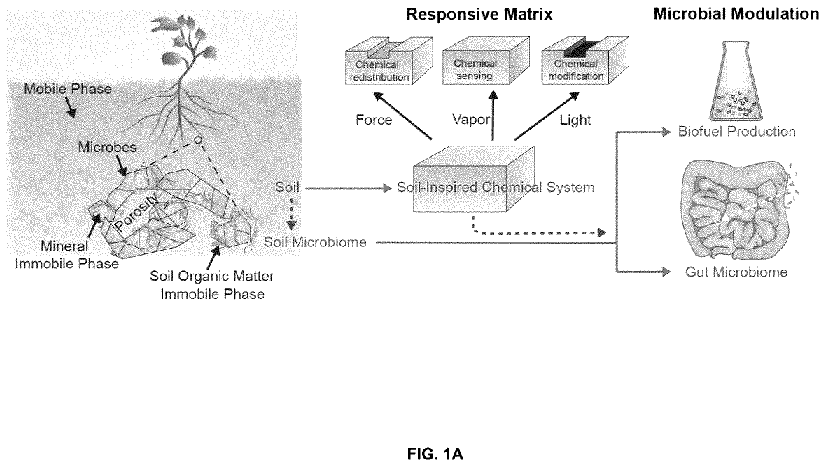

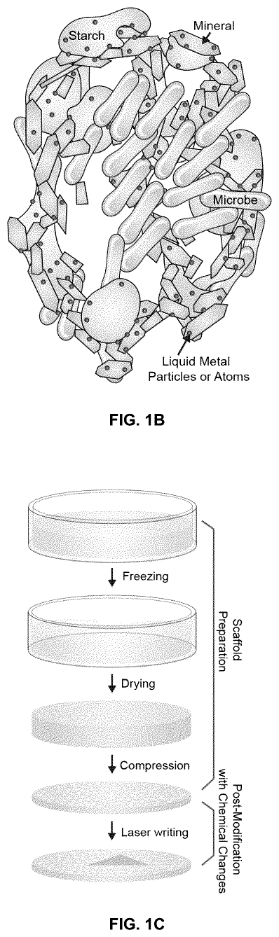

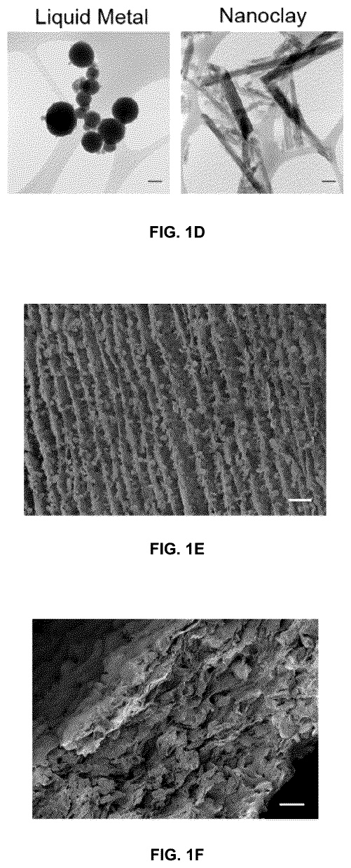

FIGS. 1A-1F describe soil-inspired dynamically responsive chemical system for microbial modulation. In particular, FIG. 1A describes schematic of the soil-inspired material. Nanoclay, starch, and liquid metal loosely represent the inorganic, organic (i.e., soil organic matter), and mobile phases, respectively, in soil. This soil-inspired material is responsive to force, vapor, and light, which induce chemical redistribution within the complex. The soil-inspired material can be broadly applied for microbial modulation in, for instance, biofuel production or homeostasis of the gut microbiome. FIG. 1B describes schematic showing the interaction between a microbial system and the soil-inspired material. FIG. 1C describes schematic of the fabrication process. Samples undergo freeze-drying and compression to create a structure similar to soil, followed by post-synthetic modification with laser writing to create chemical heterogeneity. FIG. 1D describes transmission electron microscopy (TEM) images showing the morphology of the liquid metal particles and nanoclays before freeze-drying. Scale bar, 100 and 200 nm. FIG. 1E describes scanning electron microscopy (SEM) image showing the formation of a layered structure after freeze-drying due to ice templates. Scale bar, 50 μm. f, SEM image showing a more compact structure after compression. Scale bar, 20 μm. FIG. 1F describes a SEM image illustrating a more compact structure after compression.

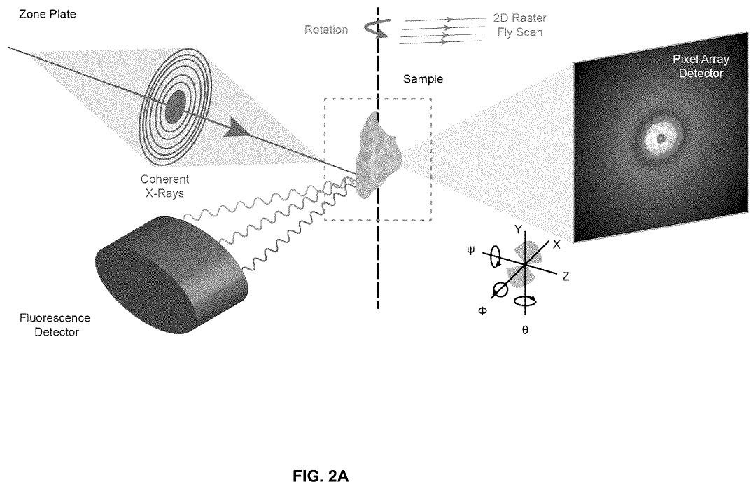

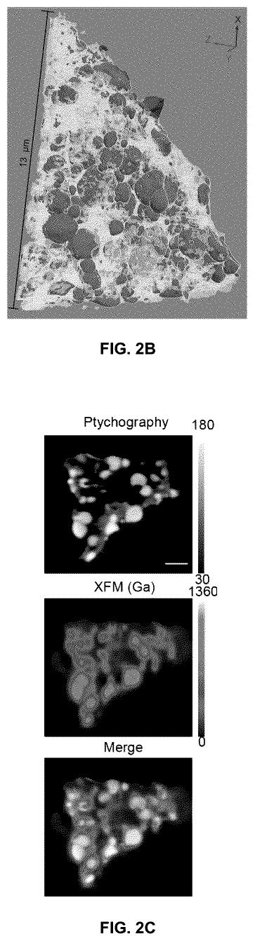

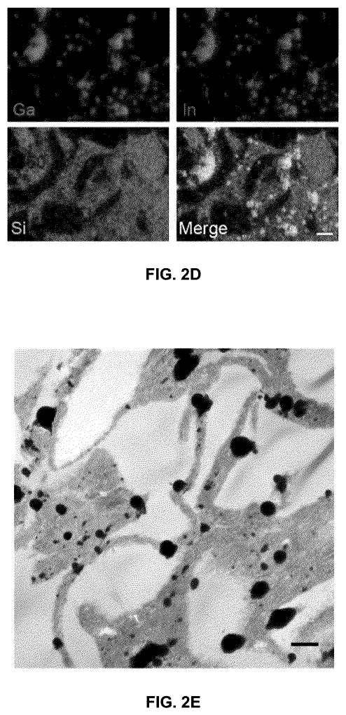

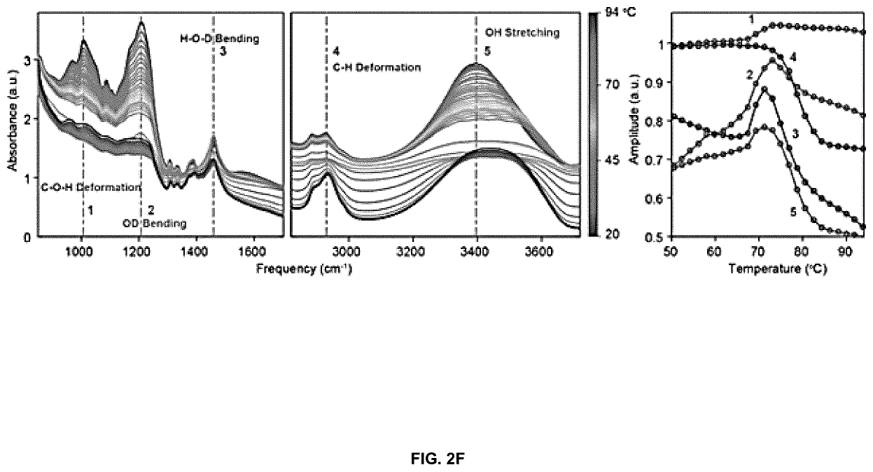

FIGS. 2A-2F described X-ray ptychographic, fluorescence tomography, and in-situ infrared (IR) spectra reveal chemical composition and dynamics. In particular, FIG. 2A describes schematic of the simultaneous X-ray fluorescence and ptychography measurement experiment. A coherent monochromatic X-ray beam (10.7 keV) was focused by a Fresnel zone plate onto a spot of ˜90 nm on a sample. The sample was raster fly-scanned in the x-y plane. Fluorescent signals and diffraction patterns were simultaneously recorded by a fluorescence detector and a pixel array detector, respectively. FIG. 2B describes 3D ptychographic tomography demonstrates the distribution of liquid metal particles in the soil-inspired material (liquid metal particles are more electron-dense, shown as red). FIG. 2C describes sections of correlative 3D X-ray fluorescence and ptychographic tomography showing that the electron-dense particles in ptychography perfectly correlate with gallium distribution in X-ray fluorescence imaging, confirming that the particles in the ptychography are gallium-based liquid metal particles. Scale bar, 2 μm. FIG. 2D describes correlative fluorescence and ptychographic imaging of the microtomed samples showing the distribution of liquid metal (gallium and indium) and nanoclay (silicon). Scale bar, 2 μm. FIG. 2E describes cross-sectional TEM image of the soil-inspired material prepared by an ultramicrotome showing well-distributed liquid metal (dark) inside the starch and nanoclay matrix (grey color). Cross-section imaging further confirms the porosity of the soil-inspired material. Scale bar, 1 μm. FIG. 2F describes in-situ IR spectra confirm gelatinization of starch granules during the heating process. The loss of starch crystallization is assigned to peaks 1 and 4, and the intermolecular hydrogen bonding is assigned to peaks 2, 3, and 5. Evidence includes loss of starch granule crystallinity and formation of intermolecular hydrogen bonding between starch and heavy water.

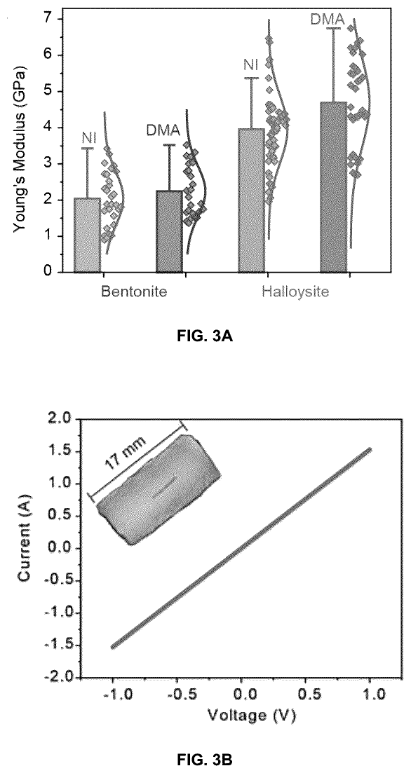

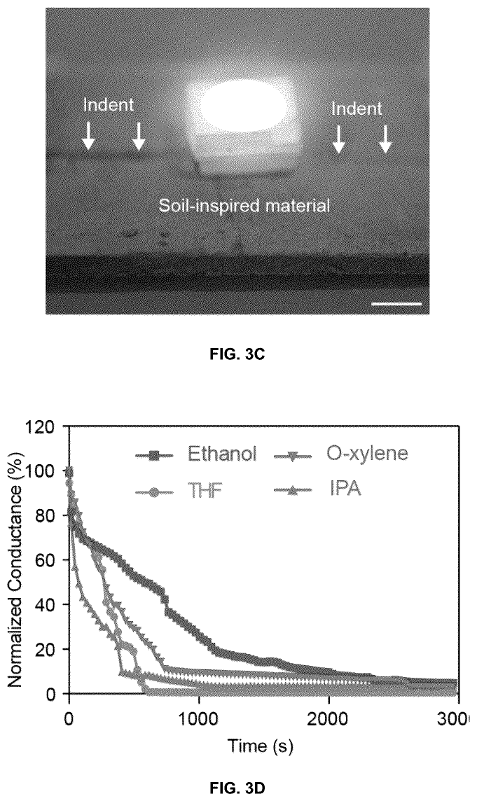

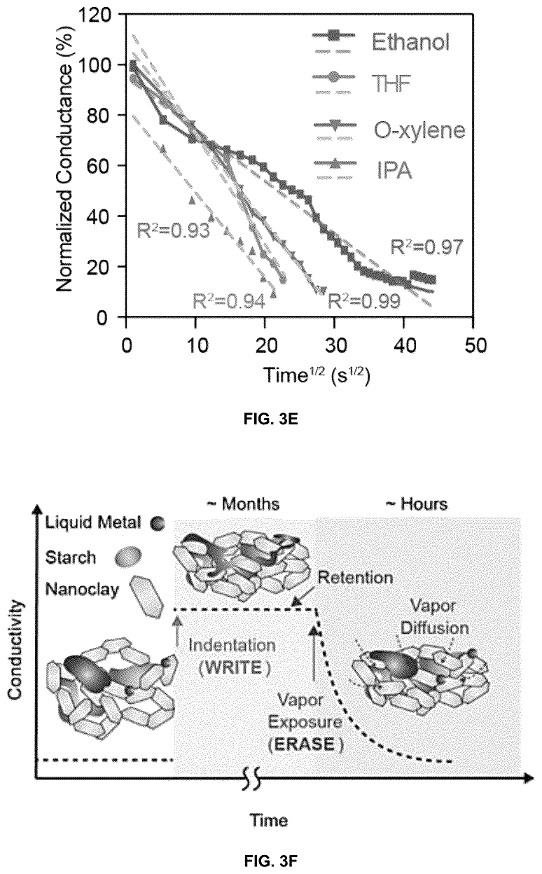

FIGS. 3A-3F describe soil-inspired material with tunable conductivity under mechanical and chemical stimuli. In particular, FIG. 3A describes statistical analysis showing that the Young's modulus of bentonite-containing and halloysite-containing soil-inspired material is ˜2 GPa and ˜5 GPa, respectively. NI: Nanoindentation. DMA: Dynamic mechanical analysis. n=29, 25, 62, and 35, respectively. Data are presented as mean values±SD. FIG. 3B describes mechanical sintering induces conductivity on the initially non-conductive soil-inspired material. The plot shows an I-V curve of the mechanically sintered pathway. Inset is an X-ray microtomography image (micro-CT) of a soil-inspired material with a mechanically indented pathway. FIG. 3C describes optical images showing the soil-inspired material can light up an LED with mechanically indented pathways. Scale bar, 1.5 mm. FIG. 3D describes solvent vapors, such as ethanol, o-xylene, tetrahydrofuran (THF), and isopropyl alcohol (IPA), can erase the conductivity on the soil-inspired material. FIG. 3E describes the change in conductance is linearly related to the square root of the time (from 0 s to the time when conductivity becomes almost zero) under solvent treatment, which is well-fitted with Fick's law of diffusion. This indicates that the erasing process may be dominated by a diffusion mechanism. FIG. 3F describes schematic showing the soil-inspired material is a responsive matrix. Conductivity can be written with mechanical indentation and later erased chemically.

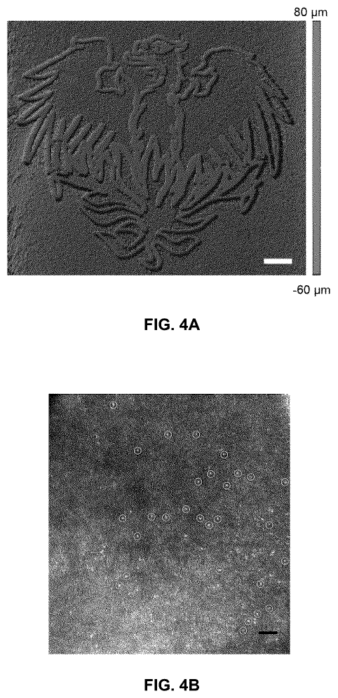

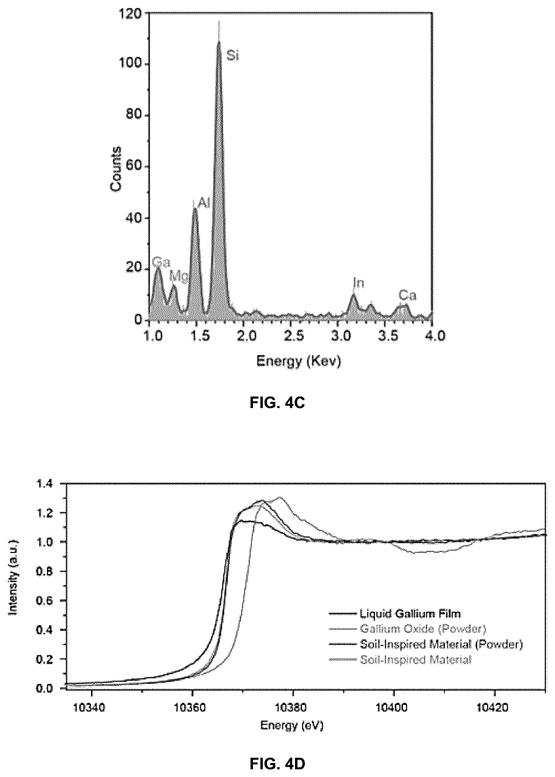

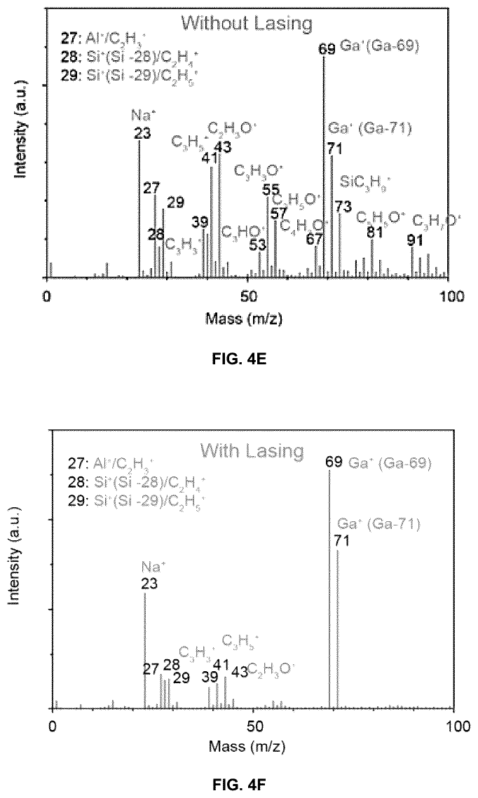

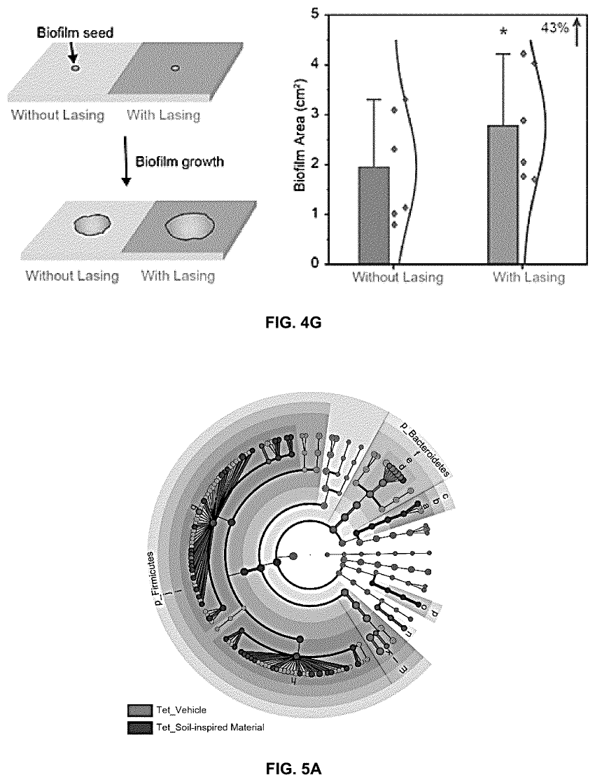

FIGS. 4A-4F describe laser-assisted chemical modification for biofilm growth enhancement. In particular, FIG. 4A describes laser microscopy images of soil-inspired material showing laser writing in spatially defined regions with The University of Chicago logo. Scale bar, 1 mm. FIG. 4B describes high-resolution scanning transmission electron microscope (STEM) image showing many single atoms with brighter contrast (circled with yellow). Scale bar, 2 nm. FIG. 4C describes energy dispersive X-ray spectroscopy (EDS) in STEM confirms the existence of Ga and In single atoms and Al and Si elements in the supporting matrix, indicating stabilization of Ga and In atoms in nanoclay-containing matrices. FIG. 4D describes X-ray absorption near edge structure (XANES) spectra show that the electronic structure of gallium in soil-inspired material containing gallium single atoms is different from the electronic structure of liquid gallium and gallium oxide. FIGS. 4E-4F describe positive spectra of time-of-flight secondary ion mass spectrometry (TOF-SIMS) from the soil-inspired material with and without laser writing demonstrate the chemical changes induced by post-modification with lasing. FIG. 4G describes Biofilms on soil-inspired material with lasing are larger in area than those on the soil-inspired material without lasing (p=0.031857). Paired t-test, two-tailed; n=6. Data are presented as mean values±SD.

FIGS. 5A-5K describe soil-inspired material for gut microbiome modulation and DSS-induced colitis therapy in vivo. In particular, FIG. 5A describes Linear discriminant analysis Effect Size (LEfSe) taxa analysis confirms the soil-inspired material enriches bacterial diversity under a pathological condition (tetracycline-induced gut microbiome dysbiosis) in vivo. FIGS. 5B-5E describe statistical analysis of g_Oscillibacter (p=0.0005), g_Allobaculum (p=0.0421), g_Blautia (p=0.0004), and g_Enterorhabdu (p=0.0271) modulation demonstrates that the soil-inspired material can rectify the dysbiosis of g_Allobaculum and g_Oscillibacter. Box bind interquartile range (IQR) divided by the median; whiskers extend 1.5±IQR. All data points are plotted (n=4 for Tet_SIM and Tet_Vehicle group and n=3 for healthy group). ‘SIM’ denotes soil-inspired material. Two-tailed Student's t-test. FIG. 5F describes the change of mouse body weight percentage over 7 consecutive days with oral administration of the soil-inspired material, the soil-inspired material without starch (indicated as “No Starch:), without nanoclay (No nanoclay), and without liquid metal (No Liquid Metal) in DSS-induced ulcerative colitis. Results show that the soil-inspired material significantly mitigated mouse body weight loss in DSS-induced colitis. Data are presented as mean±standard error of mean. (n=10). P values are determined by ordinary one-way ANOVA with Tukey's multiple comparisons test; all the Tukey's multiple comparisons shown in the figure are between DSS control and corresponding experimental groups. ns, not significant or p>0.05. FIG. 5G describes soil-inspired material significantly mitigated the shortened colon length induced by ulcerative colitis. Specifically, the experimental group without starch (No Starch) shows the shortest colon length, suggesting an essential role for starch in ulcerative colitis management. FIG. 5H describes mice with ulcerative colitis treated with soil-inspired material had significantly less fecal blood than other groups. Data are presented as mean±standard error of mean. (n=10). P values are determined by ordinary one-way ANOVA with Tukey's multiple comparisons test; all the Tukey's multiple comparisons shown in the figure are between DSS control and corresponding experimental groups. ns, not significant or p>0.05. FIG. 5I describes soil-inspired material mitigated diarrhea in mice with ulcerative colitis. FIG. 5J describes histology of the colon shows that the soil-inspired material has a therapeutic effect, in terms of histological injuries, compared with the DSS control model. Scale bar, 100 μm. FIG. 5K describes histology injury score shows the soil-inspired material (i.e., all components) achieved the best therapeutic effect on DSS-induced ulcer colitis. Boxes in FIGS. 5G-5I and FIG. 5K bind interquartile range (IQR) divided by the median; whiskers extend 1.5±IQR. All data points are plotted (n=5). P values are determined by ordinary one-way ANOVA with Tukey's multiple comparisons test; all the Tukey's multiple comparisons shown in the figure are between DSS control and corresponding experimental groups. ns, not significant or p>0.05.

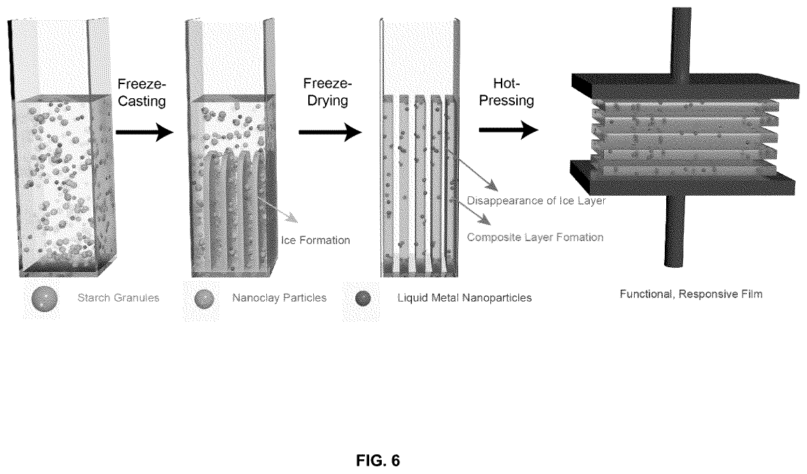

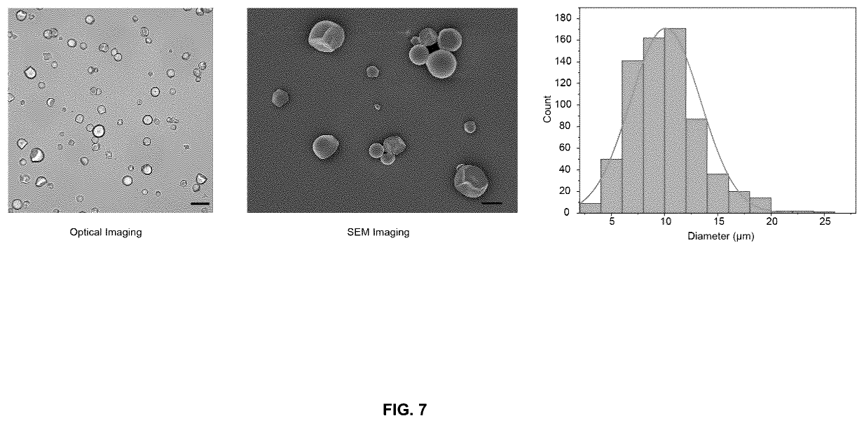

FIG. 6 describes a schematic of the fabrication of the soil-inspired chemical system. Here we use a rectangular container as an example. The choice of the container determines the shape and scale of the soil-inspired material. The fabrication procedure includes freeze-casting, freeze-drying, and hot-pressing processes.

FIG. 7 describes the starch granules have an average lateral size of ˜10.1 μm. The figure shows the optical and SEM images of starch granules and the corresponding size distribution for ˜700 random particles. Scale bar, 30 μm (left), and 10 μm (middle).

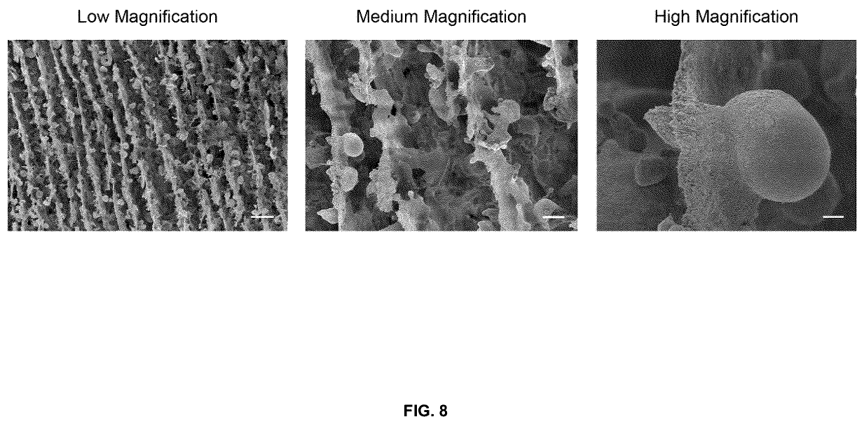

FIG. 8 describes freeze-drying yields layered structure with liquid metal particles and starch granules attached on the layer surfaces. SEM images show the porous scaffold morphology at different magnifications. The sample was recorded prior to the hot-pressing step. From left to right, scale bars are 40 μm, 10 μm, and 2 μm.

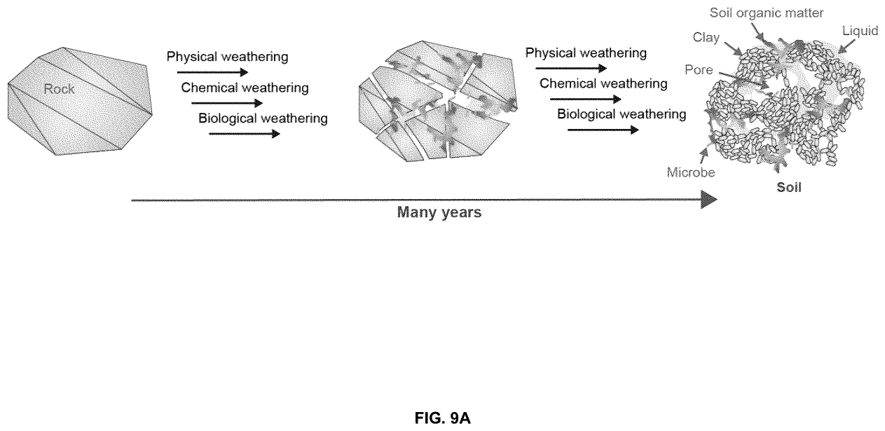

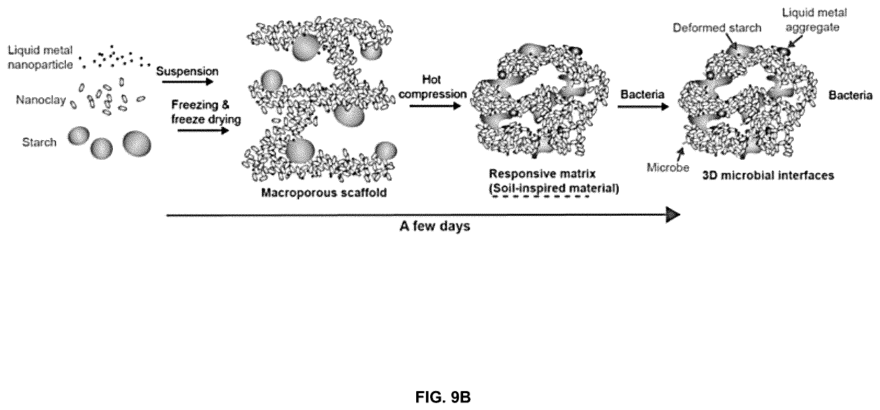

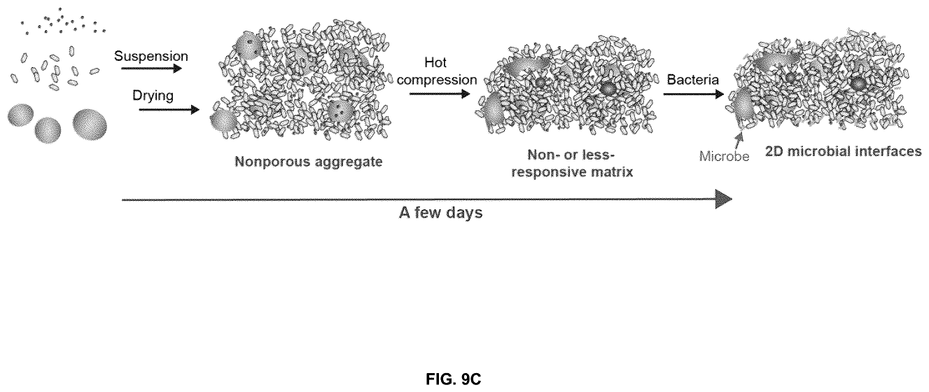

FIGS. 9A-9C describe freeze-drying is a scalable method for soil-inspired material preparation. In particular, FIG. 9A describes a schematic showing the formation of the porous soil structure due to years of physical, chemical, and biological weathering. FIG. 9B describes a schematic showing our approach, using the freeze-drying method to build a microporous scaffold followed by hot compression to form 3D microbial interfaces. The liquid-metal and starch granules attach mainly to the surface of the mineral-based layers, which is critical for the responsive properties and microbial modulation activities. FIG. 9C describes a schematic showing how simple mixing in suspension would produce a nonporous aggregate, which only yields 2D microbial interfaces. The nonporous composite does not show any of the responsive properties revealed in this study (see FIGS. 3A-3F).

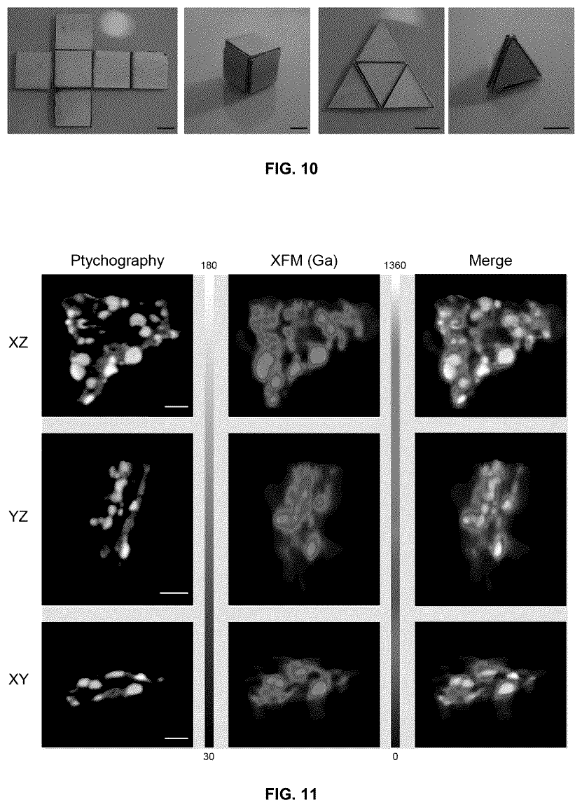

FIG. 10 describes photographs of the soil-inspired material fabricated into origami structures. The composite materials can be prepared into different building blocks, and can be assembled into origami structures with polymer joints. Scale bar, 5 mm.

FIG. 11 describes a sectioning of correlative 3D X-ray fluorescence and ptychographic tomography at different planes confirms the distribution of gallium-based liquid metal particles. The electron-dense particles in ptychography correlate with the gallium distribution in X-ray fluorescence imaging, confirming that the bright particles in ptychography are gallium-based liquid metal particles. Scale bar, 2 μm.

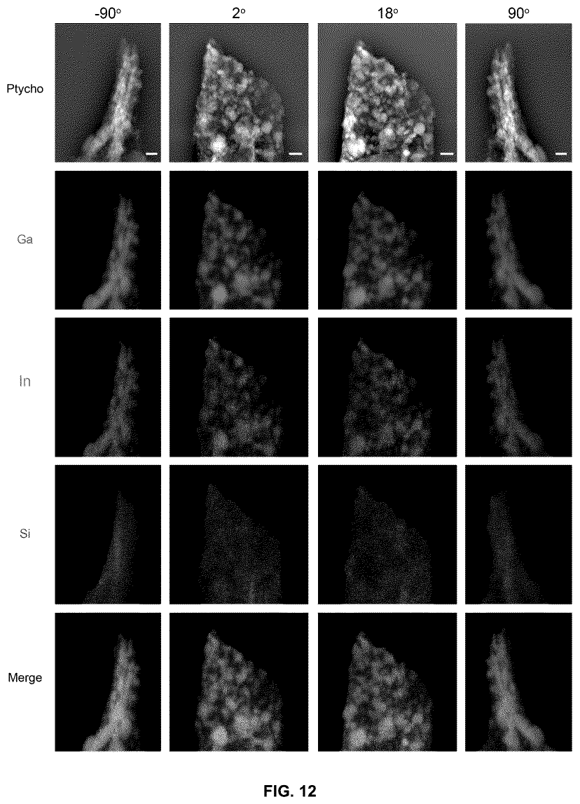

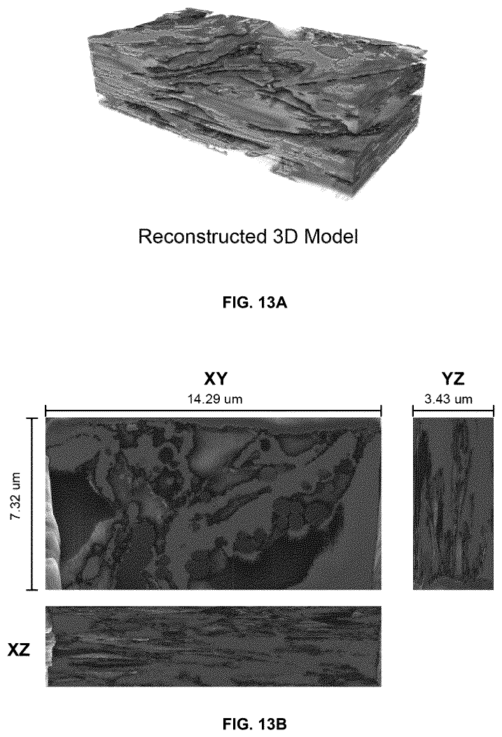

FIG. 12 describes an X-ray ptychography and fluorescence imaging confirm the distribution of liquid metal and nanoclay in the soil-inspired material. 3D X-ray ptychography and fluorescence imaging were collected at different projections (−90°/2°/18°/90°) on soil-inspired material. X-ray fluorescence element mappings show the distribution of Ga (red) and In (green) from liquid metal, and Si(blue) from nanoclay. Scale bar, 2 μm.

FIGS. 13A-13B describe a 3D reconstruction of FIB confirms the porosity of soil-inspired material. In particular, FIG. 13A describes a reconstructed 3D model. FIG. 13B describes representative slices in the 3D model with porous domains highlighted in red. Calculation from the whole sample yields a porosity of ˜54.6%.

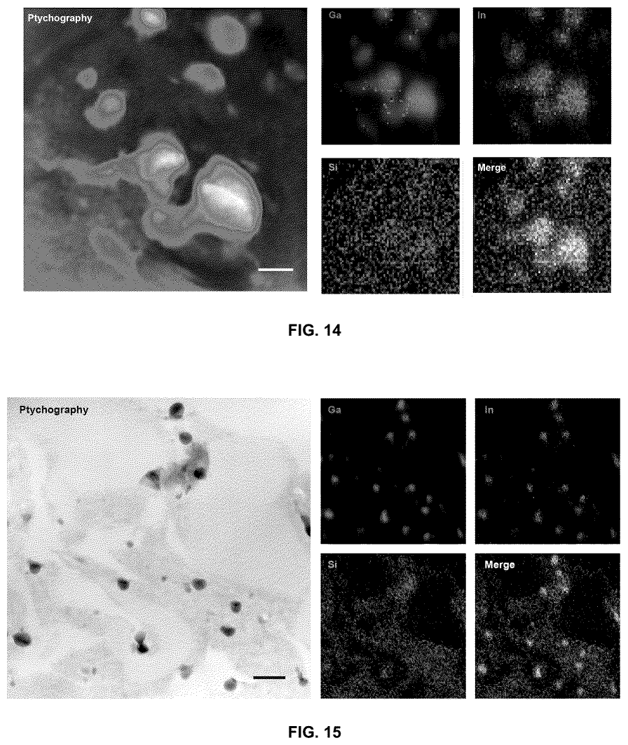

FIG. 14 describes an X-ray ptychography and fluorescence imaging in cross-sectioned samples confirm the distribution of elements. Electron density in the ptychography is shown using a color scale. X-ray fluorescence element mapping (right) shows the distribution of Ga (red) and In (green) from liquid metal, and Si (blue) from nanoclay. Scale bar, 500 nm.

FIG. 15 describes an X-ray ptychography and fluorescence imaging in cross-sectioned samples confirm the distribution of elements. Electron density in the ptychography is shown in greyscale. X-ray fluorescence element mapping (right) shows the distribution of Ga (red) and In (green) from liquid metal, and Si (blue) from nanoclay. Scale bar, 1 μm.

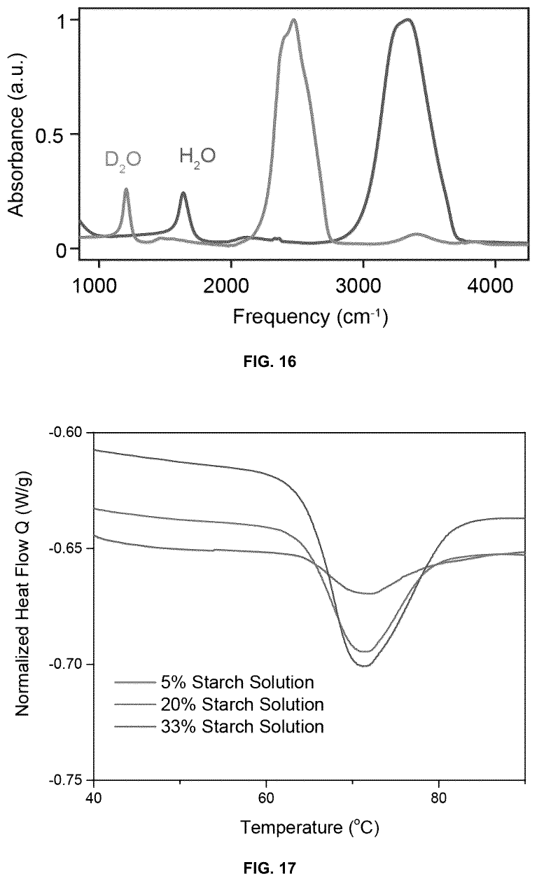

FIG. 16 describes a fourier-transform infrared (FTIR) spectra of water and heavy water in the frequency range 880 to 4250 cm⁻¹.

FIG. 17 describes differential scanning calorimetry (DSC) curves indicate a phase change temperature of ˜70° C. The phase transition correlates with loss of crystallinity as the starch gelatinization process progresses.

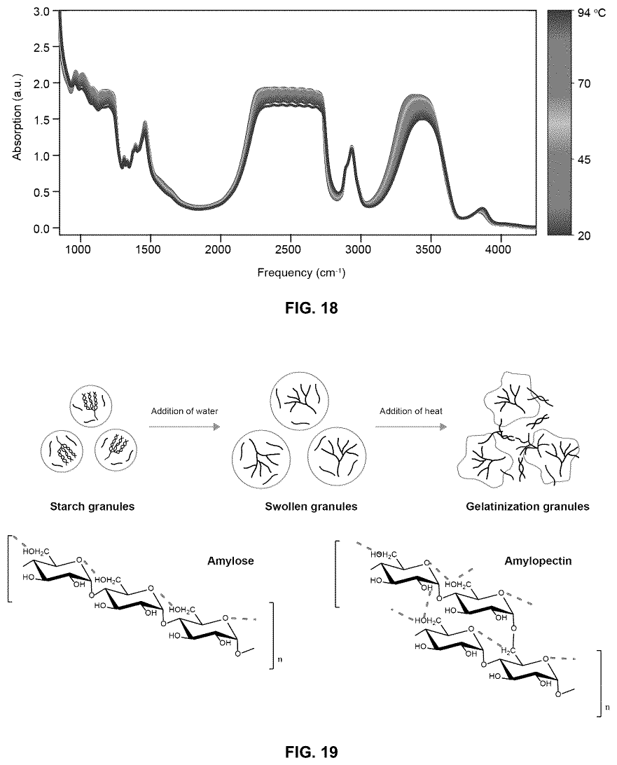

FIG. 18 describes the gelatinization process is not reversible. Temperature ramp FTIR spectra of starch from 94° C. to 20° C. show minimal changes with decreasing temperature, in contrast with the heating spectra, indicating that the chemical changes during the gelatinization process are irreversible.

FIG. 19 describes schematic diagrams show the starch gelatinization and the chemical structures of starch. During gelatinization, the addition of water breaks the amylose crystallinity and disrupts helices. More heat and water then cause more swelling and amylose diffusion out of the granules. As a result, the water outside the starch diffuses in and forms intermolecular hydrogen bonds. The red dash lines in the chemical structure represent hydrogen bonds.

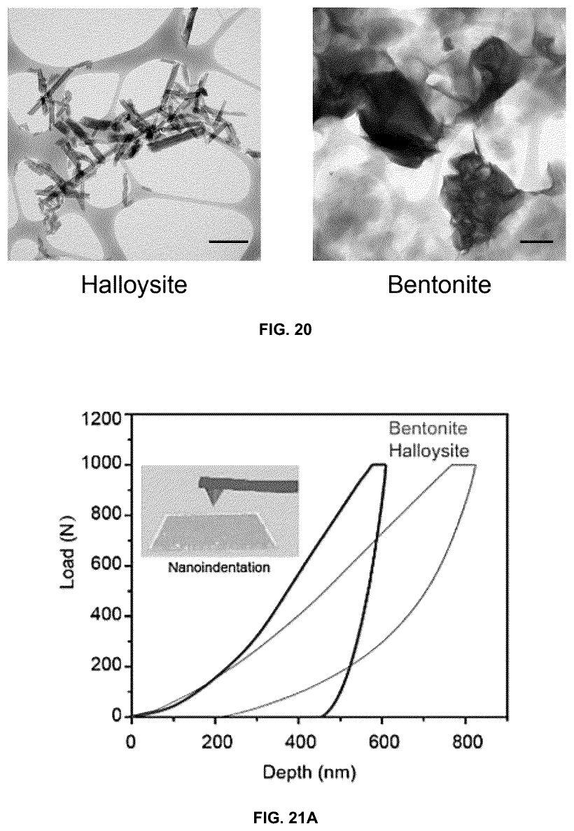

FIG. 20 describes different nanoclays can be used to construct the soil-inspired chemical systems. In this paper, we highlighted two nanoclays, halloysite and bentonite nanoclay, which have very different morphologies. Scale bar, 500 nm.

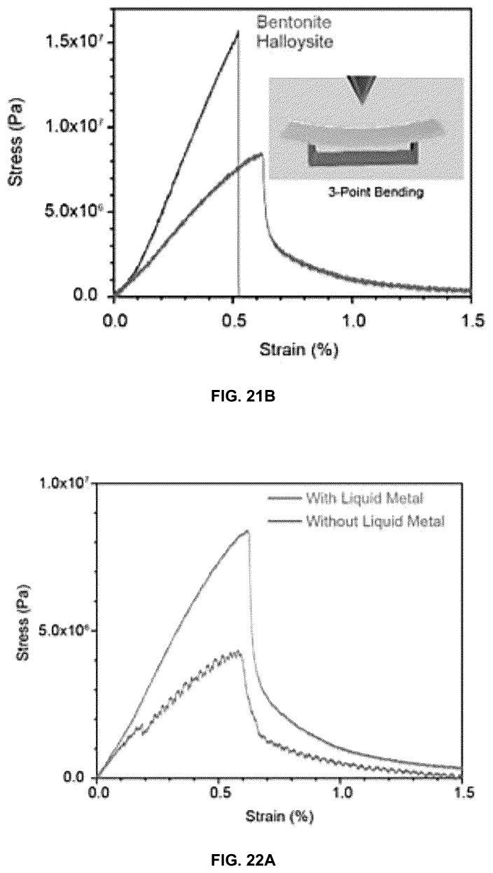

FIGS. 21A-21B describe the Young's moduli of soil-inspired material can range from 2 to 5 GPa through choices of nanoclays and their ratios in the composites. In particular, FIG. 21A describes a schematic and typical curves of the soil-inspired material under nanoindentation. Nanoindentation is a microscopic test that probes the sample surface in a local area. FIG. 21B describes a schematic and typical curves of soil-inspired material under three-point bending. Three-point bending in the dynamic mechanical analyzer is a standard technique to measure the bulk mechanical properties of a material.

FIGS. 22A-22B describe the mechanical properties of soil-inspired materials are influenced by liquid metal. In particular, FIG. 22A describes typical strain-stress curves from three-point-bending tests of soil-inspired materials, with and without liquid metal. FIG. 22B describes statistical analysis shows the soil-inspired material without liquid metal possesses a Young's modulus ˜half that of complete composite. Box bind interquartile range (IQR) divided by the median; whiskers extend 1.5±IQR. n=25 for sample with liquid metal and n=5 for sample without liquid metal.

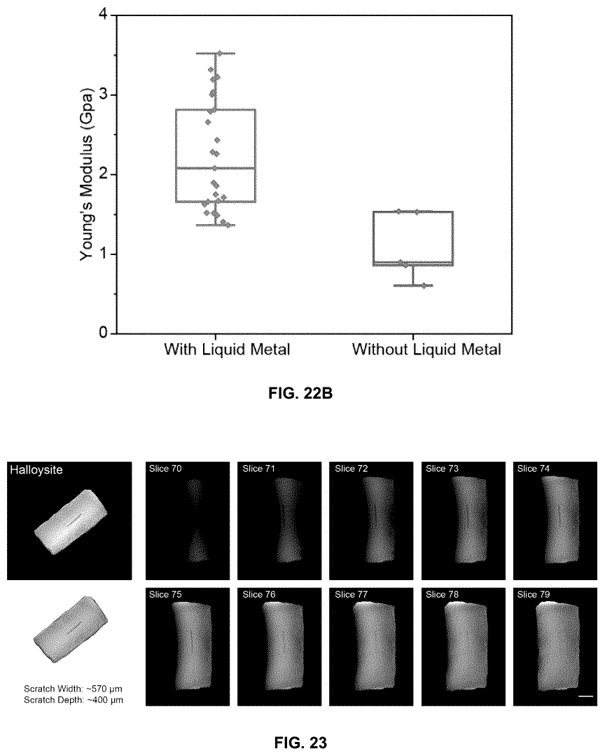

FIG. 23 describes X-ray microtomography (Micro-CT) experiments show the mechanically-sintered path on a soil-inspired material. Scale bar, 3 mm.

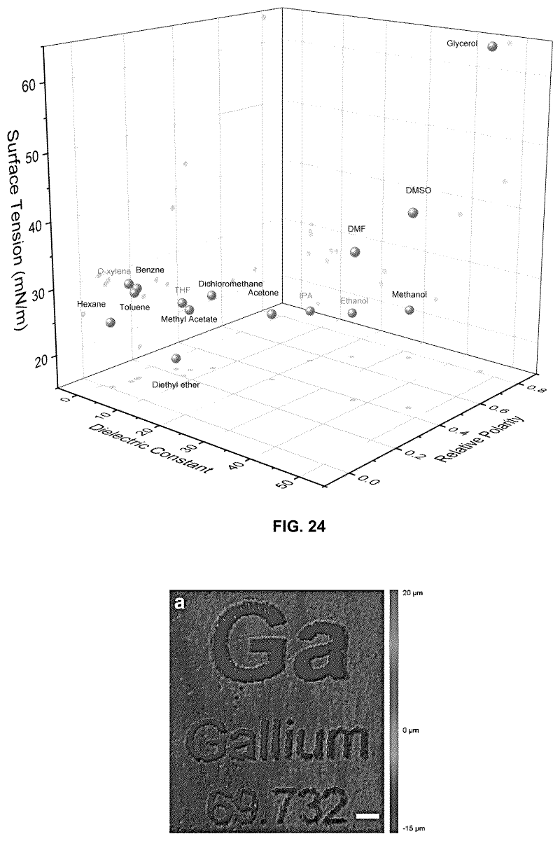

FIG. 24 describes a 3D plot of the relative polarity, dipole moment, and dielectric constant of tested solvents. Solvents that can erase conductivity are marked with red. Several factors may contribute to erasure of conductivity, including the polarity and dielectric properties of the solvent and their wettability changes on liquid metal at the interface with nanoclay and starch matrix. It is difficult to find universal features of the “working solvents” due to the complexity of the multi-component system.

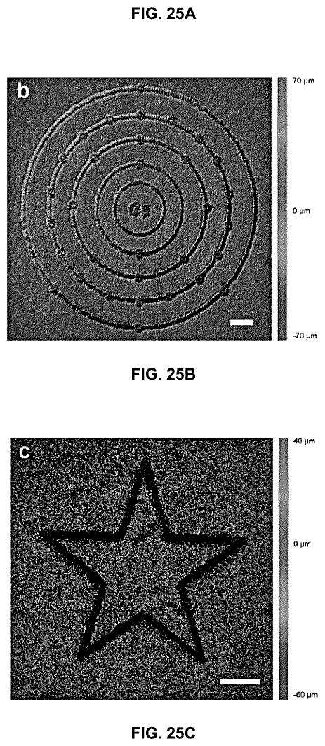

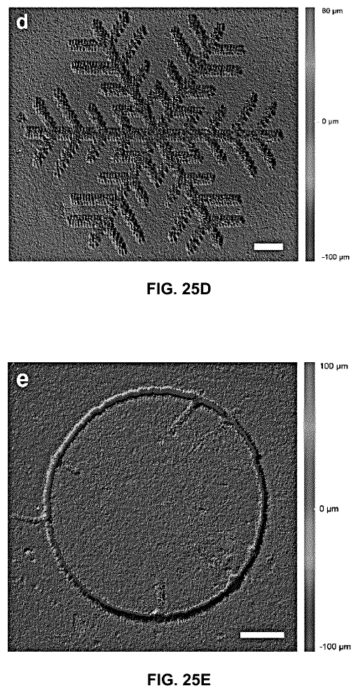

FIGS. 25A-25E describes laser-sinter different conductive patterns on the soil-inspired material. In particular, the images are taken on a 3D laser confocal scanning microscope, with patterns showing the gallium (Ga) element in FIG. 25A, the electron shell model of Ga in FIG. 25B, a star in FIG. 25C, a snowflake in FIG. 25D, and a circle in FIG. 25E. Scale bar, 1 mm.

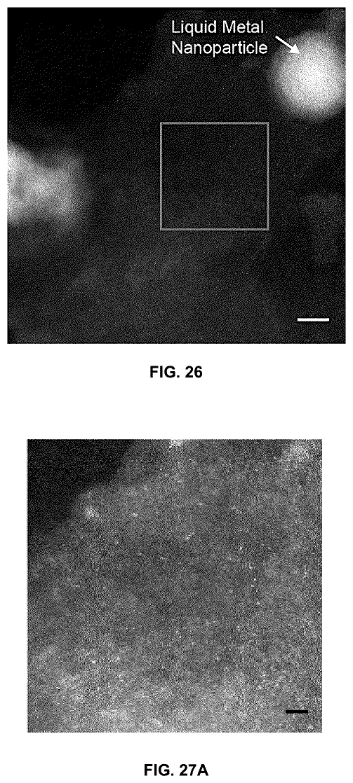

FIG. 26 describes a scanning transmission electron microscopy (STEM) image of the laser-sintered soil-inspired material. The image shows nanoclay-dominated areas (less electron-dense) with liquid metal nanoparticles (bright sphere, upper right). The area highlighted with a green box contains multiple single atoms. Scale bar, 5 nm.

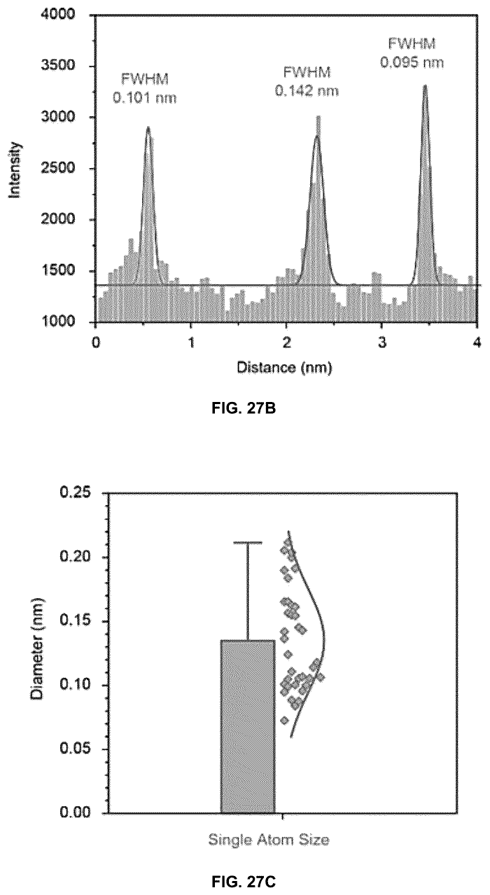

FIGS. 27A-27C describes a Gaussian fitting of a line histogram reveals the single atom size. In particular, FIG. 27A describes a STEM image of a representative area with multiple single atoms on a matrix. Scale bar, 2 nm. FIG. 27B describes a typical line histogram with Gaussian fitting calculates the full width at half maximum (FWHM) as the atom size. FIG. 27C describes statistical analysis of single atom sizes shows an average size of ˜0.13 nm. Data are presented as mean values±standard deviation, n=37.

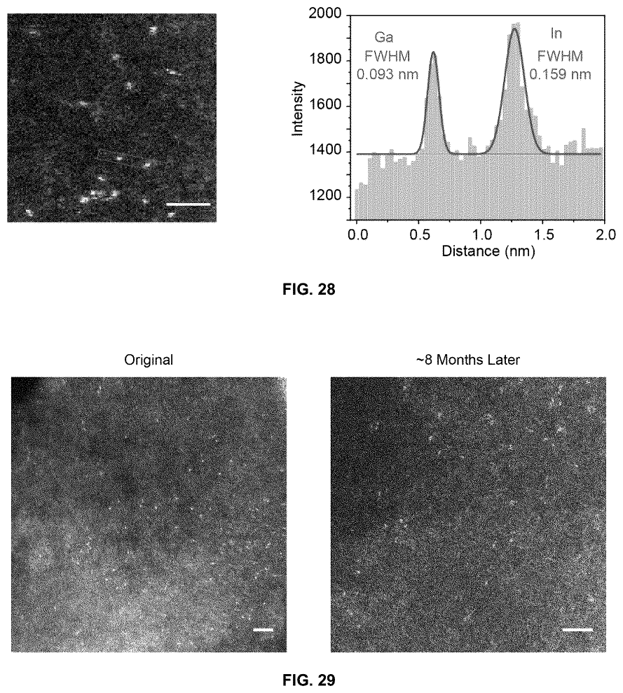

FIG. 28 describe electron microscopy (EM) image analysis indicates there are two types of single metal atoms. Several individual atoms can be seen in the STEM image. A line histogram fitted with a Gaussian distribution is used to estimate high-angle annular dark-field (HAADF) imaging intensity and single atom size. With higher signal intensity, the larger atom on the right indicates a higher atomic number, which indicates it is an In atom, while the smaller atom is Ga. Scale bar, 1 nm.

FIG. 29 describes that the single atoms remain stable for at least 8 months after laser sintering. The images were taken on the same sample. Scale bar, 2 nm.

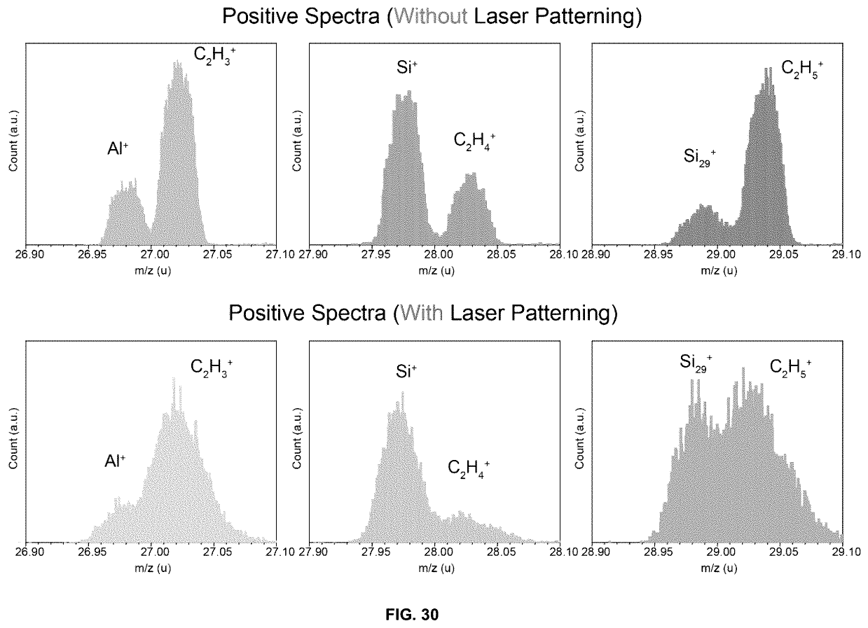

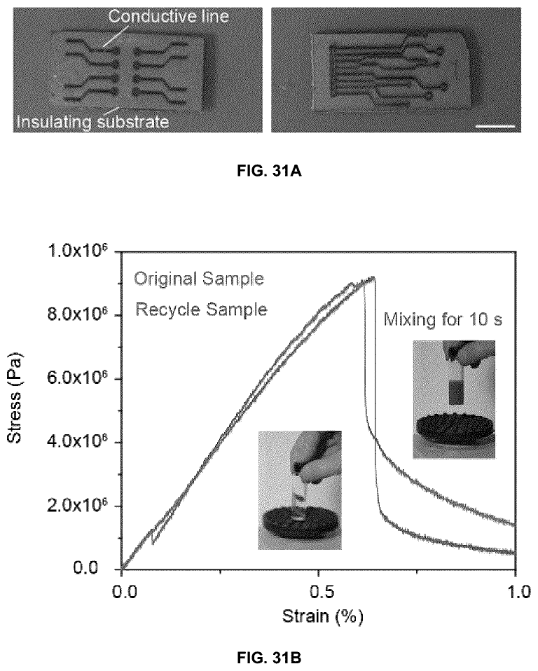

FIG. 30 describes that high-resolution time-of-flight secondary ion mass spectrometry (TOF-SIMS) confirms the existence of Al and Si elements even after laser patterning.

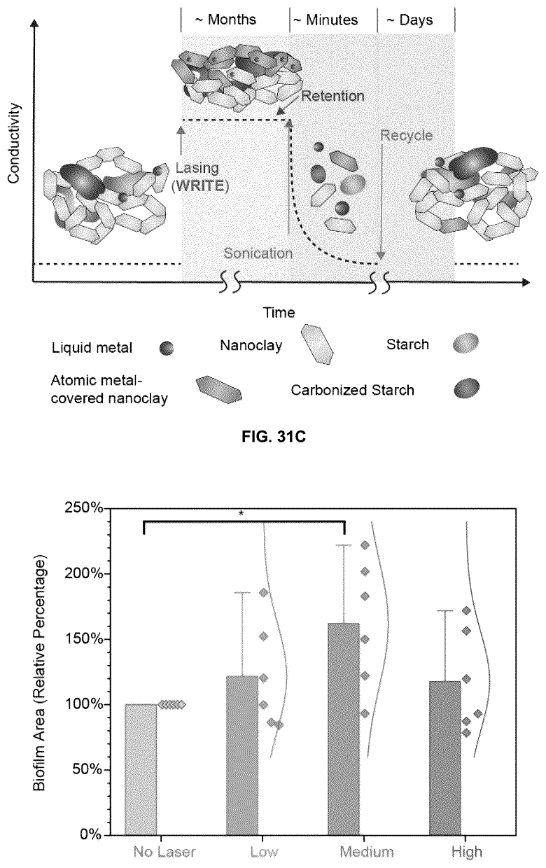

FIGS. 31A-31C describe that the soil-inspired material has the potential for recyclable electronics. In particular, FIG. 31A describes photographs of two circuit lines made by laser patterning from soil-inspired materials. Scale bar, 5 mm. FIG. 31B describes that after recycling, soil-inspired material performs almost as well as the original material in terms of mechanical performance. FIG. 31C describes a diagram showing how soil-inspired materials can be laser patterned to endow conductivity and then refabricated from recycled materials.

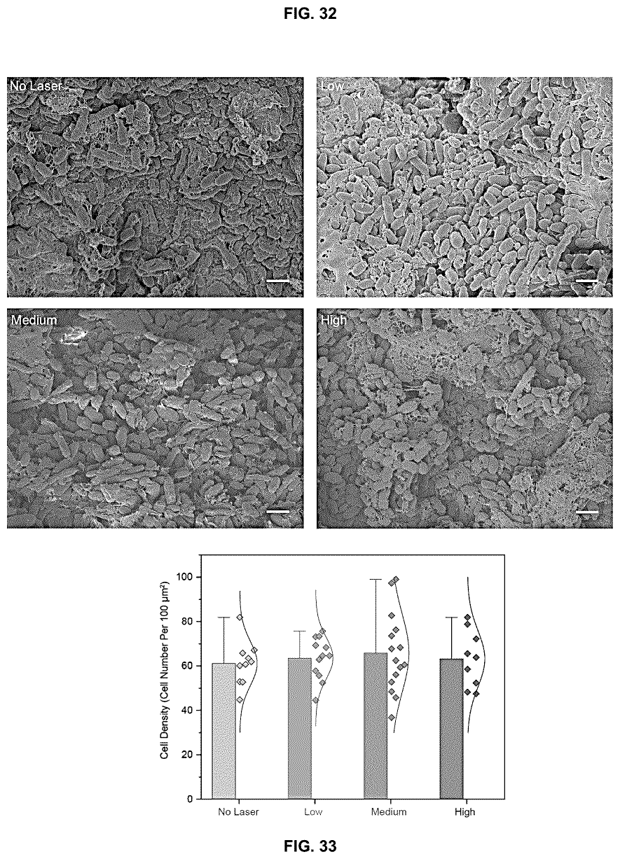

FIG. 32 describes suitable laser power can enhance Bacillus Subtilis biofilm growth. ‘Low’, ‘Medium’, and ‘High’ labels correspond to 2%, 5%, and 10% laser power, respectively. p=0.02716, Two-tailed Student's t-test. Data are presented as mean values±standard deviation (n=6 for all samples).

FIG. 33 describes biofilm cell density on soil-inspired material is not significantly affected by different laser powers. Scale bars in the SEM images, 2 μm. ‘Low’, ‘Medium’, and ‘High’ labels correspond to 2%, 5%, and 10% laser power, respectively. Data are presented as mean values±standard deviation (n=10, 12, 15, and 10, respectively).

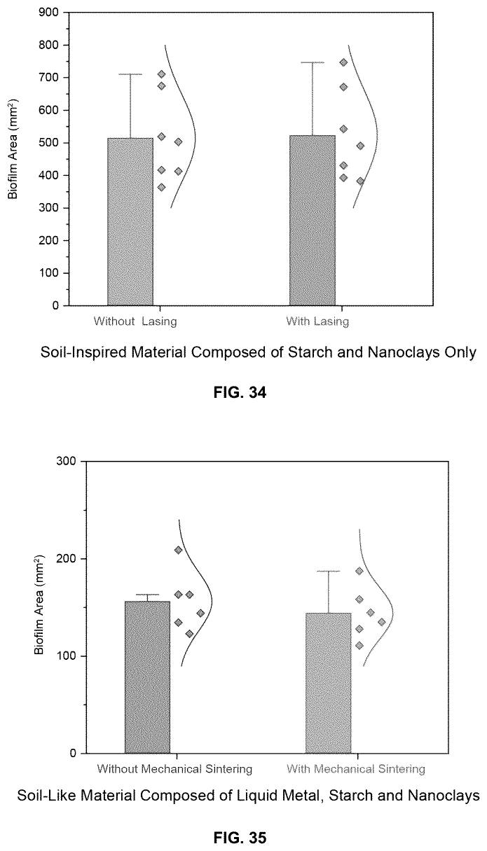

FIG. 34 describes that the benchmark experiment shows that lasing on soil-inspired material without liquid metal does not enhance bacterial growth. Biofilm modulation requires liquid metal, as demonstrated in this experiment. Data are presented as mean values±standard deviation (n=7 for both samples).

FIG. 35 describes a benchmark experiment shows that mechanically sintering soil-inspired materials doesn't enhance bacterial growth. It appears that laser sintering, rather than conductivity, is essential to modulating biofilms. Data are presented as mean values±standard deviation (n=6 for both samples).

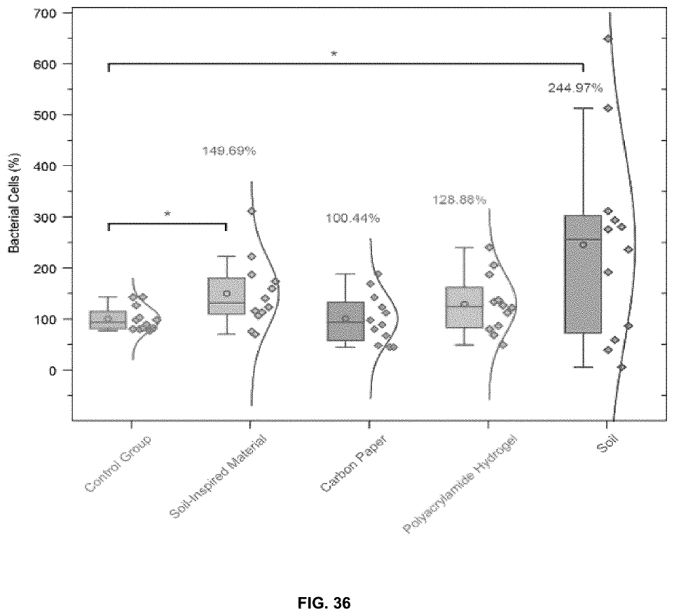

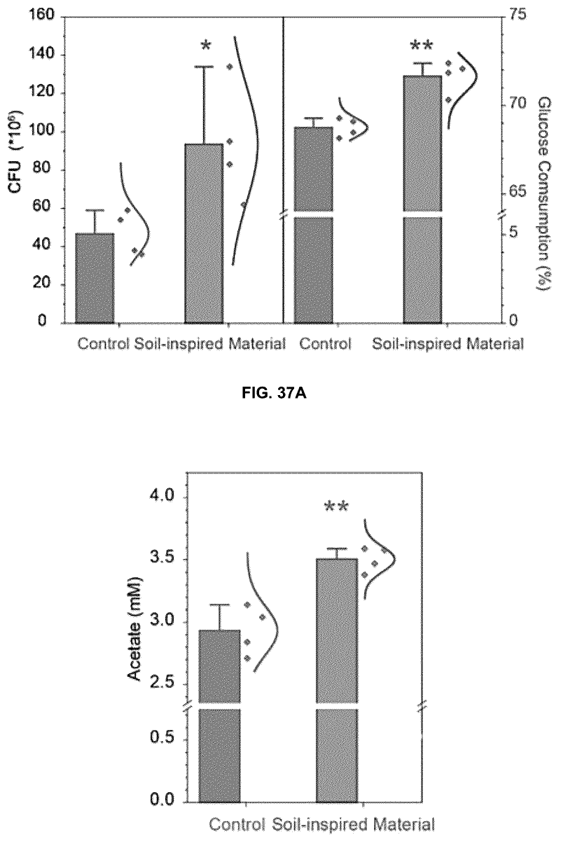

FIG. 36 describes a liquid flask culture of Bacillus Subtilis can be enhanced by soil-inspired materials and soil. The soil-inspired material increases the bacterial cell number to 149.69% (p=0.0256) and soil increases the bacterial cell number to 244.97% (p=0.0166) of control numbers. Two-tailed Student's t-test. Box bind interquartile range (IQR) divided by the median; whiskers extend 1.5±IQR (n=12).

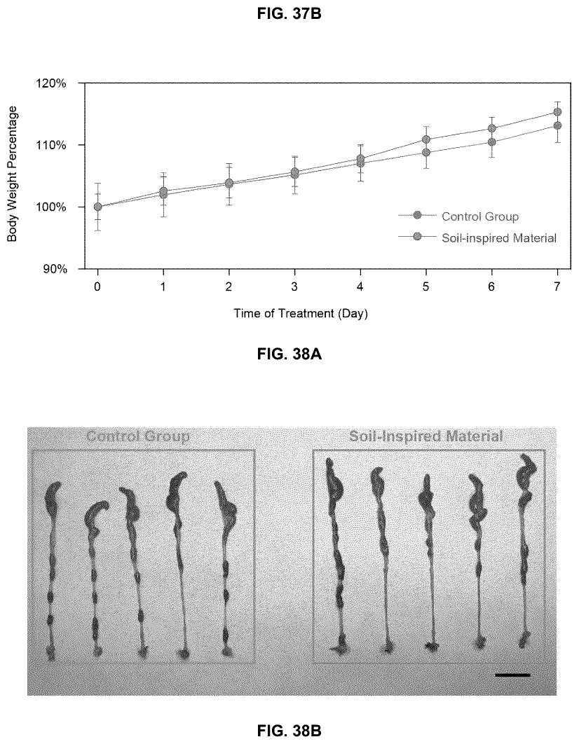

FIGS. 37A-37B describe that the soil-inspired material can enhance the growth of E. coli in flask culture and enhance biofuel production. In particular, FIG. 37A describes soil-inspired material modulates E. coli growth in liquid culture, as shown by an increase in colony-forming units (CFU) (p=0.0278), and improves glucose consumption, the primary carbon source (p=0.0016). Two-tailed Student's t-test. Data are presented as mean values±standard deviation (n=4 for both samples). FIG. 37B describes that soil-inspired material modulates bacterial metabolism to produce higher levels of acetate (p=0.001909). Two-tailed Student's t-test. Data are presented as mean values±standard deviation (n=4 for both samples).

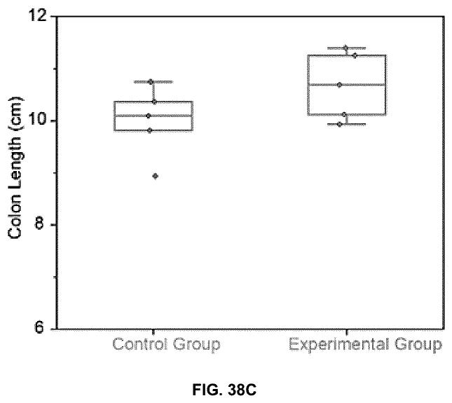

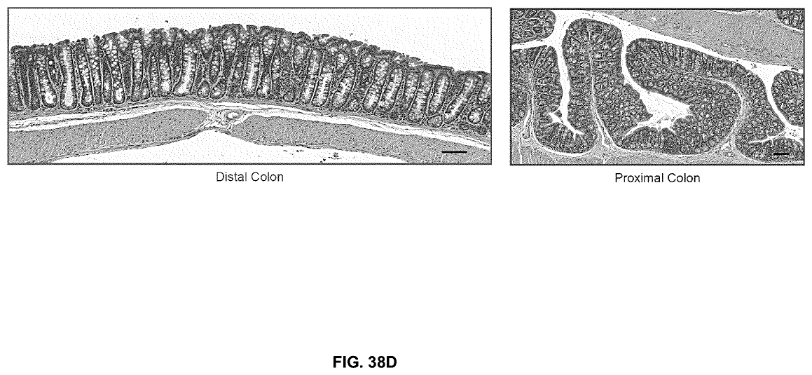

FIGS. 38A-38D describe that the soil-inspired material shows good in vivo biocompatibility and biosafety. In particular, FIG. 38A describes that the change of mouse body weight percentage over 7 consecutive days with oral administration of soil-inspired material. Results show no difference between treated mice and the control group who received orally administered distilled water, demonstrating the biosafety and biocompatibility of the soil-inspired material. Data are presented as mean values±standard deviation. FIG. 38B describes optical images of colons from soil-inspired material-treated group and control group. Scale bar, 2 cm. FIG. 38C describes that colon length is an important indicator for colon health and is typically shortened with damage or lesions. Statistical analysis shows no difference in colon lengths between the soil-inspired material and control groups. Box bind interquartile range (IQR) divided by the median; whiskers extend 1.5±IQR (n=5). FIG. 38D describes hematoxylin and eosin (H&E) staining of the distal colon and proximal colon from the soil-inspired material group shows a healthy colonic structure. Scale bar, 100 μm.

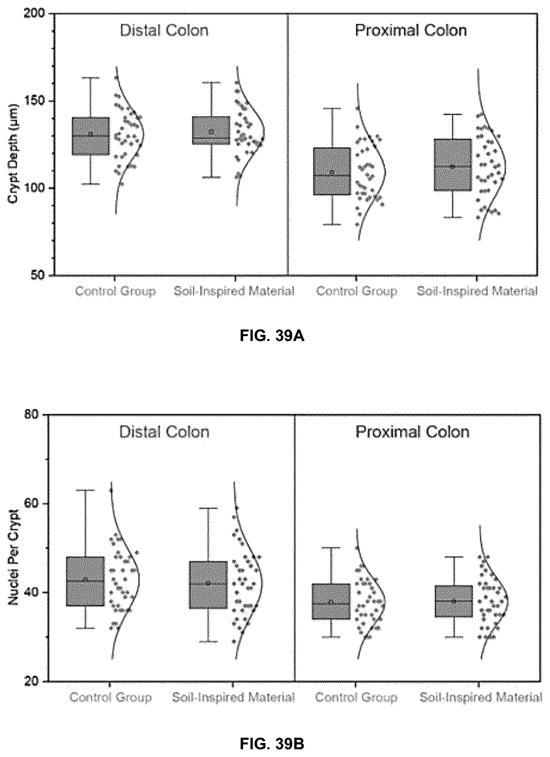

FIGS. 39A-39D describe quantitative analysis of colon histology confirms a healthy colon following oral administration of soil-inspired material. In particular, FIG. 39A describes statistical analysis of the distal and proximal colon crypt depth shows no difference between the soil-inspired material and control groups. Box bind interquartile range (IQR) divided by the median; whiskers extend 1.5±IQR (n=40). FIG. 39B describes statistical analysis of the nuclei per crypt in the distal and proximal colon shows no difference between the soil-inspired material and control groups. Box bind interquartile range (IQR) divided by the median; whiskers extend 1.5±IQR (n=40).

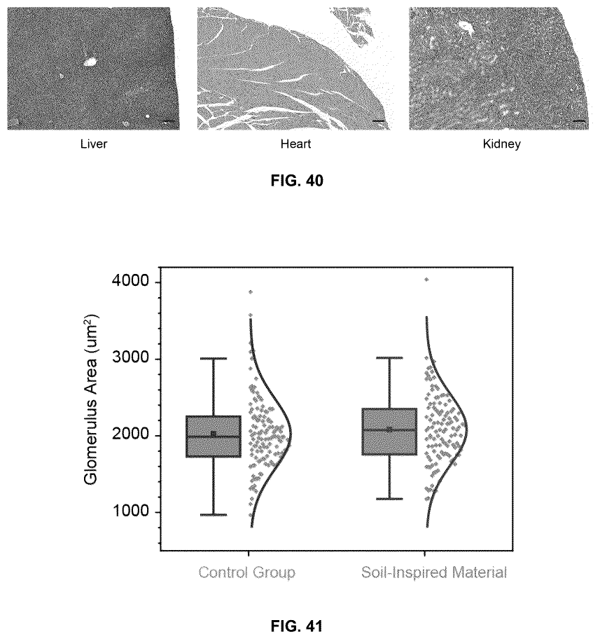

FIG. 40 describes H&E staining of internal organs confirms the biosafety and biocompatibility of the soil-inspired material. Histology of liver, heart, and kidney shows no lesion or damage, indicating the healthy condition of mice orally administrated with soil-inspired material. Scale bar, 100 μm.

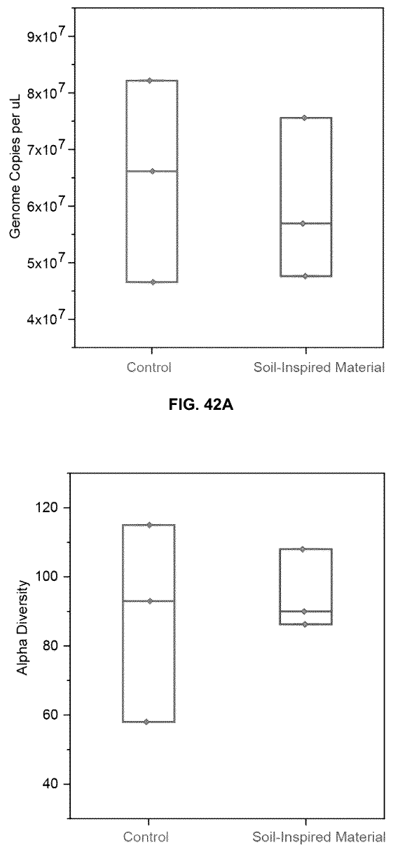

FIG. 41 describes quantitative analysis of kidney histology confirms a healthy kidney following oral administration of soil-inspired material. With the nephron as the functional unit, the kidney is responsible for the excretion of waste and harmful chemicals. Statistical analysis of the glomerulus areas within the kidney shows no difference between the soil-inspired material and control groups. Box bind interquartile range (IQR) divided by the median; whiskers extend 1.5±IQR (n=40).

FIGS. 42A-42B describe that 16S rRNA sequencing shows the soil-inspired material does not cause dysbiosis in gut bacteria. In particular, FIG. 42A describes statistical analysis on the absolute gene abundance shows no difference between the control and soil-inspired material groups. Box bind interquartile range (IQR) divided by the median; whiskers extend 1.5±IQR (n=3). FIG. 42B describes statistical analysis on the alpha diversity shows no difference between the control and soil-inspired material groups. Box bind interquartile range (IQR) divided by the median; whiskers extend 1.5±IQR (n=3).

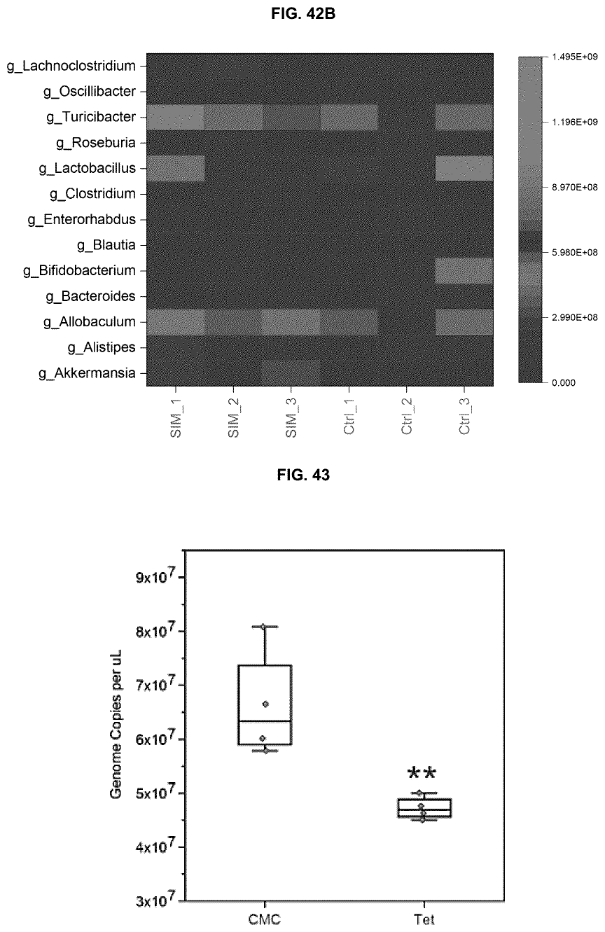

FIG. 43 describes a taxonomy abundance heatmap indicates no gut microbiota dysbiosis. The absolute abundance of 13 richest genera in gut bacteria, including g_Akkermansia, g_Alistipes, g_Allobaculum, g_Bacteroides, g_Blautia, g_Bifidobacterium, g_Clostridium, g_Enterorhabdus, g_Lachnoclostridium, g_Lactobacillus, g_Roseburia, g_Turicibacter, and g_Oscillibacter, was analyzed and plotted as a taxonomy abundance heatmap. There are no statistical differences, indicating no gut microbiota dysbiosis. ‘SIM’ denotes soil-inspired material.

FIGS. 44A-44B describe that 16S rRNA Sequencing confirms successful induction of dysbiosis with tetracycline. In particular, FIG. 44A describes statistical analysis on the absolute gene abundance shows a significant decrease after tetracycline treatment, indicating dysbiosis in gut bacteria. (p=0.011) Two-tailed Student's t-test. Box bind interquartile range (IQR) divided by the median; whiskers extend 1.5±IQR (n=4). FIG. 44B describes statistical analysis on the alpha diversity shows no difference after tetracycline treatment. Box bind interquartile range (IQR) divided by the median; whiskers extend 1.5±IQR (n=4). ‘CMC’ denotes carboxymethyl cellulose.

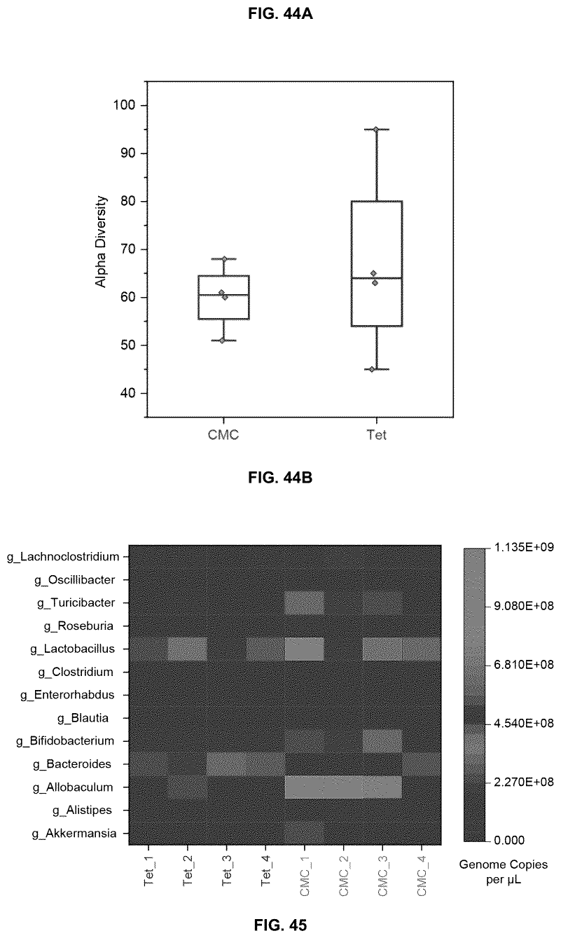

FIG. 45 describes a taxonomy abundance heatmap of the 13 richest genera confirms tetracycline-induced gut bacteria dysbiosis. The absolute abundance of 5 genera, including g_Akkermansia, g_Alistipes, g_Allobaculum, g_Clostridium, and g_Turicibacter, was significantly reduced after tetracycline treatment. The vehicle group received an orally administered carboxymethyl cellulose (CMC) suspension.

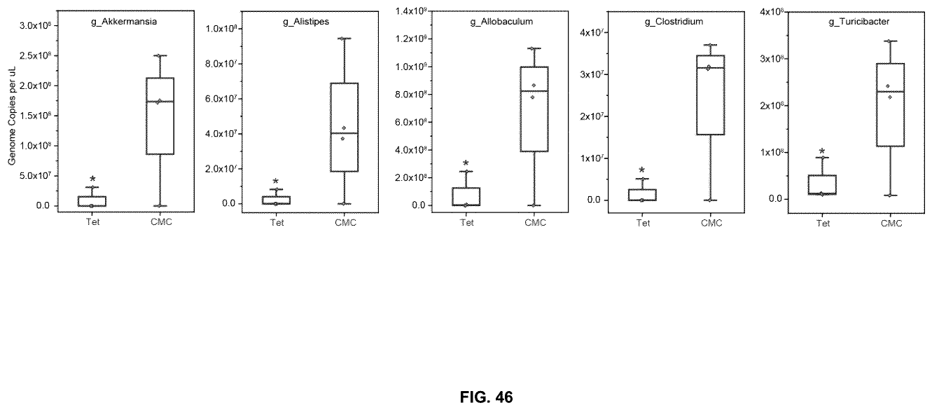

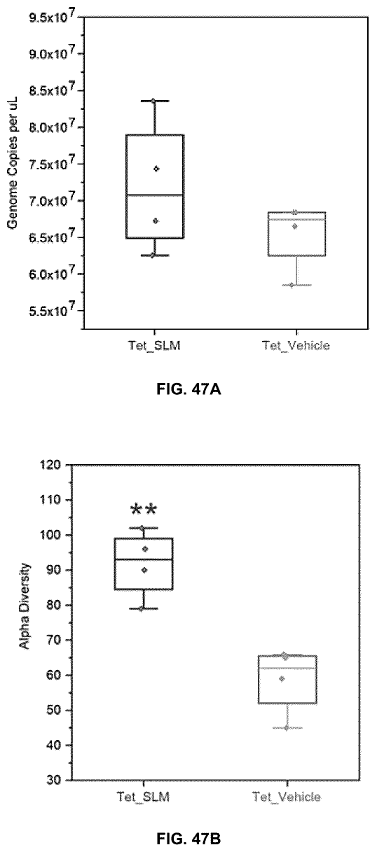

FIG. 46 describes that tetracycline treatment induces a significant reduction in the absolute abundance of several genera. Five genera, including g_Akkermansia (p=0.019), g_Alistipes (p=0.038), g_Allobaculum (p=0.023), g_Clostridium (p=0.0159), and g Turicibacter (p=0.02793), were significantly reduced after tetracycline treatment. Two-tailed Student's t-test. Box bind interquartile range (IQR) divided by the median; whiskers extend 1.5±IQR (n=4).

FIGS. 47A-47B describe that 16S rRNA sequencing confirms that soil-inspired material can enrich gut bacteria diversity under pathological conditions. a) Statistical analysis on the absolute gene abundance shows an increase in absolute abundance of the gut bacteria, although not a significant difference. Box bind interquartile range (IQR) divided by the median; whiskers extend 1.5±IQR (n=4). b) Statistical analysis shows treatment with soil-inspired material can significantly increase the alpha diversity, which indicates a healthy microbiota. ‘SIM’ denotes soil-inspired material (p=0.003). Two-tailed Student's t-test. Box bind interquartile range (IQR) divided by the median; whiskers extend 1.5±IQR (n=4).

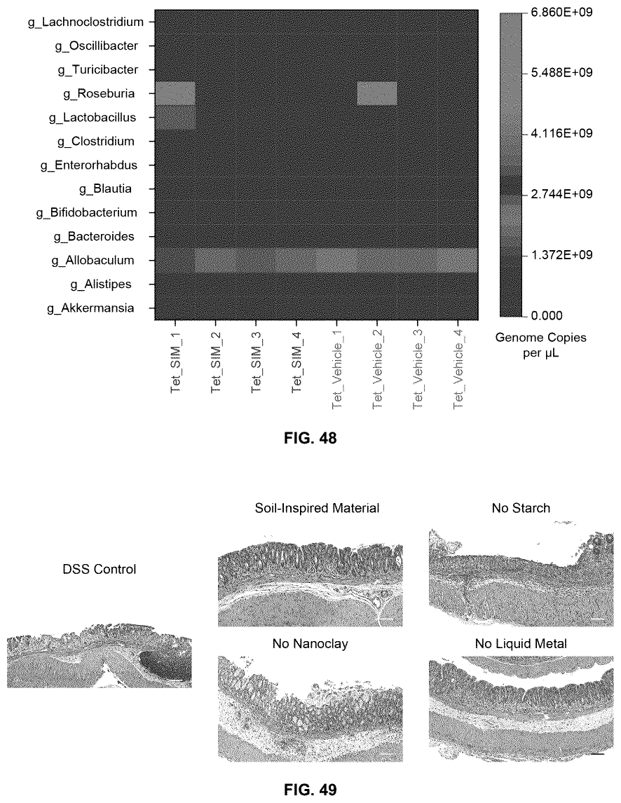

FIG. 48 describes that soil-inspired material enriches bacterial diversity after gut microbiome dysbiosis induced by tetracycline. Taxonomy abundance heatmap of 13 richest genera shows that the soil-inspired material modulates gut bacteria, with a statistical difference in 4 genera, including g_Allobaculum, g_Oscillibacter, g_Blautia, and g_Enterorhabdu.

FIG. 49 describes that representative histology images of the colon region show that the administration of the soil-inspired materials achieved the best protective effect on colonic epithelial intactness, crypt damage, and inflammatory injury in DSS-induced colitis. Scale bar 100 μm.

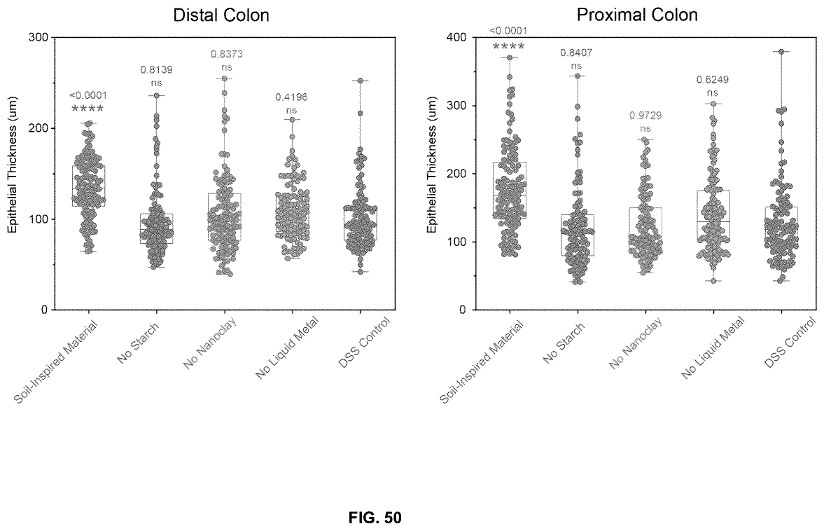

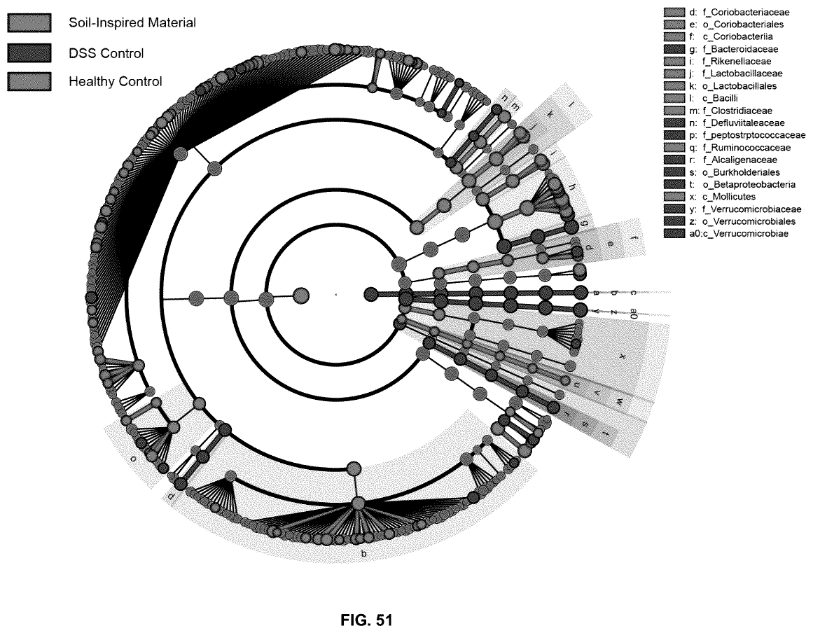

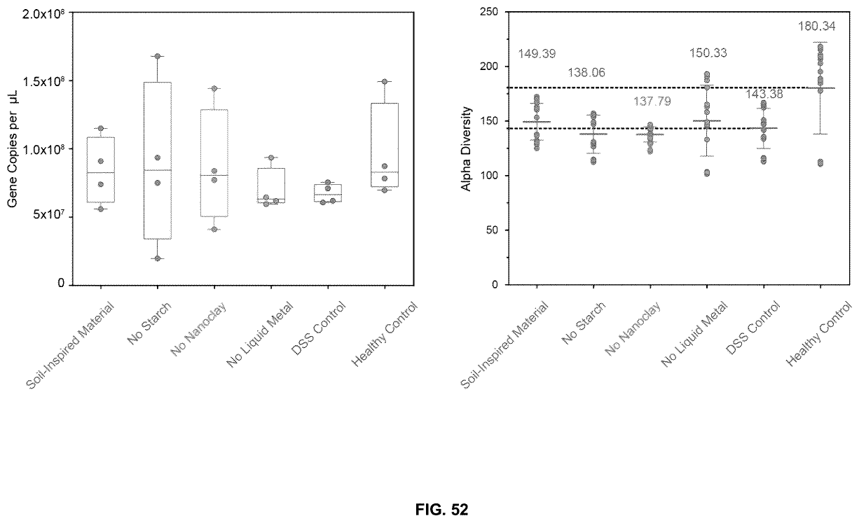

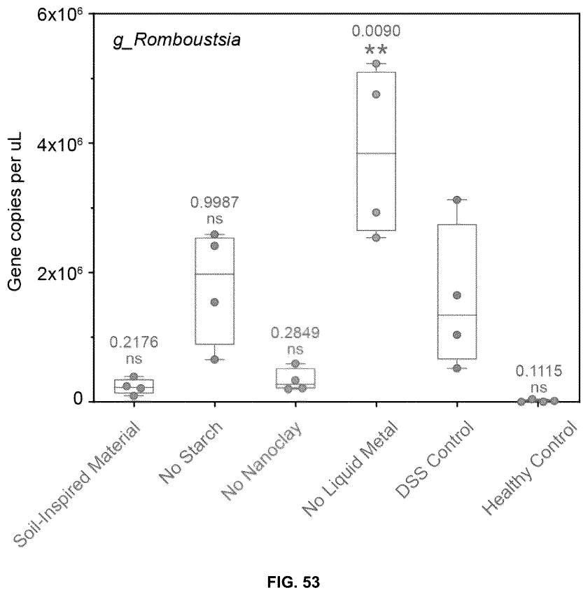

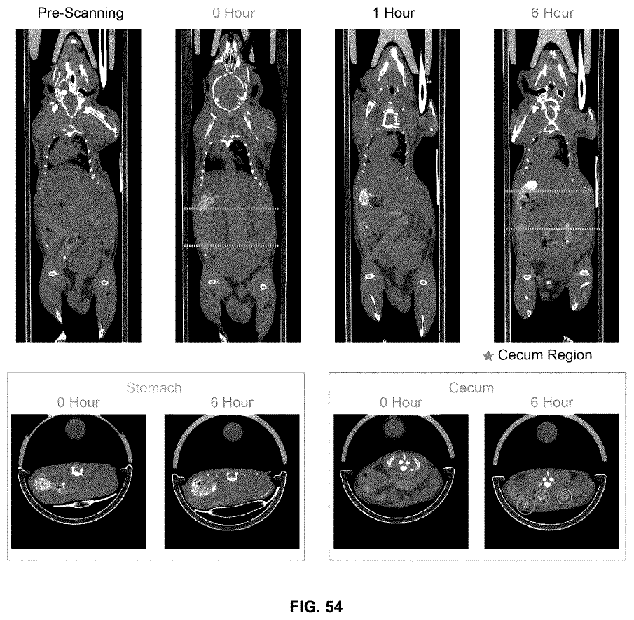

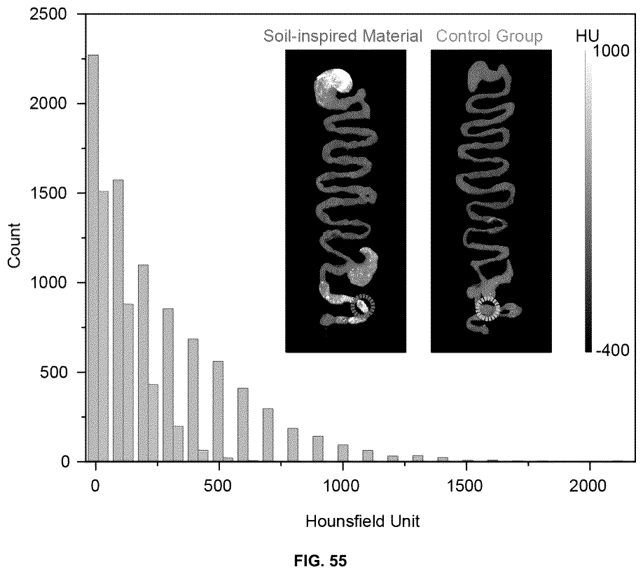

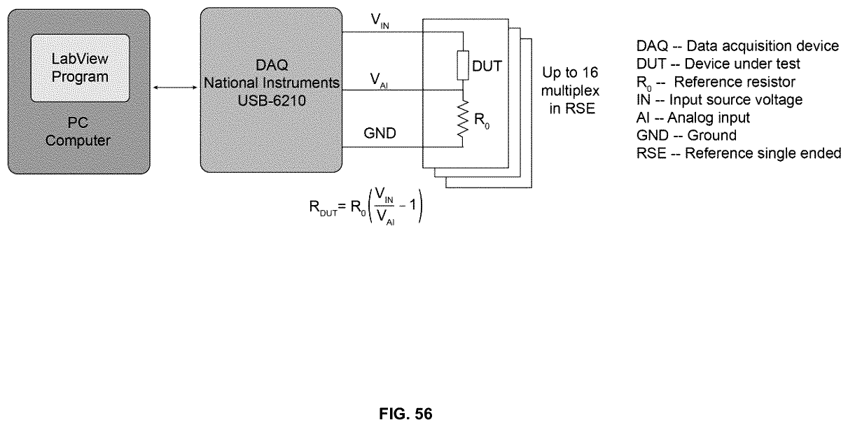

FIG. 50 describes that the soil-inspired material helps maintain the mucus layer (epithelial thickness) in both distal colon and proximal colon in DSS-induced rodent colitis. Boxes bind interquartile range (IQR) divided by the median; whiskers extend 1.5±IQR. All datapoints are plotted (n>100). P values are determined by ordinary one-way ANOVA with Tukey's multiple comparisons test; P value is <0.0001 (****) for ANOVA summary in both distal colon data and proximal colon data; all the Tukey's multiple comparison shown in figure are between DSS control and corresponding experimental groups. ns, not significant or p>0.05. Box bind interquartile range (IQR) divided by the median; whiskers extend 1.5±IQR (n=137, 124, 116, 111, 115, 126,101, 101, 135, and 108, respectively).

FIG. 5I describes that linear discriminant analysis Effect Size (LEfSe) taxa analysis confirms that the soil-inspired material alters the microbiome composition compared to healthy and DSS control. The military yellow color indicates the species with no significant difference between groups.

FIG. 52 describes that no significant difference was observed in either absolute gene abundance or alpha diversity of the total fecal bacterium population between experimental groups, including soil-inspired material, no starch, no nanoclay, no liquid metal, DSS treated group, and the healthy control group. P values are determined by ordinary one-way ANOVA with Tukey's multiple comparisons test. n=4 for absolute gene abundance and n=40 for alpha diversity. Box bind interquartile range (IQR) divided by the median; whiskers extend 1.5±IQR.

FIG. 53 describes that the material combination without liquid metal (indicated as “No Liquid Metal”) significantly worsened the Romboustsia dysbiosis induced by DSS treatment, which indicates the potentially positive effect of liquid metal on Romboustsia dysbiosis. Boxes bind interquartile range (IQR) divided by the median; whiskers extend 1.5±IQR. All datapoints are plotted (n=4). P values are determined by ordinary one-way ANOVA with Tukey's multiple comparisons test; P value is <0.0001 (****) for ANOVA summary in both distal colon data and proximal colon data; all the Tukey's multiple comparison shown in figure are between DSS control and corresponding experimental groups. ns, not significant or p>0.05.

FIG. 54 describes that micro CT imaging sequence indicates the location of orally administrated soil-inspired material in gastrointestinal tracts.

FIG. 55 describes that Ex-vivo comparison of gastrointestinal tract 6 hours following oral administration of soil-inspired material and control gastrointestinal tissue without exposure to the material. The CT images indicate the distribution of soil-inspired material in the colon region and the accumulation in feces (highlighted with circles). The histogram presents the numbers of pixels of the highlighted circles in the images in terms of their radio intensity (in the Hounsfield unit).

FIG. 56 describes that System developed for real-time conductivity measurement with multiple samples under solvent exposure.

As discussed above, the present inventors have designed and synthesized a soil-inspired material for microbial modulation using a bottom-up approach and demonstrate its capacity as a responsive microbial modulation platform in vitro and in vivo (FIG. 1A). The present inventors have incorporated nanostructured minerals (a component of natural soil) as structural building blocks, alongside starch granules and liquid metals (Supplementary Table 1, FIG. 1B) to endow the material with dynamic responsiveness; these three components loosely represent the inorganic, organic, and mobile phases in natural soil. Using synchrotron-based correlative 3D X-ray fluorescence and ptychographic tomography, and electron microscopy imaging, we confirm that the soil-inspired material is structurally similar to natural soil, with heterogeneous porosity. Like soil, the porous complex is an active matrix, and it is responsive to force and vapor, which induce chemical redistribution (FIG. 1A). The material possesses several unique properties due to the liquid metal component, including mechanically enabled and chemically erasable electrical conductivity. The soil-inspired system can also be post-synthetically modified with laser irradiation to endow the chemical heterogeneity from the atomic scale. In in vitro experiments, the soil-inspired material enhances biofilm growth, bacterial growth, and biofuel production. In vivo, the material enriches gut bacterial diversity and rectifies bacterial dysbiosis under a pathophysiological condition. It also effectively protects the gastrointestinal epithelium and mitigates colitis symptoms in a dextran sulfate sodium (DSS)-induced rodent colitis model. The combined contributions from the material components (Supplementary Table 1) give rise to a new adaptive chemical system that can interface with microbiota for both biological and non-biological applications.

As known in the art, many starches have the capability to undergo gelatinization. Gelatinized starch can thus act as an organic glue-like material.

Bacterial culture can be used for the production of a wide range of biofuels and chemicals. For example, bacterial production of a number of valuable products is discussed in Mukhopadhyay, A. “Tolerance engineering in bacteria for the production of advanced biofuels and chemicals.” Trends in Microbiology 23, 498-508 (2015).

In various embodiments, the materials as otherwise described herein can be used to product conductive-patterned substrates. The conductive-patterned substrates can serve as responsive electronic devices. The circuit can be determined by mechanical or laser sintering, and the conductivity could be further tuned into non-conductivity with the presence of vapor, making it also useful as a chemical sensor. Further, those substrates can be recycled easily and re-fabricated into new devices. In some embodiments, the material as described herein can be bound in any suitable manner, e.g., adhesives, compression, heat, lasers, etc., to a surface of a suitable substrate, e.g., glass, silicon, or plastics, to generate conductive lines or processed to create conductive lines that have a variety of uses. In one embodiment, the conductive lines can be useful in electronic circuits or devices including such electronic circuits. Electronic circuits can include one or more switches, resistors, transistors, capacitors, inductors, diodes, etc., which are connected by the conductive lines including wires or traces through which electric current can flow. The conductive lines can be generated by applying any suitable method including lasers, compression, or carbonization to the material on the substrate.

### EXAMPLES

### Materials and Procedures

### Chemicals

The liquid metal EGaln was purchased from Indium Corporation with 75.5 wt % of gallium and 24.5 wt % of indium. The nanoclays, bentonite (682659), and halloysite (685445) were purchased from Sigma Aldrich. The tapioca starch, mean diameter of 10.09±3.32 μm, was purchased from a local market.

### Soil-Inspired Material Fabrication

To prepare the soil-inspired material, we first added starch granules and nanoclay into deionized (DI) water in ratios from 1:1:8 to 1:1:18. The suspension was stirred overnight to ensure the full hydration of the starch granules. Then we added liquid metal into the well-dispersed suspension, followed by probe sonication for 5 mins to break the liquid metal into nanoparticles and form a slurry. The liquid metal has the same weight as the nanoclay. We transferred the slurry into a design container for directional freezing in a cooling bath composed of dry ice and ethanol, with a cooling temperature of ˜72° C. Directional freezing is the process of forcing water to freeze in a singular direction. In this case, we place the mixer of the solution into a container, such as the UV cuvette, and the whole sample is placed on a copper column and immersed in a dry ice-ethanol bath. Ice crystals will nucleate on one side of the slurry and grow along the temperature gradient to form porous structures.

Once it was entirely frozen, we freeze-dried the sample overnight at 0.1 mbar pressure with Freeze Dryer (Labconco 7670520) to form a layer-structured porous scaffold. Finally, we compressed the porous scaffold samples at 100° C. for one hour by platen press (Dake 44-225) to form the soil-inspired material with a pressure of 10 tons. The compression was performed on a 20 cm×20 cm plate, corresponding to an applied pressure of 22.2 MPa. The soil-inspired material was trimmed into desired shapes for the following experiments. The procedure was the same for the control sample without liquid metal, with the omission of the liquid metal during the probe sonication.

### Ultramicrotomy Sample Preparation

The soil-inspired samples were infiltrated by a polymer resin (EpoThin™ 2 Epoxy Resin) in a vacuum chamber to fill the pores for imaging. The surfaces were polished on the polishing wheel with grit paper, and ion milling (Triple Beam Ion Miller—Leica TIC3X) was applied to polish the sample so that the soil-inspired material's cross-section was exposed to air. The samples were then ready for microtome or focused ion beam (FIB) experiments. In ultramicrotomy experiments, samples were mounted directly into a Leica UC7 ultramicrotome with a clamp-style chuck, and a block face was created with a diamond trimming tool. Sectioning occurred dry without a water trough using a 35-degree histo-cryo diamond knife (Diatome). In addition, 200 nm thin sections were carefully collected with an eyelash manipulator made from a canine hair and deposited on a clamshell-style grid coated with formvar and 4 nm of carbon. (EMS Cat. #GD1010-Cu).

### X-Ray Fluorescence Imaging and X-Ray Ptychography

X-ray fluorescence imaging and X-ray ptychography were performed using Bionanoprobe¹ at 9-ID-B in the Advanced Photon Source (APS) of Argonne National Laboratory. We prepared two different types of samples for X-ray fluorescent imaging and X-ray ptychography: 1) thin samples (˜200 nm) produced using a microtome as mentioned above, and secured on Si₃N₄ membranes, and 2) a pyramid-shaped pillar approximately 20 μm in diameter. A coherent monochromatic X-ray beam at 10.7 keV energy was focused on the sample by a Fresnel zone plate into a spot of ˜90 nm. While a sample was raster scanned across the incident beam, full fluorescence spectra and diffraction patterns from each scan point were simultaneously recorded by a fluorescence detector and a pixelated area detector (Dectris Pilatus 300K), respectively, placed about 2.4 meters downstream of the sample. For tomography data collection, the sample was rotated to a new angle with a 2° increment after finishing a 2D projection until the whole 3D scan was completed. Thus, a total of 91 projections from an angular range of −90° to 90° were collected over about 18 hours, including experimental interruptions. Post-measurement data analysis included fluorescence spectrum fitting and quantification to construct elemental distributions, ptychography phase retrieval, image reconstruction, and tomography reconstruction. Fluorescence spectrum analysis was performed using MAPS, an IDL-based program developed in-house². 2D ptychographic and fluorescence images were processed following the method³ in ptychographic reconstruction, the central 256 pixels×256 pixels of each diffraction pattern were cropped, resulting in an image pixel of 6.3 nm; elemental fluorescence maps, including gallium (Ga), indium (In), and silicon (Si), were reconstructed from the collected fluorescence spectra using MAPS software. After excluding some low-quality projections, the best 85 projections of ptychographic and fluorescence images were used for tomography reconstruction. Images after reconstruction were also registered and analyzed using VivoQuant 4.0 patch 1 (InviCRO, LLC, Boston, USA). Ptychography measurements were collected using a custom code written in Python 2.8 with PyEpics package.

### Scanning Electron Microscopy Imaging (SEM)

A scanning electron microscope (Carl Zeiss, Merlin) was used to image the morphology of multiple samples, including starch granules, layer-structured porous scaffold, and soil-inspired material with/without laser writing. The SEM imaging was performed without sputter coating conductive layers for the samples, including porous scaffold samples and soil-inspired samples with/without laser writing to avoid disruption of sample morphologies. The acceleration voltage of SEM was set at 2 kV. At least 20 measurements were performed for each sample to ensure consistency.

### Focused Ion Beam (FIB)

Cross-sectional images on soil-inspired material, the infiltrated and polished sample, were obtained with a FIB system (SPF FEI Helios FIB/SEM). The ion beam (30 kV, 0.46 nA) was used to sputter the substrate at a normal incidence angle, and the electron beam (5 kV, 1.4 nA) was used for imaging at 52°. A 10 μm×10 μm region was etched with 4000 passes to reveal the cross-sectional information. The images collected at 52° were stretched with the built-in angle correction function in the Helios to produce the images obtained at the cross section's normal direction. Slices of the soil-inspired material were milled starting from the edge of the 10 μm×10 μm region with a slice thickness of 50 nm to obtain the video. Electron-beam images were captured after milling each slice. The stacked images were made into videos via ImageJ with 10 frames per sec.

### Transmission Electron Microscopy Imaging (TEM)

Transmission electron microscopy (TEM) was performed on FEI F30 to image the nanoclay, liquid metal particles, and microtomed samples. The microtomed sample was imaged under FEI F30 at 300 kV directly. Liquid metal particles and nanoclay suspensions were diluted with DI water and dropped onto copper grids (Ted Pella Inc., Lacey Formvar/Carbon, 200 meshes), and the samples were imaged under FEI 30 at 300 kV after thoroughly drying.

### Scanning Transmission Electron Microscopy Imaging (STEM)

Scanning transmission electron microscopy (STEM) was carried out using a 200 kV aberration-corrected JEOL ARM200F with a cold field emission source, which gives a spatial resolution ˜0.8 Å. High angle annular dark field (HAADF) detector angle is 90-270 mrad to give Z contrast images. Low angle annular dark field (LAADF) detector angle is 40-120 mrad, and STEM EDS was carried out by an Oxford X-max 100TLE windowless SDD X-ray detector equipped with the JEOL ARM 200F.

### Time-of-Flight Secondary Ion Mass Spectrometry (TOF-SIMS)

ToF-SIMS analysis was conducted on a Physical Electronics PHI TRIFT III secondary ion mass spectrometer. The primary beam is a gallium ion source with 15 kV energy. The positive ion spectra were collected in an area of 100 μm² for three minutes with/without laser-writing. Data were analyzed using the WinCadence software, and mass calibration was performed on hydrocarbon secondary ions.

### Dynamic Mechanical Analyzer Test

The dynamic mechanical properties of the composites were measured with the three-point bending test. A machine (TA Instruments RSA-G2 dynamic mechanical analyzer (DMA)) with 10 μN resolution equipped with a three-point bending fixture was used to test specimens. Frequency sweeping was conducted over the range of 0.1-100 Hz under strain amplitudes of 0.01% to characterize the specimens' viscoelastic behavior. The strain-stress curve was obtained under the three-point bending geometry at an angular frequency of 10 rad/s. All measurements were carried out in their linear viscoelastic region, determined by strain amplitude sweeping with a frequency of 1 Hz.

### Nanoindentation

Nanoindentation was performed to characterize the soil-inspired material's mechanical properties with a Hysitron 950 Tribolndenter (Bruker, CA) with a Berkovich indenter (three-sided pyramid-shaped diamond tip, tip radius ˜100 nm) in the ambient environment. The indentations were conducted at a constant loading and unloading speed of 20 μN/s to prevent potential time-dependent effects on the materials, such as viscoelastic behavior on the nanoindentation test. The data were analyzed using standard Oliver and Pharr analysis to extract the indentation moduli S.^{4,5} The modulus of the soil-inspired material, E, can be further derived using the following equation:

$$E = \frac{1 - {v}_{s}^{2}}{\frac{1}{S} - \frac{1 - {v}_{diamond}^{2}}{{E}_{diamond}}}$$

Where vₛ is the Poisson ratio of the samples (assuming vₛ is 0.3), v_{diamond} is the Poisson ratio of the diamond tip (v_{diamond}=0.07), E_{diamond} is Young's modulus of the diamond (E_{diamond}=1141 GPa)⁵.

### Micro Computed Tomography (CT) of Soil-Inspired Material

Micro-Computed Tomography (microCT) images were captured on the XCUBE (Molecubes NV., Gent, Belgium) at the Integrated Small Animal Imaging Research Resource (iSAIRR) at The University of Chicago. Spiral high-resolution CT acquisitions were performed with an X-ray source of 50-kVp and 440 μA. Volumetric CT images were reconstructed in a 1400×1400×750 format with voxel dimensions of 50 μm. Images were analyzed using AMIRA 2020.1 (Thermo Fisher Scientific, Hillsboro, Oregon, USA), VivoQuant 4 patch 1 (InviCRO, LLC, Boston, USA).

### Infrared Spectroscopy

For FTIR spectra, 15 mg starch powder and 5 μL D20 (purchased from Cambridge Isotope Laboratories) were held between two CaF₂ windows held in a temperature-regulated brass jacket. Temperature-dependent IR spectra were acquired using a Bruker Tensor 27 Fourier-transform infrared (FTIR) spectrometer by acquiring a series of spectra during a slow temperature-ramp from 20° C. to 94° C. in 2° C. steps with a 60 s equilibration time between each spectrum. The sample temperature was monitored with a Phidget K-type thermocouple attached to the brass jacket. ATR-FTIR spectra were measured using Bruker Platinum ATR.

### Differential Scanning Calorimetry (DSC)

DSC measurement was conducted by TA Discovery DSC 2500 with 5-10 mg starch with different concentrations and conditions. The samples were measured at a heating and cooling rate of 10° C./min from room temperature to 92° C. The obtained data were processed by Trios software.

### Laser Sintering

Laser sintering was performed on soil-inspired material and control samples with a CO₂ laser cutter (Universal Laser Systems, VLS 4.60) with raster and vector mode. In both operation modes, the sintering power was 2%, 5%, and 10% (referred to as low, medium, high power, respectively), the speed was 20%, and the patterning procedure was repeated twice to obtain the desired engraving. We laser wrote a library of patterns using a combination of vector and raster modes with the 5% sintering power setting.

### Optical Microscope Imaging

Bright-field images were taken with the Nikon Eclipse Ti2 microscope to analyze starch granule morphology in the hydrated state. Starch granules were suspended in DI water and hydrated overnight, and the solution was directly transferred onto the microscope glass slides for measurements. The average size of the starch granules was calculated with ˜700 particles.

### Laser Confocal Scanning Microscope Imaging

A 3D laser confocal scanning microscope (LEXT OLS5000) was utilized to characterize the soil-inspired material's surface morphology with laser writing. The obtained images contained surface roughness and height information for the patterns. The images were colored based on height information on the surface to visualize the conductive patterns.

### X-Ray Absorption Near Edge Spectroscopy (XANES)

XANES measurements were performed at the Advanced Photon Source APS/CNM beamline 26-ID-C at Argonne National Lab. XANES was collected by scanning X-ray excitation energies across the absorption edge of the element of interest and measuring the intensity of Ka fluorescence at each energy. 26-ID-C used a Si(111) double-crystal monochromator to select X-ray energy. The monochromator energy was calibrated with standard Zn metal foil before XANES measurements. To measure XANES of the Ga element, excitation energies were scanned from 10335 eV to 10410 eV in 0.5 eV increments. A fluorescence spectrum was collected for 1 s for each excitation energy, and Ga Ka-emission intensity was represented by integrating the signal over a properly defined ROI in the spectrum. Each scan was performed twice, and the results were averaged. The fluorescence intensity was then normalized to the incident X-ray intensity to calculate the absorption coefficient for each excitation energy. Liquid gallium and gallium oxide were used to compare the samples' absorption edge energy to compounds of known oxidation states. To compare samples and standards under a similar signal lever, the calculated coefficient profiles were further normalized over their respective post-edge coefficient averaged from 10391 eV to 10401 eV.

### Conductivity and Solvent Test

To measure the real-time changes in resistance, we built a voltage divider circuit using DAQ National Instruments (USB-6210) and a LabVIEW program (FIG. 56). Soil-inspired materials with mechanically sintered conductive paths were exposed to different solvents, including acetone, benzene, dichloromethane, diethyl ether, dimethylformamide, dimethyl sulfoxide, ethanol, glycerol, hexane, isopropyl alcohol, methanol, methyl acetate, tetrahydrofuran, toluene, and o-xylene with multiple replicate samples (N>6). The resistance of the soil-inspired material was recorded over time.

### Biofilm Growth on Soil-Inspired Materials

B. subtilis biofilms were grown in an MSgg minimal medium agar plate containing 5 mM potassium phosphate buffer, 100 mM MOPS buffer (pH 7.0 adjusted with NaOH), 2 mM MgCl₂, 700 μM CaCl₂, 50 μM MnCl₂, 100 μM FeCl₃, 1 μM ZnCl₂, 2 μM thiamine hydrochloride, 0.5% (v/v) glycerol, and 0.5% (w/v) monosodium glutamate, 50 μg/ml tryptophan, 50 μg/ml phenylalanine. Typically, the soil-inspired material was centered on the Msgg agar plate, and 3 μL B. subtilis culture was transferred onto the center of the material. After culturing at 30° C. for 2 days, the biofilm growth area was measured by Image J.

B. subtilis and E. coli Growth in Liquid Flask Culture

B. subtilis were cultured in 4 ml LB culture at 37° C. overnight. We transferred 1% overnight culture to 30 mL MSgg liquid culture supplemented with soil-inspired material, carbon paper, polyacrylamide hydrogel, or organic potting soil and grew the culture in a rotary shaker at 37° C. for 12 h. The clone forming unit (CFU) per milliliter method was used to measure the biomass of cultured B. subtilis.

E. coli were cultured in 4 mL LB culture at 37° C. overnight. We transferred 1% overnight culture to 30 mL M9 minimum medium (containing 4 g/L glucose) supplemented with soil-inspired material and grew the culture in a rotary shaker 37° C. for 12 h. The biomass of the E. coli was measured using the CFU method. Fermentation products were measured by HPLC (1200 series; Agilent Technologies) with a mobile phase of 4 mM H₂SO₄ using an Aminex HPX-87H column with Micro Guard Cation H Cartridge. The column temperature was set to 55° C., and the flow rate was 0.6 mL/min.

### Biocompatibility Test

C57BL/6J mice (6-8 weeks) were orally administrated a daily dose of 75 mg/kg liquid metal powder for 7 consecutive days. Body weights (Days 0-7) were recorded every day before oral gavage. On Day 7, all the mice were euthanized. Colons were collected for length measurement and histology in the Human Tissue Resource Center at the University of Chicago. Crypt nuclei number and crypt depth were quantified on the colon histology scans. Other internal organs, including the liver, heart, and kidney, were also collected for histological examination. The glomerulus area was quantified on the kidney histology scans. All animals were housed under pathogen-free conditions, and all animal procedures were approved by the Institutional Animal Care and Use Committees (IACUC) of the University of Chicago.

### Ribosomal 16S Sequencing

C57BL/6J mice (6-8 weeks) were orally administrated a daily dose of 75 mg/kg liquid metal powder for 7 consecutive days. Two groups of feces samples (control and soil-inspired material) were collected for 16S sequencing. A test on the tetracycline-induced dysbiosis model was also conducted. Briefly, mice were orally administrated with two doses of 10 mg/kg tetracycline (suspended in 2.5% sodium carboxymethylcellulose) for 2 days. Mice in the control group were given the same dose of vehicle. Two groups of feces samples (CMC.Day2, Tet.Day2) were collected for 16S sequencing. After Day 3, tetracyclin-treated mice were orally administrated with 75 mg/kg liquid metal (suspended in water) for 7 days. Two groups of feces samples (Tet.Day2.ctrl.Day7, Tet.Day2.LM.Day7) were collected for 16S sequencing.

Feces samples were processed and analyzed with the ZymoBIOMICS® Targeted 16S Sequencing Service (Zymo Research, Irvine, CA). Unique amplicon sequence variants were inferred from raw reads using the DADA2 pipeline.⁶ Potential sequencing errors and chimeric sequences were removed with the DADA2 pipeline. Chimeric sequences were also removed with the DADA2 pipeline. Taxonomy assignment was performed using Uclust from Qiime v.1.9.1 with the Zymo Research Database, a 16S database that is internally designed and curated as a reference. Composition visualization, alpha-diversity, and beta-diversity analyses were performed with Qiime v.1.9.17. Taxonomy with significant abundance among different groups was identified by Linear discriminant analysis Effect Size (LEfSe) using default settings⁸. Other analyses such as heatmaps, Taxa2ASV Deomposer, and PCoA plots were performed with internal scripts. Absolute abundance was quantified with quantitative real-time PCR. The resulting values were shown as the gene copies number.

### Dextran Sodium Sulfate (DSS) Model of Ulcerative Colitis

For DSS-induced colitis animal tests, C57B/6J mice (6-8 weeks old) were given 2% DSS drinking water ad libitum for 7 days. Soil-inspired material, composed of starch, nanoclay, and liquid metal, and different two-component combinations were administrated through oral gavage into the mouse stomach at a dose of 75 mg/kg body weight once a day in concurrence with DSS treatment. All animals were euthanized at the endpoint. Colitis symptoms were evaluated based on daily body weight, fecal blood test, postmortem colon length, fecal water content, and colonic histology exams. Fecal blood scores were calculated by following the below scoring system: 0, Normal stool consistency with negative hemoccult; 1, Soft stools with positive hemoccult; 2, Very soft stools with traces of blood; 3, Watery stools with visible rectal bleeding. Histological injury scores were calculated based on the following aspects of the H&E-stained colonic tissue sections: Severity of inflammation (0-3: none, slight, moderate, severe), the extent of injury (0-3: none, mucosal, mucosal, and submucosal, transmural), and crypt damage (0-4: none, basal one-third damaged, basal two-thirds damaged, only surface epithelium intact, entire crypt and epithelium lost). Fecal samples were collected for colonic microbiome analysis with 16S rRNA sequencing.

### Micro Computed Tomography (CT) of Soil-Inspired Material in Gastrointestinal Region

Mice were prepared following an overnight fast and receiving oral gavage with soil-inspired material for in-vivo monitoring. Mice were imaged with microCT (XCUBE, Molecubes NV., Gent, Belgium) by the Integrated Small Animal Imaging Research Resource (iSAIRR) at The University of Chicago. The first scan was performed before any gavage procedure and scanned immediately after oral administration as time 0, then scanned at 1, 2, 3, 4, 6 hours, respectively. Once those scans were completed, mice were sacrificed, and gastrointestinal tissue was collected for ex-vivo microCT scan. Spiral high-resolution CT acquisitions were performed with an X-ray source of 50-kVp and 440 μA. Volumetric CT images were reconstructed in a 400×400×1200 format with voxel dimensions of 100 μm³. Images were analyzed using AMIRA 6.4 (Thermo Fisher Scientific, Hillsboro, Oregon, USA), VivoQuant 3.5 patch 2 (InviCRO, LLC, Boston, USA).

### Statistics and Reproducibility

Data were statistically analyzed with ordinary one-way ANOVA and Tukey's multiple comparisons test unless specified in the figure legends. For materials characterizations, all the SEM or TEM images were individually repeated more than five times at different sample spots. The X-ray ptychography and fluorescence imaging were repeated two times. Bacterial experiments were individually repeated at least three times. Animal experiments were individually repeated three times except for the DSS-induced colitis test.

### Results

### Example 1: Soil-Inspired Material Synthesis and Characterization

Our soil-inspired material comprises montmorillonite nanoclay, starch granules, and liquid metal (eutectic gallium-indium) particles. Montmorillonite nanoclay can replicate the chemical composition of natural minerals and is a native composite of regular soil. The starch and liquid metal components add responsiveness and additional functionality that natural soil doesn't possess. Specifically, starch granules undergo jamming in suspension^{24,25} and gelatinization with increasing temperature²⁶. Gallium-based liquid metals have a unique combination of metallic and fluidic properties and can undergo phase changes near or below room temperature with unique properties²⁷⁻³². As such, gallium has attracted considerable attention in bio-related applications^{33,34}, including drug delivery, positron emission tomography imaging, and lung infection therapy.

To introduce porosity and chemical heterogeneity, essential for responsive properties and microbial interfaces in soil, we employed an ice-templating step³⁵⁻³⁸ followed by hot compression (FIGS. 1C and 6). We vigorously mixed an aqueous suspension of nanoclay, starch granules, and liquid metal particles in a container. Prior to freeze-drying, the liquid metal and clay particle sizes were at the nanoscale (FIG. 1D), while the starch granules had a size of ˜10.1 μm (FIG. 7). After freeze-drying, the sample formed a mineral-based layered scaffold (FIG. 7), with starch granules and liquid metal particles attached mainly to the mineral membrane or layer surfaces (FIG. 8). We hypothesize that the ice-formation process may have selectively attracted the starch granules and liquid metal particles to the ice surfaces (or the mineral/ice interface), resulting in the heterogeneous distribution of the components; this heterogeneous distribution is critical for the mechanical, chemical, and optical responsive properties of the material, discussed later (FIG. 9B). Hot compression transformed the sample into a denser, multi-layered, yet still porous scaffold (FIG. 1F). The starch granules deformed during the hot compression and toughened the composite due to glue-like binding between adjacent mineral layers. The large size of the starch granules also prevented a complete collapse of the composite into a non-porous composite. The as-made soil-inspired material can be processed into origami plates with different geometries and assembled with polymer joints into corresponding 3D structures such as a cube and a tetrahedron (FIG. 10).

Synchrotron-based, correlative 3D X-ray fluorescence, and ptychographic tomography (resolution, ˜12.8 nm³⁹, FIG. 2A) revealed dispersed liquid metal particles with sizes ranging from tens of nanometers to several microns (FIG. 2B, red color). Electron-dense particles in X-ray ptychography correlated with gallium distribution in X-ray fluorescence imaging (FIGS. 2C, 11, and 12), and blank areas in the correlative sectioning images suggested porosity. The correlated images shown in the second (YZ) and third (XY) rows of FIG. 9 confirmed that the liquid metal components mainly accumulated at the mineral layer surfaces. As discussed below, exposure of the liquid metals (i.e., the responsive component) at the inner surfaces of the pores (FIG. 9B) contributes to the observed responsive properties and microbial modulation activities of the soil-inspired material.

To further confirm the porosity of the soil-inspired material, we embedded it with an epoxy resin and prepared thin section slices (˜200 nm) with an ultramicrotome. Fluorescence imaging (FIG. 2D), TEM images (FIG. 2E), and focus-ion-beam (FIB) tomography reaffirmed the porous nature of the material. The porosity of the material is ˜54.6% according to the 3D reconstruction of FIB tomography with a ˜360 μm³ volume size sample (FIG. 13). The X-ray ptychography and fluorescence imaging also verified that the electron-dense nanoparticles were gallium and indium, and the matrix hosting the liquid metal nanoparticles was composed of nanoclay (FIGS. 14 and 15). When we prepared the composites via simple mixing of the components and hot compression, the material did not display the desired responsive properties (FIG. 9C); the liquid metal particles were encapsulated by minerals and starch granules, and thus lost their mobility and accessibility, while limited porosity resulted in the loss of responsiveness to external stimuli or perturbation.

As starch undergoes gelatinization with increasing temperature, it was hypothesized the hot compression step, in addition to condensing the framework, may have induced a fundamental change in the starch granule structure. We performed in-situ infrared (IR) spectroscopy on hydrated starch granules with a heating/cooling cycle, employing heavy water to reveal the hydrogen bond association during the crystalline-to-amorphous phase transition. During heating from 20° C. to 94° C., we observed a loss of crystallinity in the starch granules with the disappearance of spectral features at 1007 cm⁻¹ (C—O—H deformation, Peak 1) and 2930 cm⁻¹ (C—H deformation, Peak 4)⁴⁰. We also observed spectral changes associated with the OH stretching mode (˜3400 cm⁻¹, Peak 5), OD bending mode (1207 cm⁻¹, Peak 2), and H-O-D bending mode (1458 cm⁻¹, Peak 3). These results suggest the formation of intermolecular hydrogen bonds between starch and heavy water (FIGS. 2F and 16, and Supplementary Table 2)⁴¹. We used singular value decomposition analysis to confirm that the starch granules underwent gelatinization during the fabrication process with a transition temperature of ˜72° C., in line with the phase change temperature of 70° C. established with differential scanning calorimetry (FIG. 17). This gelatinization process was irreversible according to in-situ cooling IR spectra (FIG. 18). Gelatinization induced swelling of the granules, amylose crystallinity breaking, and amylose diffusion out of the granules. As a result, the swollen granules, containing mostly amylopectin, collapsed but maintained their shape. Simultaneously, the diffused amylose behaved as an organic glue that bound the granules to the nanoclay, contributing to the mechanical robustness of the soil-inspired material (FIG. 19). The heat-induced transformation of starch positioned sticky and granular ‘spacers’ between adjacent mineral-based layers during the fabrication process, contributing to the porosity and liquid/bacterial transport capability (see below) of the soil-inspired material.

### Example 2: Mechanical, Chemical, and Optical Responsive Properties

Naturally occurring soil is a mechanically and (bio)chemically integrated system with environmental responsiveness, whose properties can be temporarily or permanently modified by nature. We further demonstrate that our soil-inspired material could act as a responsive matrix (similar to natural soil) and be post-modified for additional functionalities (Supplementary Table 1). The basic mechanical properties of the soil-inspired material can be tuned during synthesis. By selecting different nanoclays and altering the composition recipe (FIG. 20), we can tune the Young's modulus of the material from ˜2 GPa to ˜5 GPa (FIGS. 3A and 21). Omission of the liquid metal component resulted in a binary composite (i.e., starch and minerals) with a smaller Young's modulus (1 GPa, approximately half that of the complete composite) that was less stable during compression tests (FIG. 22). Considering the liquid metal itself has a Young's modulus of ˜0 Pa⁴², this result suggested that the surface tension of the liquid metal may have “tightened” the interaction between the starch and nanoclay to form a more robust matrix.

Furthermore, it was hypothesized that the production of a layered structure could contribute to the mechanical properties of the materials, and also produce porosity which allows for certain applications, such as microbial growth and diversity through production of microenvironments.

It was unexpectedly discovered that mechanical force could induce electrical conductivity, enabled by the liquid metal component, in the initially non-conductive soil-inspired material (FIGS. 3B and 23). It was demonstrated (e.g., FIG. 3C) that the indented lines over the soil-inspired substrate can serve as interconnects to light up an LED. Without liquid metal, the material remains fully non-conductive. We speculate that local compression may spread the liquid metal droplets through the pores, leading them to adhere to the mineral and starch surfaces; therefore, mechanical force enables the chemical redistribution of liquid metal droplets into a continuous pathway. Interestingly, this mechanically induced, electrically continuous pathway is sensitive to chemicals and can be erased by chemical vapors. We tested different solvents and found that solvents such as ethanol, isopropyl alcohol, o-xylene, and tetrahydrofuran can erase the conductivity of soil-inspired material (FIG. 3D). The linear relationship between conductance and the square root of the time under vapor treatment suggested the erasure of conductivity was dominated by diffusion (FIG. 3E). The solvent is known to influence the interfacial behavior of gallium-based liquid metal⁴³. We hypothesize that erasure of the conductivity may be related to the polarity and dielectric properties of the solvent and its wettability change on liquid metal interfaced with the nanoclay and starch matrix (FIG. 24). Therefore, the soil-inspired material is a mechanically and chemically responsive matrix: we can write/encode conductivity via indentation (maintainable for months) and then erase the conductivity with chemical vapor exposure (FIG. 3F).

To recapitulate the significant chemical and structural heterogeneities of soil, we employed laser writing to post-synthetically modify the soil-inspired material in spatially defined regions. Laser writing provides a facile and efficient way to change local chemical and physical properties. We prepared a library of laser writing designs, including The University of Chicago logo (FIGS. 4A and 25). Aberration-corrected scanning transmission electron microscope (aberration-corrected STEM) with high-angle annular dark-field (HAADF) imaging showed a dim nanoclay-containing matrix with a bright liquid metal nanoparticle nearby (FIGS. 4B and 26). Zooming in on the matrix revealed well-dispersed single metal atoms (FIG. 4C, yellow circles). The average size of the single atoms is ˜0.13 nm (FIG. 27), and further analysis indicated there are single atoms of two elements (FIG. 28). Energy dispersive X-ray spectroscopy (EDS) mapping of the single atom-containing region confirmed the existence of both Ga and In elements as well as Si and Al, indicating that Ga and In single metal atoms were adsorbed and stabilized by the nanoclay-based matrix (a phyllosilicate containing silicon oxide and aluminum oxide). These single atoms remained stable for months (FIG. 29). X-ray absorption near edge structure (XANES) spectra indicated partial oxidation of Ga compared to liquid gallium film, which is in line with the unsaturated state of single metal atoms on a substrate (FIG. 4D). The synthesis of Ga and In single atoms from liquid metals has not been reported before; our results lead us to believe this single atom-modified soil-inspired material may be used for heterogeneous catalysis, which is beyond the scope of the current study. Time-of-flight secondary ion mass spectrometry (TOF-SIMS) analysis revealed that laser writing significantly removes carbohydrate species, especially those with high molecular weight, indicating that the starch granules were carbonized while the metal elements and nanoclay remained (FIGS. 4E-4F and 30).

The laser writing also produced electrically conductive patterns on-demand, which is likely due to the carbonization of the starch component and the nano-/atomic level redistribution of the liquid metal component. The well-controlled conductive features over the soil-inspired material suggest its potential for patternable circuits (FIG. 31A). While laser writing produced stable properties and electrical devices in air, we can remove the laser-modified conductive patterns and recycle the soil-inspired substrates through sonication and high-speed vortex mixing in water (FIG. 31B), suggesting potential applications in recyclable electronics utilizing optical patterning (FIG. 31C).

### Example 3: Bacterial Modulation in Laboratory Culture

We next investigated the ability of our soil-inspired chemical system to modulate microbial systems (Supplementary Table 1), given its advantages in porosity and responsiveness. We firstly cultured Bacillus subtilis, a gram-positive soil bacteria that attracts distant motile cells through electrical signaling in its biofilm^{44,45}, on soil-inspired material with/without laser treatment. As shown in FIG. 4G, biofilms grown on soil-inspired materials with lasing (5% power) had larger film areas than biofilms grown on soil-inspired materials without lasing (˜43% increase). Meanwhile, laser power that was too high or too low (10% or 2% power) did not achieve the same level of enhancement (FIG. 32). We also confirmed that the biofilm grown on soil-inspired material without laser and with different laser power levels has no significant difference in cell number/density (FIG. 33). Additional benchmark experiments (FIGS. 34-35) suggested that neither carbonization from starch granules, the presence of liquid metal particles, nor increased conductivity alone could yield the observed bacterial growth enhancement. As such, it is possible that the single metal atoms produced by the lasing play an essential role in enhancing B. subtilis biofilm growth. We also studied the effect of the soil-inspired material in flask culture and found that the material enhanced B. subtilis growth better than carbon paper or hydrogel, although not as good as real soil (FIG. 36). This microbial growth enhancement can be extended to gram-negative Escherichia coli bacteria. The soil-inspired material promoted E. coli growth (FIG. 37A) and increased biofuel synthesis (FIG. 37B). These results indicate that the soil-inspired material may serve as a non-genetic tool to modulate microbial systems.

### Example 4: Bacterial Modulation In Vivo with Gut Microbiota

B. subtilis is also a gut commensal bacterium. Based on the in vitro results (FIGS. 4G and 36), we hypothesized that the soil-inspired material could influence the in vivo biochemical environment, and consequently the diversity and richness of the gut microbiome, which plays an essential role in priming the immune system, regulating gut endocrine function, modulating metabolism, and eliminating toxins⁴⁶. We first confirmed the in vivo biosafety and biocompatibility of the soil-inspired material in the C57B6/J mouse model. There was no statistical difference in body weight (FIG. 38A), colon length (FIGS. 38B-38C), colon histology (FIG. 38D), distal/proximal crypt depth (FIG. 39A), nuclei per crypt (FIG. 39B), or histology of other internal organs (FIGS. 40-41) between soil-inspired material-treated mice and control mice. Ribosomal 16S sequencing of fecal samples showed no significant difference in either absolute gene abundance or alpha diversity of the total fecal bacterium population (FIGS. 42A-42B). A taxonomy abundance heatmap showed no obvious changes in genera abundance among the richest genera, further indicating that the soil-inspired material did not result in noticeable gut microbiota dysbiosis (FIG. 43).

After confirming the biosafety and biocompatibility of the soil-inspired material, we next tested the biochemical impact of the soil-inspired material in a pathologically relevant condition in mice, tetracycline-induced gut microbiome dysbiosis. Tetracycline caused significant microbiome dysbiosis; 16S sequencing data showed a significant reduction in absolute gut microbiota abundance (FIG. 44) and abundance of the top richest genera (FIGS. 45-46). In mice suffering from tetracycline-induced dysbiosis, oral administration of the soil-inspired material significantly boosted gut microbial abundance compared with the vehicle control (FIG. 47), based on microbial alpha diversity quantification of fecal ribosomal 16S sequencing results. Linear discriminant analysis Effect Size (LEfSe) revealed a broader distribution of taxa, which indicated a significantly richer microbiota diversity in feces from the soil-inspired material-treated mice (FIG. 5A). The enhancement of biodiversity might be attributed to the spatial partitioning offered by the porosity of soil-inspired materials⁴⁷. High gut microbiota diversity, high gut microbiota gene richness, and stable microbiome function are all indicators of healthy microbiota⁴⁶. The ability of the soil-inspired material to enhance the diversity of gut microbiota under a pathological condition demonstrates promise for material-enabled biochemical modulation of the gut microbiota. A taxonomy abundance heatmap comparing the relative abundances of the top richest genera between soil-inspired material-treated mice and control mice showed statistical differences in the abundance of Oscillibacter, Allobaculum, Blautia, and Enterorhabdus (FIG. 48). The soil-inspired material significantly rectified the tetracycline-induced dysbiosis of Oscillibacter and Allobaculum (FIGS. 5B-5C) and significantly enriched the abundance of Enterorhabdus and Blautia in the gut (FIGS. 5D-5E); the latter result requires further systematic investigation given limited studies in the literature^{48,49}. Our results demonstrated that the soil-inspired chemical system could modulate gut bacteria in a bifacial manner, rectifying the dysbiosis of Allobaculum and Oscillibacter while boosting levels of Enterorhabdus and Blautia.

To evaluate the potential of the soil-inspired material in more severe gastrointestinal conditions, we employed the dextran sulfate sodium (DSS)-induced ulcerative colitis rodent model. We also included benchmark control groups to delineate the contributions from individual components. Specifically, mice, given 2% DSS drinking water ad libitum, were orally administrated with either 1) soil-inspired material (starch, nanoclay, and liquid metal), 2) no starch (nanoclay and liquid metal), 3) no nanoclay (starch and liquid metal), 4) no liquid metal (starch and nanoclay), or 5) water (i.e., DSS control group). In comparison to the DSS control group, mice treated with soil-inspired material presented significantly milder colitis symptoms, including less body weight loss (FIG. 5F), longer colon length (FIG. 5G), lower fecal bleeding score (FIG. 5H), and lower feces water content (FIG. 5I). These results indicate the therapeutic effects of soil-inspired materials in DSS-induced rodent colitis. Histology staining (FIGS. 5J and 49) and analysis (injury scoring in FIG. 5K, epithelial thickness in proximal and distal colon in FIG. 50) confirmed that the soil-inspired material improved the pathological appearance of the colon. The therapeutic efficacy of the complete soil-inspired material was greater than that of material that lacked components (FIGS. 5F-5I). We collected feces from all groups for 16S sequencing to explore the effects of the different components on the gut microbiome. DSS and oral administration of soil-inspired material altered the gut microbiome composition (FIG. 5I), but they did not have a significant difference in the bacterial abundance or alpha diversity (FIG. 52). g_Romboustsia dysbiosis was exacerbated in the group treated with a material that did not contain liquid metal (FIG. 53), which indicates that liquid metal may have a positive effect on g_Romboustsia dysbiosis. g_Romboustsia is a recently described bacterial genus⁵⁰, and its intestinal functions are not fully understood. One clinical study reported that intestinal Romboutsia abundance was positively correlated with obesity and high serum lipids⁵¹. Another study reported increased Romboutsia abundance in DSS-induced mouse colitis⁵², which is consistent with our result. The dysbiosis rectification with soil-inspired material containing liquid metal suggests its potential for the intervention of inflammatory bowel disease through microbial modulation. Oral administration of soil-inspired material was visualized using time-lapse X-ray microtomography imaging. The soil-inspired material can arrive in the colon and accumulate in feces within 6 hours (FIGS. 54-55). These test results indicate that the soil-inspired material and gut microbes are physically very close to the colon, which facilitates the material interacting and/or affecting the gut microbiome. Our results on the management of ulcerative colitis symptoms with soil-inspired materials suggest that this chemical system may find broad application in intestinal pathophysiological conditions involving gut microbiota dysbiosis and inflammatory bowel conditions.

### Outlook

This work presents the synthesis and characterization of a soil-inspired chemical system (Supplementary Table 1). We demonstrate its utility as a dynamically responsive material platform for microbial modulation in vitro and in vivo. The soil-inspired chemical system shows promise as a therapy for gastrointestinal disease, suggesting a therapeutic alternative to existing techniques⁵³⁻⁵⁷. Beyond gut microbiota, this chemical system may be extended to the study of other microbiomes, such as skin and soil microbiota, which would have implications from human health to the stability and productivity of agro-ecosystems⁵⁸.

SUPPLEMENTARY TABLE 1
Roles of the individual components in the soil-inspired chemical system.

| | Components | | | |
|---|---|---|---|---|
| Roles | Liquid metal | Starch granules | Nanoclay particles | Figure panels |
| Mechanical | | Establish the porosity | Establish the porosity | FIGS., 1e, 1f, 2e |
| | Establish a | Establish a | Establish a | FIG. S5 |
| | macroscopic shape | macroscopic shape | macroscopic shape | |
| | | Organic glue to | | FIGS. 2f, |
| | | maintain the | | S11-S14 |
| | | soil-inspired material | | |
| | | | Tune the modulus | FIGS. 3a, S16 |
| | Increase the modulus | | | FIG. S17 |
| | and toughness of the | | | |
| | composite | | | |
| | | Enable local | Enable local | FIG. 3b, S18 |
| | | deformability (through | deformability (through | |
| | | the porosity) | the porosity) | |
| Physical | Enable | Facilitate liquid metal | Facilitate liquid metal | FIGS. 3b, 3c |
| and | mechanically-induced | spreading during the | spreading during the | |
| chemical | electrical | indentation (through | indentation (through | |
| | conductivity increase | the porosity) | the porosity) | |
| | Enable chemically- | Permit vapor diffusion | Permit vapor diffusion | FIG. 3d, 3e |
| | induced electrical | (through the porosity) | (through the porosity) | |
| | conductivity | | | |
| | decrease | | | |
| | Enable optically- | | | FIGS. 4a |
| | induced electrical | | | |
| | conductivity increase | | | |
| | (through liquid | | | |
| | metal redistribution) | | | |
| | | Enable | | FIGS. 4e, 4f |
| | | optically-induced | | |
| | | electrical conductivity | | |
| | | increase (through | | |
| | | carbonization) | | |
| Biological | Enhance microbial | Enhance microbial | Enhance microbial | FIGS. 4g, S31, |
| | biofilm growth and | biofilm growth and | biofilm growth and | S32a |
| | liquid culture | liquid culture | liquid culture | |
| | Enhance the biofuel | Enhance the biofuel | Enhance the biofuel | FIG. S32b |
| | production | production | production | |
| | Enrich bacterial | Enrich bacterial | Enrich bacterial | FIGS. 5a, S42 |
| | diversity under the | diversity under the | diversity under the | |
| | tetracycline-induced | tetracycline-induced | tetracycline-induced | |
| | dysbiosis in vivo | dysbiosis in vivo | dysbiosis in vivo | |
| | Contribute to the | Contribute to the | | FIGS. 5f-5k |
| | alleviation of some | alleviation of some | | |
| | DSS-induced colitis | DSS-induced colitis | | |
| | symptoms, including | symptoms, including | | |
| | body weight loss, | body weight loss, | | |
| | colon length | colon length | | |
| | shortening, fecal | shortening, fecal | | |
| | blooding score, but | blooding score, and | | |
| | not on fecal water | fecal water content, | | |
| | content or histology | but not on histology | | |
| | injury score of | injury score of | | |
| | the colon. | the colon. | | |
| | Rectify colonic | | | FIGS. S48 |
| | Romboustsia | | | |
| | dysbiosis in vivo | | | |

SUPPLEMENTARY TABLE 2
Band Assignments for the Infrared Spectra.

| | Frequency | |
|---|---|---|
| Species | (cm⁻¹) | Assignment |
| H₂O | 1640 | bending⁹ |
| | 2105 | bending + libration⁹ |
| | 3350 | OH stretching⁹ |
| D₂O | 1207 | bending^{9, 10} |
| | 1560 | bending + libration^{9, 10} |
| | 2455 | OD stretching⁹ |
| HDO | 1458 | bending¹⁰ |
| Starch | 966 | skeletal mode vibrations of |
| | | α-1,4 glycosidic linkage^{11, 12} |
| | 1007 | C—O—H deformation^{13, 14} |
| | 1087 | C—O, C—C stretching¹⁵ |
| | 1168 | asymmetric stretching of |
| | | C—O—C glycosidic bridge¹⁴ |
| | 1307 | C—H deformation of all |
| | | ring hydrogens¹⁵ |
| | 1332 | C—O—H bending + CH₂ |
| | | twisting¹⁵ |
| | 1371&1386 | ring mode¹⁵ |
| | 2884&2930 | C—H deformation¹⁵ |

Additional aspects of the present disclosure are provided by the following enumerated embodiments, which may be combined in any number and in any combination that is not logically or technically inconsistent.

Embodiment 1. A material comprising:
nanoclay in an amount of 20 wt % to 40 wt %;
starch granules in an amount of 20 wt % to 40 wt %; and
a gallium-based alloy in an amount of 20 wt % to 40 wt %.

Embodiment 2. The material of embodiment 1, wherein the nanoclay comprises montmorillonite, bentonite, kaolinite, halloysite, dickite, nacrite, or illite.

Embodiment 3. The material of embodiment 1, wherein the nanoclay comprises bentonite in an amount of at least 90 wt % of the nanoclay.

Embodiment 4. The material of embodiment 1, wherein the nanoclay comprises at least two clays selected from the group consisting of montmorillonite, bentonite, kaolinite, halloysite, dickite, nacrite, and illite.

Embodiment 5. The material of embodiment 1, wherein the starch granules comprise starch derived from tapioca, corn, waxy corn, potatoes, rice, or wheat, and wherein the starch granules is native or modified.

Embodiment 6. The material of embodiment 1, wherein the starch granules comprise tapioca starch in an amount of at least 90 wt % of the starch granules.

Embodiment 7. The material of embodiment 1, wherein the starch granules comprise at least two starches derived from corn, waxy corn, potatoes, rice, or wheat.

Embodiment 8. The material of embodiment 1, wherein the starch granules have an average size in the range of 0.5 μm to 200 μm.

Embodiment 9. The material of embodiment 1, wherein the gallium-based alloy comprises at least 25 wt % gallium.

Embodiment 10. The material of embodiment 1, wherein the gallium-based alloy further comprises indium in an amount of at least 10 wt %.

Embodiment 11. The material of embodiment 1, wherein the gallium-based alloy further comprises tin.

Embodiment 12. The material of embodiment 1, wherein the gallium-based alloy comprises indium in the range of 60 to 85% of the alloy, and the balance is gallium.

Embodiment 13. The material of embodiment 1, wherein the gallium-based alloy is present as nanoparticles.

Embodiment 14. The material of embodiment 13, wherein the nanoparticles have an average diameter of less than 1 μm.

Embodiment 15. The material of embodiment 1, wherein the gallium-based alloy has a freezing point of no more than 20° C.

Embodiment 16. The material of embodiment 1, wherein the material comprises no more than 10 wt % water.

Embodiment 17. The material of embodiment 1, wherein the material is porous with a porosity in the range of 20 to 80%.

Embodiment 18. The material of embodiment 1, wherein the material is layered.

Embodiment 19. The material of embodiment 1, wherein the material has a Young's modulus in the range of 0.1 GPa to 10 GPa.

Embodiment 20. The material of embodiment 1, wherein the material further comprises conductive lines.

Embodiment 21. The material of embodiment 20, wherein the conductive lines are carbonized or compressed.

Embodiment 22. A method of making the material of embodiment 1, the method comprising the steps of:
(i) mixing the nanoclay and the starch granules with water to obtain a mixture, wherein the mixture comprises 60 to 98 wt % water;
(ii) adding the gallium-based alloy to the mixture to form a slurry;
(iii) lowering the temperature of the slurry below the freezing point of the gallium-based alloy;
(iv) freeze-drying the slurry to form a scaffold; and
(v) compressing the scaffold at a temperature of at least 50° C. (e.g., at least 60° C.) and at a pressure of at least 5 MPa (e.g., at least 10 MPa, or at least 15 MPa) to form the material.

Embodiment 23. The method of embodiment 22, wherein the mixture of step (ii) is stirred for at least 8 hours in order to hydrate the starch granules.

Embodiment 24. The method of embodiment 22, wherein the slurry of step (ii) is sonicated to form gallium-based alloy nanoparticles.

Embodiment 25. The method of embodiment 22, wherein the lowering of the temperature is performed through the application of a temperature gradient.

Embodiment 26. The method of embodiment 22, wherein the freeze-drying of step (iv) is conducted at a temperature of no more than −10° C. and at a pressure of no more than 1 mbar.

Embodiment 27. The method of embodiment 22, further comprising:
(vi) exposing the material to a stimulus to form a conductive pattern, wherein the stimulus is laser irradiation or pressure.

Embodiment 28. An artificial growth medium comprising the material of embodiment 1 and a plurality of cells, wherein the plurality of cells comprises a biofilm-forming organism, gram-positive bacteria, or gram-negative bacteria.

Embodiment 29. A method of producing a chemical, the method comprising:
providing the artificial growth medium of claim 28, wherein the plurality of cells is capable of producing a chemical; and
inducing the plurality of cells to produce the chemical, wherein the chemical is a chemical feedstock, a fuel, or a pharmaceutical.

Embodiment 30. A method of modulating the gut microbiome and/or treating a digestive disorder in a subject in need thereof, the method comprising administering an effective amount of the material of embodiment 1 to the subject.

Embodiment 31. The method of embodiment 30, wherein the digestive disorder is microbiome dysbiosis, ulcerative colitis, colitis, Crohn's disease, or irritable bowel syndrome.

Embodiment 32. A substrate comprising a layer of the material of embodiment 1, wherein the layer comprises a predetermined conductive pattern.

Embodiment 33. A method of creating a circuit, the method comprising providing a substrate comprising a layer of the material of embodiment 1, and converting portions of the layer to create a predetermined conductive pattern.

### REFERENCES

1. Rodriguez-Caballero, E., Belnap, J., Büdel, B., Crutzen, P. J., Andreae, M. O., Pöschl, U. & Weber, B. Dryland photoautotrophic soil surface communities endangered by global change. Nature Geoscience 11, 185-189 (2018).
2. Zheng, D., Liwinski, T. & Elinav, E. Interaction between microbiota and immunity in health and disease. Cell Res 30, 492-506 (2020).
3. Jimenez, M., Langer, R. & Traverso, G. Microbial therapeutics: New opportunities for drug delivery. J Exp Med 216, 1005-1009 (2019).
4. Sakimoto, K. K., Wong, A. B. & Yang, P. Self-photosensitization of nonphotosynthetic bacteria for solar-to-chemical production. Science 351, 74-77 (2016).
5. Zhang, H., Liu, H., Tian, Z., Lu, D., Yu, Y, Cestellos-Blanco, S., Sakimoto, K. K. & Yang, P. Bacteria photosensitized by intracellular gold nanoclusters for solar fuel production. Nature Nanotechnology 13, 900-905 (2018).
6. Cestellos-Blanco, S., Zhang, H., Kim, J. M., Shen, Y. & Yang, P. Photosynthetic semiconductor biohybrids for solar-driven biocatalysis. Nature Catalysis 3, 245-255 (2020).
7. Liu, C., Colón, B. C., Ziesack, M., Silver, P. A. & Nocera, D. G. Water splitting-biosynthetic system with CO₂ reduction efficiencies exceeding photosynthesis. Science 352, 1210-1213 (2016).
8. Guo, J., Suástegui, M., Sakimoto, K. K., Moody, V. M., Xiao, G., Nocera, D. G. & Joshi, N. S. Light-driven fine chemical production in yeast biohybrids. Science 362, 813-816 (2018).
9. Wang, T., Zhu, J., Wei, Z., Yang, H., Ma, Z., Ma, R., Zhou, J., Yang, Y., Peng, L., Fei, H., Lu, B. & Duan, X. Bacteria-Derived Biological Carbon Building Robust Li—S Batteries. Nano Lett. 19, 4384-4390 (2019).
10. Ding, M., Shiu, H.-Y, Li, S.-L., Lee, C. K., Wang, G., Wu, H., Weiss, N. O., Young, T. D., Weiss, P. S., Wong, G. C. L., Nealson, K. H., Huang, Y. & Duan, X. Nanoelectronic Investigation Reveals the Electrochemical Basis of Electrical Conductivity in Shewanella and Geobacter. ACS Nano 10, 9919-9926 (2016).
11. Liu, C., Gallagher, J. J., Sakimoto, K. K., Nichols, E. M., Chang, C. J., Chang, M. C. Y. & Yang, P. Nanowire-Bacteria Hybrids for Unassisted Solar Carbon Dioxide Fixation to Value-Added Chemicals. Nano Lett. 15, 3634-3639 (2015).
12. Su, Y, Cestellos-Blanco, S., Kim, J. M., Shen, Y., Kong, Q., Lu, D., Liu, C., Zhang, H., Cao, Y & Yang, P. Close-Packed Nanowire-Bacteria Hybrids for Efficient Solar-Driven CO2 Fixation. Joule 4, 800-811 (2020).
13. Cestellos-Blanco, S., Zhang, H. & Yang, P. Solar-driven carbon dioxide fixation using photosynthetic semiconductor bio-hybrids. Faraday Discussions 215, 54-65 (2019).
14. Tang, T.-C., An, B., Huang, Y, Vasikaran, S., Wang, Y, Jiang, X., Lu, T. K. & Zhong, C. Materials design by synthetic biology. Nature Reviews Materials 6, 332-350 (2021).
15. Huang, J., Liu, S., Zhang, C., Wang, X., Pu, J., Ba, F., Xue, S., Ye, H., Zhao, T., Li, K., Wang, Y, Zhang, J., Wang, L., Fan, C., Lu, T. K. & Zhong, C. Programmable and printable Bacillus subtilis biofilms as engineered living materials. Nature Chemical Biology 15, 34-41 (2019).
16. Liu, X., Tang, T.-C., Tham, E., Yuk, H., Lin, S., Lu, T. K. & Zhao, X. Stretchable living materials and devices with hydrogel-elastomer hybrids hosting programmed cells. PNAS 114, 2200-2205 (2017).
17. Wang, Y, An, B., Xue, B., Pu, J., Zhang, X., Huang, Y, Yu, Y, Cao, Y & Zhong, C. Living materials fabricated via gradient mineralization of light-inducible biofilms. Nature Chemical Biology 17, 351-359 (2021).
18. Gilbert, C., Tang, T.-C., Ott, W., Dorr, B. A., Shaw, W. M., Sun, G. L., Lu, T. K. & Ellis, T. Living materials with programmable functionalities grown from engineered microbial co-cultures. Nature Materials 20, 691-700 (2021).
19. O'Donnell, A. G., Young, I. M., Rushton, S. P., Shirley, M. D. & Crawford, J. W. Visualization, modelling and prediction in soil microbiology. Nature Reviews Microbiology 5, 689-699 (2007).
20. Young, I. M. & Crawford, J. W. Interactions and Self-Organization in the Soil-Microbe Complex. Science 304, 1634-1637 (2004).
21. Chaparro, J. M., Sheflin, A. M., Manter, D. K. & Vivanco, J. M. Manipulating the soil microbiome to increase soil health and plant fertility. Biol Fertil Soils 48, 489-499 (2012).
22. Wargo, J. A. Modulating gut microbes. Science 369, 1302-1303 (2020).
23. Gupta, A., Osadchiy, V. & Mayer, E. A. Brain-gut-microbiome interactions in obesity and food addiction. Nature Reviews Gastroenterology & Hepatology 17, 655-672 (2020).
24. Peters, I. R., Majumdar, S. & Jaeger, H. M. Direct Observation of Dynamic Shear Jamming in Dense Suspensions. Nature 532, 214-217 (2016).
25. James, N. M., Han, E., de la Cruz, R. A. L., Jureller, J. & Jaeger, H. M. Interparticle Hydrogen Bonding Can Elicit Shear Jamming in Dense Suspensions. Nature Materials 17, 965-970 (2018).
26. Lelievre, J. Starch Gelatinization. Journal of Applied Polymer Science 18, 293-296 (1974).
27. Daeneke, T., Khoshmanesh, K., Mahmood, N., Castro, I. A. de, Esrafilzadeh, D., Barrow, S. J., Dickey, M. D. & Kalantar-zadeh, K. Liquid Metals: Fundamentals and Applications in Chemistry. Chem. Soc. Rev. 47, 4073-4111 (2018).
28. Zavabeti, A., Ou, J. Z., Carey, B. J., Syed, N., Orrell-Trigg, R., Mayes, E. L. H., Xu, C., Kavehei, O., O'Mullane, A. P., Kaner, R. B., Kalantar-zadeh, K. & Daeneke, T. A liquid metal reaction environment for the room-temperature synthesis of atomically thin metal oxides. Science 358, 332-335 (2017).
29. Markvicka, E. J., Bartlett, M. D., Huang, X. & Majidi, C. An autonomously electrically self-healing liquid metal-elastomer composite for robust soft-matter robotics and electronics. Nature Materials 17, 618-624 (2018).
30. Dickey, M. D. Emerging Applications of Liquid Metals Featuring Surface Oxides. ACS Appl. Mater. Interfaces 6, 18369-18379 (2014).
31. Chen, S., Wang, H.-Z., Zhao, R.-Q., Rao, W. & Liu, J. Liquid Metal Composites. Matter 2, 1446-1480 (2020).
32. Hirsch, A., Dejace, L., Michaud, H. O. & Lacour, S. P. Harnessing the Rheological Properties of Liquid Metals To Shape Soft Electronic Conductors for Wearable Applications. Acc. Chem. Res. 52, 534-544 (2019).
33. Yan, J., Lu, Y, Chen, G., Yang, M. & Gu, Z. Advances in liquid metals for biomedical applications. Chemical Society Reviews 47, 2518-2533 (2018).
34. Goss, C. H., Kaneko, Y, Khuu, L., Anderson, G. D., Ravishankar, S., Aitken, M. L., Lechtzin, N., Zhou, G., Czyz, D. M., McLean, K., Olakanmi, O., Shuman, H. A., Teresi, M., Wilhelm, E., Caldwell, E., Salipante, S. J., Hornick, D. B., Siehnel, R. J., Becker, L., Britigan, B. E. & Singh, P. K. Gallium disrupts bacterial iron metabolism and has therapeutic effects in mice and humans with lung infections. Science Translational Medicine 10, (2018).
35. Wegst, U. G. K., Bai, H., Saiz, E., Tomsia, A. P. & Ritchie, R. O. Bioinspired Structural Materials. Nature Materials 14, 23-36 (2015).
36. Munch, E., Launey, M. E., Alsem, D. H., Saiz, E., Tomsia, A. P. & Ritchie, R. O. Tough, Bio-Inspired Hybrid Materials. Science 322, 1516-1520 (2008).
37. Bai, H., Chen, Y., Delattre, B., Tomsia, A. P. & Ritchie, R. O. Bioinspired Large-Scale Aligned Porous Materials Assembled with Dual Temperature Gradients. Science Advances 1, e1500849 (2015).
38. Mao, L.-B., Gao, H.-L., Yao, H.-B., Liu, L., Cölfen, H., Liu, G., Chen, S.-M., Li, S.-K., Yan, Y.-X., Liu, Y.-Y. & Yu, S.-H. Synthetic nacre by predesigned matrix-directed mineralization. Science 354, 107-110 (2016).
39. Deng, J., Lo, Y H., Gallagher-Jones, M., Chen, S., Pryor, A., Jin, Q., Hong, Y. P., Nashed, Y S. G., Vogt, S., Miao, J. & Jacobsen, C. Correlative 3D X-Ray Fluorescence and Ptychographic Tomography of Frozen-Hydrated Green Algae. Science Advances 4, eaau4548 (2018).
40. van Soest, J. J. G., Tournois, H., de Wit, D. & Vliegenthart, J. F. G. Short-range structure in (partially) crystalline potato starch determined with attenuated total reflectance Fourier-transform IR spectroscopy. Carbohydrate Research 279, 201-214 (1995).
41. Ramakers, L. A. I., Hithell, G., May, J. J., Greetham, G. M., Donaldson, P. M., Towrie, M., Parker, A. W., Burley, G. A. & Hunt, N. T. 2D-IR Spectroscopy Shows that Optimized DNA Minor Groove Binding of Hoechst33258 Follows an Induced Fit Model. J. Phys. Chem. B 121, 1295-1303 (2017).
42. Wagner, S. & Bauer, S. Materials for stretchable electronics. MRS Bulletin 37, 207-213 (2012).
43. Khan, M. R., Trlica, C., So, J.-H., Valeri, M. & Dickey, M. D. Influence of Water on the Interfacial Behavior of Gallium Liquid Metal Alloys. ACS Appl. Mater. Interfaces 6, 22467-22473 (2014).
44. Humphries, J., Xiong, L., Liu, J., Prindle, A., Yuan, F., Arjes, H. A., Tsimring, L. & Suel, G. M. Species-Independent Attraction to Biofilms through Electrical Signaling. Cell 168, 200-209.e12 (2017).
45. Nimje, V. R., Chen, C.-Y, Chen, C.-C., Jean, J.-S., Reddy, A. S., Fan, C.-W., Pan, K.-Y, Liu, H.-T. & Chen, J.-L. Stable and high energy generation by a strain of Bacillus subtilis in a microbial fuel cell. Journal of Power Sources 190, 258-263 (2009).
46. Fan, Y & Pedersen, O. Gut microbiota in human metabolic health and disease. Nature Reviews Microbiology 19, 55-71 (2021).
47. Wu, F., Ha, Y, Weiss, A., Wang, M., Letourneau, J., Wang, S., Luo, N., Huang, S., Lee, C. T., David, L. A. & You, L. Modulation of microbial community dynamics by spatial partitioning. Nature Chemical Biology 18, 394-402 (2022).
48. Zhou, H., Tai, J., Xu, H., Lu, X. & Meng, D. Xanthoceraside Could Ameliorate Alzheimer's Disease Symptoms of Rats by Affecting the Gut Microbiota Composition and Modulating the Endogenous Metabolite Levels. Front Pharmacol 10, (2019).
49. Kong, C., Gao, R., Yan, X., Huang, L. & Qin, H. Probiotics improve gut microbiota dysbiosis in obese mice fed a high-fat or high-sucrose diet. Nutrition 60, 175-184 (2019).
50. Gerritsen, J., Fuentes, S., Grievink, W., van Niftrik, L., Tindall, B. J., Timmerman, H. M., Rijkers, G. T. & Smidt, H. Characterization of Romboutsia ilealis gen. nov., sp. nov., isolated from the gastro-intestinal tract of a rat, and proposal for the reclassification of five closely related members of the genus Clostridium into the genera Romboutsia gen. nov., Intestinibacter gen. nov., Terrisporobacter gen. nov. and Asaccharospora gen. nov. International Journal of Systematic and Evolutionary Microbiology 64, 1600-1616 (2014).
51. Zeng, Q., Li, D., He, Y., Li, Y., Yang, Z., Zhao, X., Liu, Y, Wang, Y, Sun, J., Feng, X., Wang, F., Chen, J., Zheng, Y, Yang, Y, Sun, X., Xu, X., Wang, D., Kenney, T., Jiang, Y, Gu, H., Li, Y, Zhou, K., Li, S. & Dai, W. Discrepant gut microbiota markers for the classification of obesity-related metabolic abnormalities. Sci Rep 9, 13424 (2019).
52. Xu, H.-M., Huang, H.-L., Liu, Y-D., Zhu, J.-Q., Zhou, Y-L., Chen, H.-T., Xu, J., Zhao, H.-L., Guo, X., Shi, W., Nie, Y-Q. & Zhou, Y-J. Selection strategy of dextran sulfate sodium-induced acute or chronic colitis mouse models based on gut microbial profile. BMC Microbiology 21, 279 (2021).
53. Nadeau, P., EI-Damak, D., Glettig, D., Kong, Y L., Mo, S., Cleveland, C., Booth, L., Roxhed, N., Langer, R., Chandrakasan, A. P. & Traverso, G. Prolonged energy harvesting for ingestible devices. Nature Biomedical Engineering 1, 1-8 (2017).
54. Steiger, C., Abramson, A., Nadeau, P., Chandrakasan, A. P., Langer, R. & Traverso, G. Ingestible electronics for diagnostics and therapy. Nature Reviews Materials 4, 83-98 (2019).
55. Mimee, M., Nadeau, P., Hayward, A., Carim, S., Flanagan, S., Jerger, L., Collins, J., McDonnell, S., Swartwout, R., Citorik, R. J., Bulovid, V., Langer, R., Traverso, G., Chandrakasan, A. P. & Lu, T. K. An ingestible bacterial-electronic system to monitor gastrointestinal health. Science 360, 915-918 (2018).
56. Zhang, S., Bellinger, A. M., Glettig, D. L., Barman, R., Lee, Y-A. L., Zhu, J., Cleveland, C., Montgomery, V. A., Gu, L., Nash, L. D., Maitland, D. J., Langer, R. & Traverso, G. A pH-responsive supramolecular polymer gel as an enteric elastomer for use in gastric devices. Nature Materials 14, 1065-1071 (2015).
57. Lee, Y, Deelman, T. E., Chen, K., Lin, D. S. Y, Tavakkoli, A. & Karp, J. M. Therapeutic luminal coating of the intestine. Nature Materials 17, 834-842 (2018).
58. Singh, J. S., Pandey, V. C. & Singh, D. P. Efficient soil microorganisms: A new dimension for sustainable agriculture and environmental development. Agriculture, Ecosystems & Environment 140, 339-353 (2011).

### REFERENCES FOR METHODS

ADDIN ZOTERO_BIBL {“uncited”:[ ],“omitted”:[ ],“custom”:[ ]} CSL_BIBLIOGRAPHY 1. Chen, S. et al. The Bionanoprobe: hard X-ray fluorescence nanoprobe with cryogenic capabilities. J. Synchrotron Radiat. 21, 66-75 (2014).
2. Vogt, S. MAPS: A set of software tools for analysis and visualization of 3D X-ray fluorescence data sets. J. Phys. IV Proc. 104, 635-638 (2003).
3. Deng, J. et al. Correlative 3D x-ray fluorescence and ptychographic tomography of frozen-hydrated green algae. Sci. Adv. 4, eaau4548 (2018).
4. Oliver, W. C. & Pharr, G. M. An improved technique for determining hardness and elastic modulus using load and displacement sensing indentation experiments. J. Mater. Res. 7, 1564-1583 (1992).
5. Oliver, W. C. & Pharr, G. M. Measurement of hardness and elastic modulus by instrumented indentation: Advances in understanding and refinements to methodology. J. Mater. Res. 19, 3 (2004).
6. Callahan, B. J. et al. DADA2: High-resolution sample inference from Illumina amplicon data. Nat. Methods 13, 581-583 (2016).
7. Caporaso, J. G. et al. QIIME allows analysis of high-throughput community sequencing data. Nat. Methods 7, 335-336 (2010).
8. Segata, N. et al. Metagenomic biomarker discovery and explanation. Genome Biol. 12, R60 (2011).
9. Max, J.-J. & Chapados, C. Isotope effects in liquid water by infrared spectroscopy. III. H2O and D2O spectra from 6000to0 cm-1. J. Chem. Phys. 131, 184505 (2009).
10. Bodis, P., Larsen, 0. F. A. & Woutersen, S. Vibrational Relaxation of the Bending Mode of HDO in Liquid D2O. J. Phys. Chem. A 109, 5303-5306 (2005).
11. Sekkal, M., Dincq, V., Legrand, P. & Huvenne, J. P. Investigation of the glycosidic linkages in several oligosaccharides using FT-IR and FT Raman spectroscopies. J. Mol. Struct. 349, 349-352 (1995).
12. Cael, S. J., Koenig, J. L. & Blackwell, J. Infrared and raman spectroscopy of carbohydrates: Part III: raman spectra of the polymorphic forms of amylose. Carbohydr. Res. 29, 123-134 (1973).
13. van Soest, J. J. G., Tournois, H., de Wit, D. & Vliegenthart, J. F. G. Short-range structure in (partially) crystalline potato starch determined with attenuated total reflectance Fourier-transform IR spectroscopy. Carbohydr. Res. 279, 201-214 (1995).
14. Liu, Q., Charlet, G., Yelle, S. & Arul, J. Phase transition in potato starch-water system I. Starch gelatinization at high moisture level. Food Res. Int. 35, 397-407 (2002).
15. Cael, J. J., Koenig, J. L. & Blackwell, J. Infrared and Raman spectroscopy of carbohydrates. Part VI: Normal coordinate analysis of V-amylose. Biopolymers 14, 1885-1903 (1975).

We claim:

1. A material comprising:
nanoclay in an amount of 20 wt % to 40 wt %;
starch granules in an amount of 20 wt % to 40 wt %; and
a gallium-based alloy in an amount of 20 wt % to 40 wt %.

2. The material of claim 1, wherein the nanoclay comprises montmorillonite, bentonite, kaolinite, halloysite, dickite, nacrite, or illite.

3. The material of claim 1, wherein the nanoclay comprises bentonite in an amount of at least 90 wt % of the nanoclay.

4. The material of claim 1, wherein the nanoclay comprises at least two clays selected from the group consisting of montmorillonite, bentonite, kaolinite, halloysite, dickite, nacrite, and illite.

5. The material of claim 1, wherein the starch granules comprise at least one starch derived from tapioca, corn, waxy corn, potatoes, rice, or wheat, and wherein the starch granules are native or modified.

6. The material of claim 1, wherein the starch granules comprise tapioca starch in an amount of at least 90 wt % of the starch granules.

7. The material of claim 1, wherein the starch granules have an average size in the range of 0.5 μm to 200 μm.

8. The material of claim 1, wherein the gallium-based alloy comprises at least 25 wt % gallium.

9. The material of claim 1, wherein the gallium-based alloy further comprises indium in an amount of at least 10 wt %.

10. The material of claim 1, wherein the gallium-based alloy further comprises tin.

11. The material of claim 1, wherein the gallium-based alloy comprises indium in the range of 60 to 85% of the alloy, and the balance is gallium.

12. The material of claim 1, wherein the gallium-based alloy is present as nanoparticles.

13. The material of claim 12, wherein the nanoparticles have an average diameter of less than 1 μm.

14. The material of claim 1, wherein the gallium-based alloy has a freezing point of no more than 20° C.

15. The material of claim 1, wherein the material comprises no more than 10 wt % water.

16. The material of claim 1, wherein the material is porous with a porosity in the range of 20 to 80%.

17. The material of claim 1, wherein the material is layered.

18. The material of claim 1, wherein the material has a Young's modulus in the range of 0.1 GPa to 10 GPa.

19. The material of claim 1, wherein the material further comprises conductive lines.

20. The material of claim 19, wherein the conductive lines are carbonized or compressed.
